(19) United States
(12) Patent Application Publication
(10) Pub. No.: US 2016/0152738 A1
(43) Pub. Date: Jun. 2, 2016

(54) Supported Catalyst for Olefin Polymerization, Preparation Method and Use Thereof

(71) Applicant: EAST CHINA UNIVERSITY OF SCIENCE AND TECHNOLOGY, Shanghai (CN)

(72) Inventors: WANG JINGWEN, SHANGHAI (CN); BOPING LIU, SHANGHAI (CN); RUIHUA CHENG, SHANGHAI (CN); KUELIAN HE, SHANGHAI (CN); ZHEN LIU, SHANGHAI (CN)

(73) Assignee: EAST CHINA UNIVERSITY OF SCIENCE AND TECHNOLOGY, SHANGHAI (CN)

(21) Appl. No.: 14/904,691

(22) PCT Filed: Jun. 20, 2014
(86) PCT No.: PCT/CN2014/080371

§ 371 Date: Jan. 12, 2016

(30) Foreign Application Priority Data
Jul. 16, 2013 (CN) 201310298051.2

(51) Int. Cl. C08F 4/02; C08F 4/16

(52) U.S. Cl. CPC C08F 4/025; C08F 4/02; C08F 4/16; C08F 2410/01; C08F 2410/04

(57) ABSTRACT

A supported catalyst for olefin polymerization, a preparation method and use thereof. The catalyst comprises a porous carrier A, a magnesium-containing carrier B, and a supported active component containing a transitional metal of titanium. The catalyst is a highly efficient Ziegler-Natta titanium-based catalyst having a composite support formed by a magnesium compound and a silicon compound, wherein the raw material for the magnesium compound may be any soluble magnesium salt. The supported catalyst may be used for preparing olefin homopolymers or olefin copolymers. According to the present invention, the molecular weight, molecular weight distribution of the olefin homopolymer or olefin copolymer as well as the contents and distribution of the comonomers may be adjusted conveniently by means of changing the factors such as types and amounts of organometallic co-catalyst and molecular weight regulator.

### FIELD OF INVENTION

The present invention relates to a supported olefin polymerization catalyst, preparation method and its application in the production of olefin homopolymers and olefin copolymers. The catalyst is easy to be prepared at low cost, and has a high activity, excellent hydrogen response and copolymerization performance, et al.

### BACKGROUND OF INVENTION

Polyethylene markets dominance in general synthetic resin, which shows chemical resistance, good mechanical strength, and electrical insulation characteristics. Polypropylene is a thermoplastic synthetic resin with excellent performance, such as non-toxic, chemically stable, and easy processing, which is the best product in heat resistance for general resin. Polyethylene and polypropylene are widely used in people's daily life, health care, industry and agriculture, etc.

Polyolefin products with excellent performance are closely related to catalysts used in polymerization thereof.

Ziegler-Natta catalyst is originated from the great discovery of the TiCl₄-AlEt₃ and TiCl₃-AlEt2Clcatalytic systems by Ziegler and Nana in early 1950s, respectively. This kind of Ziegler-Natta catalyst was used successfully in low temperature and pressure synthesis of high-density polyethylene and polypropylene with higher isotacticity. Modification and further study were proceeded based on this Ziegler-Natta catalyst, including patent U.S. Pat. No. 6,221,803, U.S. Pat. No. 6,825,146, U.S. Pat. No. 6,930,071, U.S. Pat. No. 7,078,362, U.S. Pat. No. 7,348,383, et al.

As the initial Ziegler-Natta catalyst presented a low activity and a low utilization of titanium atom, so a residue removal process is necessary for the original polyolefin process to remove ash in the catalyst, which resulted in high production costs. Therefore, researchers have begun to explore methods for preparing supported catalysts. In the late of 1960s, Kashiwa from Mitsui Chemicals in Japan (Patent JP 1031698) and Galli from Italian company Montecatini (Patent GB 1286867A) had developed a Ziegler-Natta catalyst with high activity, in which titanium chloride was supported on MgCl₂. The discovery of MgCl₂ carrier is a milestone in polyolefin industry and leads to innovative improvement of the polyolefin properties. Due to the significant increase of the catalytic activity, eliminating of the de-ashing process, the industrialization and the application of the polyolefin products has been promoted greatly. MgCl₂ supported high efficiency Ziegler-Natta catalyst has been still a major industrial catalysts in polyolefin production after years of sustained development. There are mainly two ways to prepare the MgCl₂ support(carrier) as follows:

1) The first type is called two-step process, reported by Kashiwa and Galli, in which anhydrous MgCl₂ is used as Mg-source, and reacted with alcohol to form MgCl₂-alcoholate adduct, then excess amount of TiCl₄ removed the alcohol and made Ti species (transition metal active component containing titanium) supported on the MgCl₂ support. While this kind of method is relatively complex and showed a high production cost.

2) The second type is called one-step process developed by Hoechst Company (THB polyethylene catalyst) and Toho titanium Company (THC polypropylene catalyst, U.S. Pat. No. 4,547,476 A), in which, MgCl₂ support was directly synthesized in situ by the reaction between Mg(OEt)₂ and TiCl₄, and the Ti species is supported thereon simultaneously. The preparation process is simple, however, due to the Mg(OEt)₂ raw materials was expensive, the cost of the preparation process is high, and the morphology control of catalyst particle is difficult.

Another major industrial supported Ziegler-Natta catalyst is MgCl₂/SiO₂ bi-supported catalyst. Firstly, amorphous porous silica is an excellent carrier material for polyolefin catalysts. Chien et al. has found that a carrier having functional groups (mainly hydroxyl groups) supported with the transition metal compound may synthesize olefin polymerization catalyst with high activity. Secondary, SiO₂ has porous structure and high specific surface area, and contains a small amount of reactive groups, such as silanol groups, etc., which may be reacted with TiCl₄ in the catalyst, to obtain the SiO₂ supported Ziegler-Natta catalyst.

Patent U.S. Pat. No. 4,293,673, U.S. Pat. No. 4,302,565, U.S. Pat. No. 4,302,566, U.S. Pat. No. 4,303,771 reported that the Union Carbide Company developed high efficiency Ziegler-Natta catalysts based on silica and magnesium composite support, the representative of the industrial catalyst is M-1 catalyst which has been applied in UNIPOL gas phase process, in which, Anhydrous MgCl₂ as Mg-source was dissolved in THF, and the homogeneous solution was impregnated into the thermally-treated SiO₂ surface to form composite carrier, then the titanium species was supported. This catalyst showed high catalytic activity, good hydrogen response and copolymerization ability, however, the production method is complex and the cost thereof is high.

In general, although a lot of works have been done in the field of Ziegler-Natta catalysts, there are still some shortcomings for the traditional MgCl₂ carrier and MgCl₂/SiO₂ composite carrier-supported Ziegler-Natta catalyst, such as relative complexity of preparation method, high cost, difficulties in morphology controling. Therefore, a novel Ziegler-Natta catalyst with simple preparation method, low cost, controllable morphology and performance should be developed.

### CONTENTS OF THE INVENTION

In order to solve the problems mentioned above, disclosed are a supported catalyst for olefin polymerization, a preparation method and use thereof in the production of olefin homopolymers and olefin copolymers. According to the present invention, the catalyst is prepared through impregnation of solution of soluble Mg-compounds on inorganic carrier, and form a supported thin layer of magnesium compound on the surface of inorganic carrier by high temperature calcination, followed by further reacting with chlorinated titanium compound to synthesize the support containing magnesium compound in situ and to support the titanium species on the surface of inorganic carrier, simultaneously. According to the present invention, any porous inorganic carrier with any inexpensive soluble magnesium may be used as raw materials. The catalyst preparation method is simple, easy to control catalyst morphology at low cost, and the resulting composite supported Ziegler-Natta catalyst shows an excellent performance in olefin polymerization.

### The Technical Scheme of the Present Invention

The present invention provides a supported olefin polymerization catalyst, wherein the catalyst includes a porous support as support (carrier) A, a magnesium-containing compound support as support (carrier) B and a supported transition metal active component containing titanium.

According to the supported olefin polymerization catalyst of the present invention, the carrier A is one or more selected from silica, alumina, aluminosilicate (xAl₂O₃.ySiO₂), titania, zirconia, magnesium oxide, calcium oxide, inorganic clays and combinations thereof. The inorganic clays may include, e.g. montmorillonite and the like. In one embodiment of the present disclosure, the at least one inorganic support is selected from silica gel, such as amorphous porous silica gel. These supports are commercially available or may be synthesized by known processes. As an example of the silica gel, Davison 955 may be used.

According to the supported olefin polymerization catalyst of the present invention, preferably, the carrier A is selected from silica, alumina, aluminosilicate, titania and zirconia.

According to the supported olefin polymerization catalyst of the present invention, preferably, the carrier A is further selected from silica, alumina and aluminosilicate.

According to the supported olefin polymerization catalyst of the present invention, the specific surface area of the carrier A is usually 10˜800 m²/g, preferably 100˜300 m²/g; the pore volume of the carrier A is 0.1˜6.0 cm³/g, preferably 0.5˜3.0 cm³/g; the average pore size is 1˜50 nm, preferably 5˜40 nm. The carrier A used in the present invention may be any support generally used in the preparation of olefin polymerization catalyst.

According to the supported olefin polymerization catalyst of the present invention, carrier B is a kind of magnesium compound, the general formula of the magnesium compound is R¹ₘMgCl₂₋ₘ, wherein, R¹ is C₁-C₂₀ alkyl group which may be saturated or unsaturated straight-chain, branched or cyclic chain, 0≦m<2.

According to the supported olefin polymerization catalyst of the present invention, the titanium transition metal is titanium compound, such as Ti(L¹)ₙCl₄₋ₙ, Ti(L¹)_{g}Cl_{3-g} or Ti(L¹)ₖCl₂₋ₖ, wherein, L¹ is C₁-C₂₀ alkyl group R² or alkyl oxide group R²O, R² may be saturated or unsaturated straight-chain, branched or cyclic chain, 0≦n≦4, 0≦g≦3, 0≦k≦2, when n, g and k is 2 or more than 2, the R² may be same or different.

According to the supported olefin polymerization catalyst of the present invention, the titanium compound is selected from trimethoxy titanium chloride, triethoxy titanium chloride, tri-n-propoxy titanium chloride, tri-iso-propoxy titanium chloride, dimethoxy titanium dichloride, diethoxy titanium dichloride, di-iso-propoxy titanium dichloride, methoxy titanium trichloride, ethoxy titanium trichloride, titanium tetrachloride, tetraethoxy titanium, tetraethyl titanate, tetrabutyl titanate, titanium trichloride, titanium ethoxide, titanium dichloride, di-n-butyl titanium, ethyl titanium chloride.

According to the supported olefin polymerization catalyst of the present invention, preferably, the titanium compound is selected from triethoxy titanium chloride, diethoxy titanium dichloride, methoxy titanium trichloride, titanium tetrachloride, tetrabutyl titanate, titanium trichloride.

According to the supported olefin polymerization catalyst of the present invention, preferably, the titanium compound is further selected from triethoxy titanium chloride, diethoxy titanium dichloride, methoxy titanium trichloride, titanium tetrachloride.

According to the method for preparing the supported olefin polymerization catalyst of the present invention, support(carrier) A is impregnated with a solution of the soluble magnesium salt, or impregnated with a mixed solution mixed with the soluble magnesium salt and the soluble ammonium salt, followed by calcination at high temperature of 300˜900° C. and further reacting with titanium-containing compound, to obtain the catalyst. If necessary, an organometallic cocatalyst may also be used to pre-activate the catalyst. After the calcination reaction and before the reaction with the solution containing titanium compound, if necessary, the organic magnesium compound, the organic aluminum compound or hydroxyl-containing compound may be added to modify the calcined product.

According to the method for preparing the supported olefin polymerization catalyst of the present invention, the soluble magnesium salt includes any soluble magnesium salt.

According to the method for preparing the supported olefin polymerization catalyst of the present invention, the soluble magnesium salt is one or more selected from magnesium carbonate, magnesium bicarbonate, magnesium chromate, magnesium silicon fluoride, magnesium acetate, magnesium nitrate, magnesium fluoride, magnesium chloride, magnesium bromide, magnesium iodide, magnesium sulfate, magnesium gluconate, magnesium chlorate, magnesium perchlorate, magnesium phosphate, magnesium sulfate, magnesium citrate, magnesium amino acid et al, other suitable soluble magnesium salt and combinations thereof

According to the method for preparing the supported olefin polymerization catalyst of the present invention, the loading of magnesium loaded on carrier A is 0.01˜50wt % (weight of Mg based on the total weight of the catalyst).

According to the method for preparing the supported olefin polymerization catalyst of the present invention, preferably, the soluble magnesium salt is selected from magnesium acetate, magnesium nitrate, magnesium bicarbonate, magnesium chromate, magnesium fluoride, magnesium sulfate, magnesium gluconate, magnesium chlorate, magnesium phosphate, magnesium sulfide.

According to the method for preparing the supported olefin polymerization catalyst of the present invention, preferably, the soluble magnesium salt is selected from magnesium gluconate, magnesium chlorate, magnesium phosphate, magnesium bicarbonate, magnesium fluoride, magnesium sulfate, magnesium acetate.

According to the method for preparing the supported olefin polymerization catalyst of the present invention, the soluble ammonium salt include any soluble ammonium salt, such as ammonium acetate, ammonium nitrate, ammonium carbonate, ammonium bicarbonate et al, other suitable soluble ammonium salt, and combinations thereof

According to the method for preparing the supported olefin polymerization catalyst of the present invention, the molar ratio of the soluble ammonium salt and the magnesium salt is 0.01˜10.

According to the method for preparing the supported olefin polymerization catalyst of the present invention, preferably, the soluble ammonium salt is one or more selected from ammonium acetate, ammonium nitrate, and ammonium carbonate.

According to the method for preparing the supported olefin polymerization catalyst of the present invention, further preferably, the soluble ammonium salt is selected from ammonium acetate, ammonium nitrate.

According to the method for preparing the supported olefin polymerization catalysts of the present invention, the titanium compound which react with the calcination product, as Ti(L²)ₕCl₄₋ₕ, Ti(L²)ₛCl₃₋ₛ or Ti(L²)ₜCl₂₋ₜ, wherein, L² is C₁-C₂₀ alkyl group R³ or alkyl oxide group R³O, R³ may be saturated or unsaturated straight-chain, branched or cyclic chain, 0≦h≦4, 0≦s≦3, 0≦t≦2, when h, s and t is 2 or more than 2, the existed R³ may be same or different.

According to the method for preparing the supported olefin polymerization catalyst of the present invention, the titanium compound is one or more selected from trimethoxy titanium chloride, triethoxy titanium chloride, tri-n-propoxy titanium chloride, tri-iso-propoxy titanium chloride, dimethoxy titanium dichloride, diethoxy titanium dichloride, di-isopropoxy titanium dichloride, methoxy titanium trichloride, ethoxy titanium trichloride, titanium tetrachloride, titanium trichloride, titanium dichloride, ethyl titanium chloride et al. The molar ratio of the titanium compound and the magnesium which supported on carrier A is 0.01˜500, preferably, 0.1˜200.

According to the method for preparing the supported olefin polymerization catalysts of the present invention, preferably, the titanium compound is selected from triethoxy titanium chloride, diethoxy titanium dichloride, methoxy titanium trichloride, titanium tetrachloride, titanium trichloride.

According to the method for preparing the supported olefin polymerization catalysts of the present invention, further preferably, the titanium compound is selected from triethoxy titanium chloride, methoxy titanium trichloride, titanium tetrachloride, and titanium trichloride.

According to the method for preparing the supported olefin polymerization catalysts of the present invention, the internal electron donor is one or more selected from the compound as the below figures (I), (II), (II), (IV) and any other alkyl ester of saturated aliphatic carboxylic acid, alkyl esters of aromatic carboxylic acid, aliphatic ethers, cyclic ethers, saturated aliphatic ketones, glycol esters, and combinations thereof, generally the internal electron donor is known in the field of olefin polymerization.

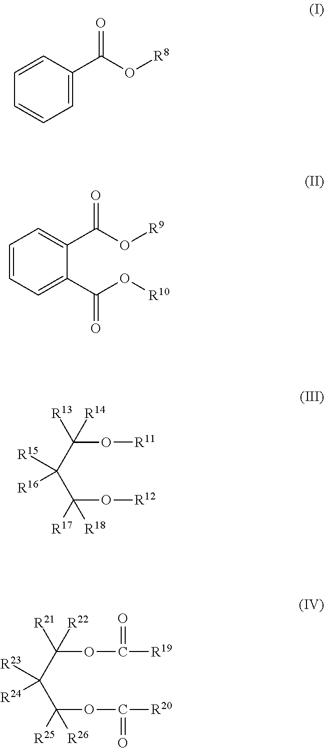

Wherein, R⁸-R²⁶ is C₁-C₂₀ alkyl group which may be saturated or unsaturated straight-chain, branched or cyclic chain. The internal electron donor is one or more selected from methyl methacrylate, ethyl methacrylate, butyl methacrylate, methyl formate, ethyl formate, butyl formate, methyl acetate, ethyl acetate, butyl acetate, methyl paraben, ethylparaben, butylparaben, amino methyl benzoate, amino ethyl benzoate, butyl aminobenzoate, p-methyl benzenesulfonate, p-butyl benzenesulfonate, methyl benzoate, ethyl benzoate, butyl benzoate, methyl salicylate, ethyl salicylate, butyl salicylate, p-benzene diacetic diether, dimethyl isophthalate, diethyl isophthalate, dibutyl isophthalate, dimethyl phthalate, diethyl phthalate, phthalic acid di-n-propyl ester, dibutyl phthalate, diisobuty,l phthalate, orthophthalic dibutene dibutyl ester, diisooctyl phthalate, dimethyl oxalate, diethyl oxalate, dibutyl oxalate, 2,2-diethyl malonate n-butyl acetate, 2,3-dimethyl methyl succinic acid, β-methyl glutaric acid diisopropyl ester, phthalic acid-1,3-diamyl ester, diethyl ether, hexyl ether, 2,2-di-iso-butyl-1,3 methoxypropane, tetrahydrofuran (THF), acetone, methyl isobutyl ketone, 2-ethyl-1,3-propanediol dibenzoate, 2-isopropyl-2-isopentyl-1,3 propanediol dibenzoate, 1,3-butanediol dimethyl benzoate, 1,3-pentanediol neopentyl ester, 2,4-pentanediol dibenzoate, 2-methyl-1,3-pentanediol benzoate cinnamate, 2,4-heptandiol dibenzoate, 2-methyl-3,5-heptandiol dibenzoate, 9,9-bis (methoxymethyl) fluorine et al, and combinations thereof. The molar ratio of the internal electron donor and the magnesium loading on the carrier A is 0.01˜500, preferably, 0.1˜50.

According to the method for preparing the supported olefin polymerization catalyst of the present invention, preferably, the internal electron donor is selected from alkyl esters, alkyl esters of aromatic carboxylic acid, aliphatic ethers, cyclic ethers, saturated aliphatic ketones.

According to the method for preparing the supported olefin polymerization catalyst of the present invention, further preferably, the internal electron donor is selected from cyclic ethers, alkyl esters of aromatic carboxylic acid, saturated aliphatic ketones.

According to the method for preparing the supported olefin polymerization catalyst of the present invention, the general formula of the organic magnesium compound is R⁴ₚMgX₂₋ₚ, wherein, R⁴ is C₁-C₂₀ alkyl group which may be saturated or unsaturated straight-chain, branched or cyclic chain, 0<p<2, X is halogen, such as F, Cl, Br, I.

According to the method for preparing the supported olefin polymerization catalyst of the present invention, the organic magnesium compound is one or more selected from methyl magnesium chloride, ethyl magnesium chloride, butyl magnesium chloride, allyl magnesium chloride, isopropyl magnesium chloride, t-butyl magnesium chloride, 2-methyl butyl magnesium chloride, 1-heptyl magnesium chloride, 1-pentyl magnesium chloride, 1-hexyl magnesium chloride, 1,1-dimethylpropyl magnesium chloride, cyclopentyl magnesium chloride, vinyl magnesium chloride, 2-butyl magnesium chloride, 1-octyl magnesium chloride et al.

According to the method for preparing the supported olefin polymerization catalyst of the present invention, the molar ratio of the organic magnesium compound and the magnesium loading on carrier A is 0.01˜100.

According to the method for preparing the supported olefin polymerization catalyst of the present invention, the organic aluminum compound is selected from trialkylaluminum AlR₃, dialkyl alkoxide aluminum AlR₂OR, dialkyl aluminum halides AlR₂X, aluminoxane, triethyldialuminium trichloride et al, wherein, R is C₁-C₁₂ alkyl group, X is halogen, such as F, Cl, Br, I.

According to the method for preparing the supported olefin polymerization catalyst of the present invention, the molar ratio of the organic aluminum compound and the magnesium loading on carrier A is 0.01˜100.

According to the method for preparing the supported olefin polymerization catalyst of the present invention, the general formula of the hydroxyl-containing compound is HOR⁵, wherein, R⁵ is C₁-C₂₀ alkyl group which may be saturated or unsaturated straight-chain, branched or cyclic chain, and the hydroxyl-containing compound may be selected from ethanol, n-butanol, n-hexanol, isooctyl alcohol, benzyl alcohol and phenethyl alcohol et al.

According to the method for preparing the supported olefin polymerization catalyst of the present invention, the molar ratio of the hydroxyl-containing compound and the magnesium loading on carrier A is 0.01˜200.

For the above-mentioned catalysts, if necessary, the organometallic cocatalyst such as organic aluminum compound, organic lithium compound, organic boron compound et al may be added to pre-reduced the catalyst, wherein, the organic aluminum compound include trialkylaluminum AlR₃, dialkyl alkoxide aluminum AlR₂OR, dialkyl aluminum halides AlR₂X, aluminoxane, triethyldialuminium trichloride et al, wherein, R is C₁-C₂₀ alkyl group, X is halogen, such as F, Cl, Br, I. The general formula of organic lithium compound is LiR⁶, wherein, R⁶ is C₁-C₂₀ alkyl group which may be saturated or unsaturated straight-chain, branched or cyclic chain, and the organic lithium compound may be selected from methyl lithium, ethyl lithium, butyl lithium, t-butyl lithium, pentyl lithium, phenyl lithium et al. The general formula of organic boron compound is BR⁷_{q}Cl_{3-q}, wherein, R⁷ is C₁-C₂₀ alkyl group or alkoxy group, 0≦q<3, the organic boron compound may be selected from trimethyl boron, triethyl boron, dichloro-methyl boron, dichloro-ethyl boron, dichloro-butyl boron, dichloro-methoxy boron, dichloro-ethoxy boron, boron trichloride and dichloro-butoxy group. The molar ratio of the organometallic cocatalyst and the titanium species is 0.01˜1000.

One embodiment of the present invention comprises the steps of:

a) Carrier A is impregnated with a solution of soluble magnesium salt, then dried and calcined at high temperature of 300˜900° C.;

b) The product obtained from step a) is reacted with a solution of titanium-containing compound, if necessary, an internal electron donor may be added into the reaction system simultaneously, followed by washing and drying, to prepare the catalyst.

A preferred process for preparing the supported polyolefin catalyst of the present invention comprises the steps of:

a) Carrier A is impregnated with the solution of the soluble magnesium salt at 0 to 80° C. for 0.5˜12 h, preferably, room temperature to 70° C. and 4˜8 h, followed by drying at room temperature to 250° C. for 2˜20 h, preferably, 80° C. to 200° C. and 8˜15 h, the drying process may be also carried out under vacuum. Subsequently, the product is calcined and activated in an inert gas or oxygen or air at high temperature of 300˜900° C. for 1˜10 h, preferably, 400° C. to 800° C. and 3˜8 h, and then by cooling, air is replaced with the inert gas such as nitrogen or argon et al when it is cooled down to 300˜400° C.

b) The product obtained from step a) is reacted with the solution of titanium-containing compound at room temperature to 200° C. for 0.5˜8 h, preferably, 80° C. to 180° C. and 1˜5 h. If necessary, the internal electron donor may be added into the reaction system simultaneously, then the product is washed by C₃-C₂₀ alkane solvent such as n-heptane, hexane et al. at 0˜150° C., preferably, room temperature to 100° C. At last, the product is dried at room temperature to 250° C. for 2˜20 h, preferably, 80˜160° C. and 6˜12 h, and then the catalyst is prepared and stored.

Generally, according to the present invention, support(carrier) A is impregnated with the magnesium salt, a catalyst matrix supported magnesium compound is prepared after high temperature calcination, then the catalyst matrix is further reacted with the titanium-containing compound subsequently, thereby, carrier B is synthesized in situ on the surface of carrier A and titanium species may also be supported simultaneously. If necessary, the internal electron donor may be added into the reaction system to prepare the supported olefin polymerization catalyst.

Said step a) relates to a method of depositing a soluble magnesium salt onto the carrier A (for example the support mentioned above), and such method may be any method capable of depositing a magnesium salt onto the support, which is known by those skilled in the art. In one embodiment of the present invention, the method of depositing magnesium salt onto the support comprises impregnating a porous support with a solution of magnesium salt, and the magnesium salt may be any soluble magnesium salt as mentioned before. In one embodiment, a stirring, preferably continuous stirring, may be carried out during the impregnation process. Generally, such stirring lasts from about 1 to 12 h at 0˜80° C., preferably is 4˜8 h and room temperature to 70° C. In one embodiment, the loading of magnesium is at most 0.01˜50 wt % based on the total weight of the catalyst, preferably is 0.1˜40 wt %. Then the resultant magnesium-supporting support is dried, generally at room temperature to 250° C., preferably to 80˜200° C. In one embodiment, the drying is conducted at about 120° C., and the drying process may also be carried out under vacuum. The duration period of such drying is not specially limited, but such drying generally lasts from about 2˜20 h, preferably is 7˜18 h, further preferably is 8˜15 h. After drying, the magnesium-supporting carrier A is calcined. The calcining manner is not specifically limited, but preferably conducted within a fluidized bed. In one embodiment, such calcining is carried out by two stages as low temperature stage and high temperature stage. The low temperature stage is generally conducted at about 100 to 300° C., and the high temperature stage is generally conducted at about 300 to 900° C. Without any theoretical limitation, it is believed that the physical water of the support is removed during the low temperature stage, and the soluble magnesium salts decompose partially. The hydroxyl radical on the carrier A is removed during the high temperature stage, and the soluble magnesium salt decompose completely. In one embodiment, the low temperature stage lasts from 1 to 10 h, preferably from 2 to 9 h, further preferably from 3 to 8 h. In another embodiment, the high temperature stage lasts from 1 to 10 h, preferably from 2 to 9 h, further preferably from 3 to 8 h. In one embodiment, the low temperature stage is carried out under an inert atmosphere, wherein the inert gas is selected from, e.g. the inert gases as mentioned above, preferably high purity nitrogen. In one embodiment, the calcining is carried out in air or oxygen, preferably in dry air. After calcining, the resultant support supporting magnesium-containing compound is cooled from the high temperature stage. In one embodiment, when the temperature is decreased to 300˜400° C., the atmosphere may be changed, e.g. from air to inert gas, such as nitrogen, argon et al. In one embodiment, such cooling is a natural falling of temperature.

Said step b) relates to a method of supporting support(carrier) B onto support(carrier) A and the preparation method of the catalyst. In one embodiment, the product obtained from step a) is reacted with the solution of titanium-containing compound, a stirring, preferably a continuous stirring, may be carried out during the reaction. Generally, such stirring lasts from about 0.5 to 8 h, preferably is 1˜5 h. The titanium-containing compound is shown as Ti(L²)ₕCl₄₋ₕ, Ti(L²)ₛCl₃₋ₛ or Ti(L²)ₜCl₂₋ₜ, wherein, L² is C₁-C₂₀ alkyl group R³ or alkyl oxide group R³O, R³ may be saturated or unsaturated straight-chain, branched or cyclic chain, 0≦h≦4, 0≦s≦3, 0≦t≦2, when h, s and t is 2 or more than 2, the existed R³ may be same or different. The titanium compound is selected from trimethoxy titanium chloride, triethoxy titanium chloride, tri-n-propoxy titanium chloride, tri-iso-propoxy titanium chloride, dimethoxy titanium dichloride, diethoxy titanium dichloride, di-isopropoxy titanium dichloride, methoxy titanium trichloride, ethoxy titanium trichloride, titanium tetrachloride, titanium trichloride, titanium dichloride, ethyl titanium chloride et al. The molar ratio of the titanium-containing compound and the magnesium loading supported on carrier A is 0.01˜500, preferably, 0.1˜200. Generally, this period is carried out at room temperature to 200° C., preferably, 80˜180° C. If necessary, an internal electron donor may be added into the reaction system simultaneously, and the internal electron donor is selected from the donors mentioned before, the molar ratio of the internal electron donor and the magnesium loading on carrier A is 0.01˜500, preferably, 0.1˜50. C₃-C₂₀ alkane is used as washing solvent, such as n-heptane, hexane et al. at 0˜150° C., preferably, room temperature to 100° C. At last, the product is dried at room temperature to 250° C. for 2˜20 h, preferably, 80˜160° C. and 6˜12 h, and the drying process is also carried out under vacuum. The obtained catalyst is then transferred under nitrogen and stored.

As an example, an operation for preparing the catalyst of the present invention includes:

A porous amorphous silica gel is impregnated with a solution of magnesium acetate of a certain concentration, wherein the loading of magnesium based on the total weight of the catalyst (e.g. 0.1˜40 wt %) satisfied the requirement in the present application. After being continuously stirred for a certain period of time (e.g. 4˜8 h), then heated and dried, the silica gel support supporting the magnesium acetate is calcined under high-temperature in a fluidized bed, wherein at the low temperature stage (e.g. 100˜300° C.), the physical water of the support is removed under nitrogen and the magnesium acetate decomposes partially. At the high temperature stage (e.g. 300˜900° C.), hydroxyl group on the surface of the silica gel is removed under dry air and magnesium acetate decompose completely. The high temperature stage lasts a certain period of time (e.g. 3˜8 h). Finally, the product is naturally cooled down, and when the temperature is decreased to 300˜400° C., the atmosphere may be changed to nitrogen. Then, at a certain temperature (e.g. 80˜180° C.), the product obtained reacts with TiCl₄, the molar ratio of TiCl₄ and the magnesium loading on carrier A is 0.1˜200. If necessary, an internal electron donor may be added into the reaction system, such as dibutylphthalate, the molar ratio of the internal electron donor and the magnesium loading on carrier A is 0.1˜50. After continuous stirring (e.g. 1˜5 h), the product is washed with hexane at a certain temperature (e.g. room temperature to 100° C.) and dried at 80˜160° C. for 6˜12 h under inert gas, such as nitrogen, helium, argon et al, preferably is nitrogen, and this drying process is also carried out under vacuum. The catalyst is then transferred under the protection of nitrogen and stored. One embodiment of the present invention which provides the supported polyolefin catalyst comprises the steps of:

a) Carrier A is impregnated with a solution of soluble magnesium salt, then dried and calcined at high temperature of 300˜900° C.;

b) The product obtained from step a) is reacted with an organic magnesium compound, then dried;

c) The product obtained from step b) is reacted with the solution of titanium-containing compound, if necessary, an internal electron donor may be added into the reaction system simultaneously, and then followed by washing and drying, to prepare the catalyst.

A preferred process for preparing a supported polyolefin catalyst of the present invention comprises the steps of:

a) support(carrier) A is impregnated with a solution of soluble magnesium salt at 0 to 80° C. for 0.5˜12 h, preferably, room temperature to 70° C. and 4˜8 h, then dried at room temperature to 250° C. for 2˜20 h, preferably, 80° C. to 200° C. and 8˜15 h. The drying process may be also carried out under vacuum. Subsequently, the product is then calcined and activated in inert gas or oxygen or air at high temperature of 300˜900° C. for 1˜10 h, preferably, 400° C. to 800° C. and 3˜8 h, and then cooled down, wherein air is replaced with an inert gas such as nitrogen or argon et al when it is cooled to 300˜400° C.

b) The product obtained from step a) is reacted with an organic magnesium compound at 0˜150° C. for 5 min˜2 h, preferably at room temperature to 70° C. and 10 min˜1 h. Then the product is washed by C₃-C₂₀ alkane solvent such as n-heptane, hexane et al. at 0˜150° C., preferably, room temperature to 100° C. At last, the product is dried at room temperature to 250° C. for 2˜20 h, preferably, 60˜120° C. and 6˜12 h, and the drying process may also be carried out under vacuum. Then the product is obtained and stored.

c) The product obtained from step b) is reacted with the solution of titanium-containing compound at room temperature to 200° C. for 0.5˜8 h, preferably, 80° C. to 180° C. and 1˜5 h. If necessary, an internal electron donor may be added into the reaction system simultaneously, then the product is washed by C₃-C₂₀ alkane solvent such as n-heptane, hexane et al. at 0˜150° C., preferably, room temperature to 100° C. At last, the product is dried at room temperature to 250° C. for 2˜20 h, preferably, 80˜160° C. and 6˜12 h. The drying process may also be carried out under vacuum. Then the catalyst is prepared and stored.

Generally, the present invention involves that: support(carrier) A is impregnated with the magnesium salt, a catalyst matrix supported magnesium compound is prepared by high temperature calcination, the catalyst matrix is further reacted with an organic magnesium compound and titanium-containing compound subsequently, thereby carrier B is synthesized in situ on the surface of carrier A and titanium species may also be supported simultaneously. If necessary, an internal electron donor may be added into the reaction system to prepare the supported olefin polymerization catalyst.

Said step a) relates to a method of depositing a soluble magnesium salt onto the carrier A (for example the support mentioned above), and such method may be any method capable of depositing magnesium salt onto the support, which is known by those skilled in the art. In one embodiment of the present invention, the method of depositing magnesium salt onto the support comprises impregnating porous support with solution of magnesium salt, and magnesium salt may be any soluble magnesium salt as mentioned before. In one embodiment, a stirring, preferably a continuous stirring, may be carried out during the impregnation process. Generally, such stirring lasts from about 1 to 12 h at 0˜80° C., preferably is 4˜8 h and room temperature to 70° C. In one embodiment, the loading of magnesium is at most 0.01˜50 wt % based on the total weight of the catalyst, preferably is 0.1˜40 wt %. Then the resultant magnesium-containing support is dried, generally at room temperature to 250° C., preferably is 80˜200° C. In one embodiment, the drying is conducted at about 120° C., and the drying process may also be carried out under vacuum. The duration period for such drying is not specially limited, but such drying generally lasts from about 2˜20 h, preferably is 7˜18 h, further preferably is 8˜15 h. After drying, the magnesium-containing carrier A is calcined. The calcining manner is not specifically limited, but it is preferably conducted within a fluidized bed. In one embodiment, such calcining is carried out by two stages as low temperature stage and high temperature stage. The low temperature stage is generally conducted at about 100 to 300° C., and the high temperature stage is generally conducted at about 300 to 900° C. Without any theoretical limitation, it is believed that the physical water of the support is removed during the low temperature stage, and the soluble magnesium salts decompose partially. The hydroxyl radical on the carrier A is removed during the high temperature stage, and the soluble magnesium salts decompose completely. In one embodiment, the low temperature stage lasts from 1 to 10 h, preferably from 2 to 9 h, further preferably from 3 to 8 h. In another embodiment, the high temperature stage lasts from 1 to 10 h, preferably from 2 to 9 h, further preferably from 3 to 8 h. In one embodiment, the low temperature stage is carried out under an inert atmosphere, wherein the inert gas is selected from, e.g. the inert gases as mentioned above, preferably high purity nitrogen. In one embodiment, the high temperature calcination stage is carried out in air or oxygen, preferably dry air. After calcining, the resultant support supporting magnesium-containing compound is cooled down from the high temperature stage. In one embodiment, when the temperature is decreased to 300˜400° C., the atmosphere may be changed, e.g. from air to inert gas, such as nitrogen, argon et al. In one embodiment, such cooling down is a natural falling of temperature.

Said step b) relates to a method of further modifying the surface of the product obtained from step a). In one embodiment, the organic magnesium compound is shown as R⁴ₚMgX₂₋ₚ, wherein, R⁴ is C₁-C₂₀ alkyl group which may be saturated or unsaturated straight-chain, branched or cyclic chain, 0<p<2, X is halogen, such as F, Cl, Br, I. The organic magnesium compound is selected from methyl magnesium chloride, ethyl magnesium chloride, butyl magnesium chloride, allyl magnesium chloride, isopropyl magnesium chloride, t-butyl magnesium chloride, 2-methyl butyl magnesium chloride, 1-heptyl magnesium chloride, 1-pentyl magnesium chloride, 1-hexyl magnesium chloride, 1,1-dimethylpropyl magnesium chloride, cyclopentyl magnesium chloride, vinyl magnesium chloride, 2-butyl magnesium chloride, 1-octyl magnesium chloride et al. The molar ratio of the organic magnesium compound and the magnesium loading on carrier A is 0.01˜100, preferably 0.1˜80. Generally, such stirring lasts from about 5 min to 2 h at 0˜150° C., preferably is 10 min to 1 h and 0˜70° C. C₃-C₂₀ alkane is used as washing solvent, such as n-heptane, hexane et al. at 0˜150° C., preferably, room temperature to 100° C. At last, the product is dried at room temperature to 250° C. for 2˜20 h, preferably, 60˜120° C. and 6˜12 h, and the drying process is also carried out under vacuum. The obtained product is then transferred under nitrogen and stored.

Said step c) relates to a method of supporting support(carrier) B onto support(carrier) A and the preparation method of the catalyst. In one embodiment, the product obtained from step b) is reacted with the solution of titanium-containing compound, a stirring, preferably continuous stirring, may be carried out during the reaction. Generally, such stirring lasts from about 0.5 to 8 h, preferably is 1˜5 h. The titanium-containing compound is shown as Ti(L²)ₕCl₄₋ₕ, Ti(L²)ₛCl₃₋ₛ, or Ti(L²)ₜCl₂₋ₜ, wherein, L² is C₁-C₂₀ alkyl group R³ or alkyl oxide group R³O, R³ may be saturated or unsaturated straight-chain, branched or cyclic chain, 0≦h≦4, 0≦s≦3, 0≦t≦2, when h, s and t is 2 or more than 2, the existed R³ may be same or different. The titanium compound is selected from trimethoxy titanium chloride, triethoxy titanium chloride, tri-n-propoxy titanium chloride, tri-iso-propoxy titanium chloride, dimethoxy titanium dichloride, diethoxy titanium dichloride, di-isopropoxy titanium dichloride, methoxy titanium trichloride, ethoxy titanium trichloride, titanium tetrachloride, titanium trichloride, titanium dichloride, ethyl titanium chloride et al. The molar ratio of the titanium-containing compound and the magnesium loading supported on carrier A is 0.01˜500, preferably, 0.1˜200. Generally, this period is carried out at room temperature to 200° C., preferably, 80˜180° C. If necessary, an internal electron donor may be added into the reaction system simultaneously, and the internal electron donor is selected from the donors mentioned before, the molar ratio of the internal electron donor and the magnesium loading on carrier A is 0.01˜500, preferably, 0.1˜50. C₃-C₂₀ alkane is used as washing solvent, such as n-heptane, hexane et al. at 0˜150° C., preferably, room temperature to 100° C. At last, the product is dried at room temperature to 250° C. for 2˜20 h, preferably, 80˜160° C. and 6˜12 h, and the drying process is also carried out under vacuum. The obtained catalyst is then transferred under nitrogen and stored.

As an example, the specific operations for preparing the catalyst of the present invention include:

A porous amorphous silica gel is impregnated with a solution of magnesium acetate of a certain concentration, wherein the loading of magnesium based on the total weight of the catalyst (e.g. 0.1˜40 wt %) satisfied the requirement in the present application. After being continuously stirred for a certain period of time (e.g. 4˜8 h), heated and dried, the silica gel support supporting the magnesium acetate is calcined under high-temperature in a fluidized bed, wherein at the low temperature stage (e.g. 100˜300° C.), the physical water of the support is removed under nitrogen and the magnesium acetate decomposes partially. At the high temperature stage (e.g. 300˜900° C.), hydroxyl group on the surface of the silica gel is removed under dry air and the magnesium acetate decomposes completely. The high temperature stage lasts a certain period of time (e.g. 3˜8 h). Finally, the product is naturally cooled down, and when the temperature is decreased to 300˜400° C., the atmosphere may be changed to nitrogen. Then, at a certain temperature (e.g. room temperature˜70° C.), the product obtained before reacts with organic magnesium compound (such as ethyl magnesium chloride), the molar ratio of the organic magnesium compound and the magnesium loading on carrier A is 0.1˜80. After continuous stirring (e.g. 10 min˜1 h), the product is washed with hexane at a certain temperature (e.g. room temperature to 100° C.) and dried at 60˜120° C. for 6˜12 h under inert gas, such as nitrogen, helium, argon et al, preferably is nitrogen, and this drying process is also carried out under vacuum. The product is transferred under the protection of nitrogen and stored. Finally, at a certain temperature (e.g. 80˜180° C.), the product obtained before reacts with TiCl₄, the molar ratio of TiCl₄ and the magnesium loading on carrier A is 0.1˜200. If necessary, an internal electron donor may be added into the reaction system, such as dibutylphthalate, the molar ratio of the internal electron donor and the magnesium loading on carrier A is 0.1˜50. After continuous stirring (e.g. 1˜5 h), the product is washed with hexane at a certain temperature (e.g. room temperature to 100° C.) and dried at 80˜160° C. for 6˜12 h under inert gas, such as nitrogen, helium, argon et al, preferably is nitrogen, and this drying process is also carried out under vacuum. The catalyst is transferred under the protection of nitrogen and stored.

One embodiment of the present invention comprises the steps of:

a) Carrier A is impregnated with a solution of soluble magnesium salt, then dried and calcined at high temperature of 300˜900° C.;

b) The product obtained from step a) is reacted with an organic aluminum compound, then dried;

c) The product obtained from step b) is reacted with the solution of titanium-containing compound, if necessary, an internal electron donor may be added into the reaction system simultaneously, and then followed by washing and drying, to prepare the catalyst.

A preferred process for preparing the supported polyolefin catalyst of the present invention comprises the steps of:

a) Carrier A is impregnated with a solution of soluble magnesium salt at 0 to 80° C. for 0.5˜12 h, preferably, room temperature to 70° C. and 4˜8 h, then drying at room temperature to 250° C. for 2˜20 h, preferably, 80° C. to 200° C. and 8˜15 h, the drying process may be also carried out under vacuum. Subsequently, the product is calcined and activated in an inert gas or oxygen or air at high temperature as 300˜900° C. for 1˜10 h, preferably, 400° C. to 800° C. and 3˜8 h, and cooling, wherein air is replaced with inert gas such as nitrogen or argon et al when it is cooled to 300˜400° C.

b) The product obtained from step a) is reacted with an organic aluminum compound at −90˜70° C. for 5 min˜2 h, preferably at −70 to 50° C. and 10 min˜1 h. Then the product is washed by C₃-C₂₀ alkane solvent such as n-heptane, hexane et al. at 0˜150° C., preferably, room temperature to 100° C. At last, the product is dried at room temperature to 250° C. for 2˜20 h, preferably, 60˜120° C. and 6˜12 h, and the drying process may also be carried out under vacuum. The product is then obtained and stored.

c) The product obtained from step b) is reacted with the solution of titanium-containing compound at room temperature to 200° C. for 0.5˜8 h, preferably, 80° C. to 180° C. and 1˜5 h. If necessary, an internal electron donor may be added into the reaction system simultaneously, then the product is washed by C₃-C₂₀ alkane solvent such as n-heptane, hexane et al. at 0˜150° C., preferably, room temperature to 100° C. At last, the product is dried at room temperature to 250° C. for 2˜20 h, preferably, 80˜160° C. and 6˜12 h, and the drying process may also be carried out under vacuum. The catalyst is then prepared and stored.

Generally, according to the present invention, carrier A is impregnated with the magnesium salt, a catalyst matrix supported magnesium compound is prepared after high temperature calcination, then the catalyst matrix is further reacted with the organic aluminum compound and titanium-containing compound subsequently, thereby, carrier B is synthesized in situ on the surface of carrier A and titanium species may also be supported simultaneously. If necessary, an internal electron donor may be added into the reaction system to prepare the supported olefin polymerization catalyst.

Said step a) relates to a method of depositing the soluble magnesium salt onto the support(carrier) A (for example the support mentioned above), and such method may be any method capable of depositing magnesium salt onto the support which is known by those skilled in the art. In one embodiment of the present invention, the method of depositing magnesium salt onto the support comprises impregnating porous support with the solution of magnesium salt, and magnesium salt may be any soluble magnesium salt as mentioned before. In one embodiment, a stirring preferably a continuous stirring, may be carried out during the impregnation process. Generally, such stirring lasts from about 1 to 12 h at 0˜80° C., preferably is 4˜8 h and room temperature to 70° C. In one embodiment, the loading of magnesium is at most 0.01˜50 wt % based on the total weight of the catalyst, preferably is 0.1˜40 wt %. Then the resultant magnesium-containing support is dried, generally at room temperature to 250° C., preferably is 80˜200° C. In one embodiment, the drying is conducted at about 120° C., and the drying process may also be carried out under vacuum. The duration period for such drying is not specially limited, but such drying generally lasts from about 2˜20 h, preferably is 7˜18 h, further preferably is 8˜15 h. After drying, the magnesium-containing carrier A is calcined. The calcining manner is not specifically limited, but it is preferably conducted within a fluidized bed. In one embodiment, such calcining is carried out by two stages as low temperature stage and high temperature stage. The low temperature stage is generally conducted at about 100 to 300° C., and the high temperature stage is generally conducted at about 300 to 900° C. Without any theoretical limitation, it is believed that the physical water of the support is removed during the low temperature stage, and the soluble magnesium salts decompose partially. The hydroxyl radical on the carrier A is removed during the high temperature stage, and the soluble magnesium salts decompose completely. In one embodiment, the low temperature stage lasts from 1 to 10 h, preferably from 2 to 9 h, further preferably from 3 to 8 h. In another embodiment, the high temperature stage lasts from 1 to 10 h, preferably from 2 to 9 h, further preferably from 3 to 8 h. In one embodiment, the low temperature stage is carried out under an inert atmosphere, wherein the inert gas is selected from, e.g. the inert gases as mentioned above, preferably high purity nitrogen. In one embodiment, the high temperature calcination stage is carried out in air or oxygen, preferably dry air. After calcining, the resultant support supporting magnesium-containing compound is cooled from the high temperature stage. In one embodiment, when the temperature is decreased to 300˜400° C., the atmosphere may be changed, e.g. from air to inert gas, such as nitrogen, argon et al. In one embodiment, such cooling is a natural falling of temperature.

Said step b) relates to a method of further modifying the surface of the product obtained from step a). In one embodiment, the product obtained from step a) is reacted with an organic aluminum compound, and the organic aluminum compound is selected from trialkylaluminum AlR₃, dialkyl alkoxide aluminum AlR₂OR, dialkyl aluminum halides AlR₂X, aluminoxane, triethyldialuminium trichloride et al, wherein, R is C₁-C₁₂ alkyl group, X is halogen, such as F, Cl, Br, I. The molar ratio of the organic aluminum compound and the magnesium loading on carrier A is 0.01˜100, preferably 0.1˜80. Generally, such stirring lasts from about 5 min to 2 h at −90˜70° C., preferably is 10 min to 1 h and −70˜50° C. C₃-C₂₀ alkane is used as washing solvent, such as n-heptane, hexane et al. at 0˜150° C., preferably, room temperature to 100° C. At last, the product is dried at room temperature to 250° C. for 2˜20 h, preferably, 60˜120° C. and 6˜12 h, and the drying process is also carried out under vacuum. The obtained product is transferred under nitrogen and stored.

Said step c) relates to a method of supporting support(carrier) B onto support(carrier) A and the preparation method of the catalyst. In one embodiment, the product obtained from step b) is reacted with the solution of titanium-containing compound, a stirring, preferably continuous stirring, may be carried out during the reaction. Generally, such stirring lasts from about 0.5 to 8 h, preferably is 1˜5 h. The titanium-containing compound is shown as Ti(L²)ₕCl₄₋ₕ, Ti(L²)ₛCl₃₋ₛ or Ti(L²)ₜCl₂₋ₜ, wherein, L² is C₁-C₂₀ alkyl group R³ or alkyl oxide group R³O, R³ may be saturated or unsaturated straight-chain, branched or cyclic chain, 0≦h≦4, 0≦s≦3, 0≦t≦2, when h, s and t is 2 or more than 2, the existed R³ may be same or different. The titanium compound is selected from trimethoxy titanium chloride, triethoxy titanium chloride, tri-n-propoxy titanium chloride, tri-iso-propoxy titanium chloride, dimethoxy titanium dichloride, diethoxy titanium dichloride, di-isopropoxy titanium dichloride, methoxy titanium trichloride, ethoxy titanium trichloride, titanium tetrachloride, titanium trichloride, titanium dichloride, ethyl titanium chloride et al. The molar ratio of the titanium-containing compound and the magnesium loading supported on carrier A is 0.01˜500, preferably, 0.1˜200. Generally, this period is carried out at room temperature to 200° C., preferably, 80˜180° C. If necessary, an internal electron donor may be added into the reaction system simultaneously, and the internal electron donor is selected from the donors mentioned before, the molar ratio of the internal electron donor and the magnesium loading on carrier A is 0.01˜500, preferably, 0.1˜50. C₃-C₂₀ alkane is used as washing solvent, such as n-heptane, hexane et al. at 0˜150° C., preferably, room temperature to 100° C. At last, the product is dried at room temperature to 250° C. for 2˜20 h, preferably, 80˜160° C. and 6˜12 h, and the drying process is also carried out under vacuum. Then the obtained catalyst is transferred under nitrogen and stored.

As an example, a method for preparing the catalyst of the present invention includes:

A porous amorphous silica gel is impregnated with a solution of magnesium acetate of a certain concentration, wherein the loading of the magnesium based on the total weight of the catalyst (e.g. 0.1˜40 wt %) satisfied the requirement in the present application. After being continuously stirred for a certain period of time (e.g. 4˜8 h), then heated and dried, the silica gel support supporting the magnesium acetate is calcined under high-temperature in a fluidized bed. Wherein at the low temperature stage (e.g. 100˜300° C.), the physical water of the support is removed under nitrogen and the magnesium acetate decomposes partially. At the high temperature stage (e.g. 300˜900° C.), hydroxyl group on the surface of the silica gel is removed under dry air and the magnesium acetate decomposes completely. The high temperature stage lasts a certain period of time (e.g. 3˜8 h). Finally, the product is naturally cooled down, and when the temperature is decreased to 300˜400° C., the atmosphere may be changed to nitrogen. Then, at a certain temperature (e.g. −70˜50° C.), the product obtained reacts with triethyl aluminum, the molar ratio of the organic aluminum compound and the magnesium loading on carrier A is 0.1˜80. After continuous stirring (e.g. 10 min˜1 h), the product is washed with hexane at a certain temperature (e.g. room temperature to 100° C.) and dried at 60˜120° C. for 6˜12 h under inert gas, such as nitrogen, helium, argon et al, preferably is nitrogen, and this drying process is also carried out under vacuum. The product is transferred under the protection of nitrogen and stored. Finally, at a certain temperature (e.g. 80˜180° C.), the product obtained reacts with TiCl₄, the molar ratio of TiCl₄ and the magnesium loading on carrier A is 0.1˜200. If necessary, an internal electron donor may be added into the reaction system, such as dibutylphthalate, the molar ratio of the internal electron donor and the magnesium loading on carrier A is 0.1˜50. After continuous stirring (e.g. 1˜5 h), the product is washed with hexane at a certain temperature (e.g. room temperature to 100° C.) and dried at 80˜160° C. for 6˜12 h under inert gas, such as nitrogen, helium, argon et al, preferably is nitrogen, and this drying process is also carried out under vacuum. Then the catalyst is transferred under the protection of nitrogen and stored.

One embodiment of the present invention which provides the supported polyolefin catalystcomprises steps of:

a) support(carrier) A is impregnated with a solution of soluble magnesium salt, then dried and calcined at high temperature of 300˜900° C.;

b) The product obtained from step a) is reacted with an organic aluminum compound and hydroxyl-containing compound successively before drying;

c) The product obtained from step b) is reacted with a solution of titanium-containing compound, if necessary, an internal electron donor may be added into the reaction system simultaneously, and then followed by washing and drying, to prepare the catalyst.

A preferred process for preparing the supported polyolefin catalyst of the present invention comprises the steps of:

a) Carrier A is impregnated with a solution of soluble magnesium salt at 0 to 80° C. for 0.5˜12 h, preferably, room temperature to 70° C. and 4˜8 h, then dried at room temperature to 250° C. for 2˜20 h, preferably, 80° C. to 200° C. and 8˜15 h, the drying process may be also carried out under vacuum. Subsequently, the product is calcined and activated in an inert gas or oxygen or air at high temperature as 300˜900° C. for 1˜10 h, preferably, 400° C. to 800° C. and 3˜8 h, and then cooled down, Wherein air is replaced with an inert gas such as nitrogen or argon et al when it is cooled to 300˜400° C.

b) The product obtained from step a) is reacted with an organic aluminum compound at −90˜70° C. for 5 min˜2 h, preferably at −70 to 50° C. and 10 min˜1 h. Then the product reacts with a hydroxyl-containing compound at 0 to 150° C., preferably, room temperature to 100° C. The reaction time depends on the properties of reactant and operation conditions, and the time is generally within 5 min to 2 h, preferably, 10 min to 1 h. Finally the product is washed by C₃-C₂₀ alkane solvent such as n-heptane, hexane et al. at 0˜150° C., preferably, room temperature to 100° C. At last, the product is dried at room temperature to 250° C. for 2˜20 h, preferably, 60˜120° C. and 6˜12 h, and the drying process may also be carried out under vacuum. Then the product is obtained and stored.

c) The product obtained from step b) is reacted with the solution of titanium-containing compound at room temperature to 200° C. for 0.5˜8 h, preferably, 80° C. to 180° C. and 1˜5 h. If necessary, internal electron donor may be added into the reaction system simultaneously, then the product is washed by C₃-C₂₀ alkane solvent such as n-heptane, hexane et al. at 0˜150° C., preferably, room temperature to 100° C. At last, the product is dried at room temperature to 250° C. for 2˜20 h, preferably, 80˜160° C. and 6˜12 h, and the drying process may also be carried out under vacuum. The catalyst is then prepared and stored.

Generally, according to the present invention, support(carrier) A is impregnated with the magnesium salt, a catalyst matrix supported magnesium compound is prepared after high temperature calcination, then the catalyst matrix is further reacted with the organic aluminum compound, hydroxyl containing compound and titanium-containing compound subsequently, thereby, carrier B is synthesized in situ on the surface of carrier A and titanium species may also be supported simultaneously. If necessary, an internal electron donor may be added into the reaction system to prepare the supported olefin polymerization catalyst.

Said step a) relates to a method of depositing soluble magnesium salt onto the carrier A (for example the support mentioned above), and such method may be any method capable of depositing magnesium salt onto the support, which is known by those skilled in the art. In one embodiment of the present invention, the method of depositing magnesium salt onto the support comprises impregnating porous support with solution of magnesium salt, and the magnesium salt may be any soluble magnesium salt as mentioned before. In one embodiment, a stirring, preferably continuous stirring, may be carried out during the impregnation process. Generally, such stirring lasts from about 1 to 12 h at 0˜80° C., preferably is 4˜8 h and room temperature to 70° C. In one embodiment, the loading of magnesium is at most 0.01˜50 wt % based on the total weight of the catalyst, preferably is 0.1˜40 wt %. Then the resultant magnesium-containing support is dried, generally at room temperature to 250° C., preferably is 80˜200° C. In one embodiment, the drying is conducted at about 120° C., and the drying process may also be carried out under vacuum. The duration period for such drying is not specially limited, but such drying generally lasts from about 2˜20 h, preferably is 7˜18 h, further preferably is 8˜15 h. After drying, the magnesium-containing carrier A is calcined. The calcining manner is not specifically limited, but it is preferably conducted within a fluidized bed. In one embodiment, such calcining is carried out by two stages as low temperature stage and high temperature stage. The low temperature stage is generally conducted at about 100 to 300° C., and the high temperature stage is generally conducted at about 300 to 900° C. Without any theoretical limitation, it is believed that the physical water of the support is removed during the low temperature stage, and the soluble magnesium salts decompose partially. The hydroxyl radical on the carrier A is removed during the high temperature stage, and the soluble magnesium salts decompose completely. In one embodiment, the low temperature stage lasts from 1 to 10 h, preferably from 2 to 9 h, further preferably from 3 to 8 h. In another embodiment, the high temperature stage lasts from 1 to 10 h, preferably from 2 to 9 h, further preferably from 3 to 8 h. In one embodiment, the low temperature stage is carried out under an inert atmosphere, wherein the inert gas is selected from, e.g. the inert gases as mentioned above, preferably high purity nitrogen. In one embodiment, the high temperature calcination stage is carried out in air or oxygen, preferably dry air. After calcining, the resultant support supporting magnesium-containing compound is cooled from the high temperature stage. In one embodiment, when the temperature is decreased to 300˜400° C., the atmosphere may be changed, e.g. from air to inert gas, such as nitrogen, argon et al. In one embodiment, such cooling is a natural falling of temperature.

Said step b) relates to a method of further modifying the surface of the product obtained from step a). In one embodiment, the product obtained from step a) is reacted with an organic aluminum compound, and the organic aluminum compound is selected from trialkylaluminum AlR₃, dialkyl alkoxide aluminum AlR₂OR, dialkyl aluminum halides AlR₂X, aluminoxane, triethyldialuminium trichloride et al, wherein, R is C₁-C₁₂ alkyl group, X is halogen, such as F, Cl, Br, I. The molar ratio of the organic aluminum compound and the magnesium loading on carrier A is 0.01˜100, preferably 0.1˜80. Generally, such stirring lasts from about 5 min to 2 h at −90˜70° C., preferably is 10 min to 1 h and −70˜50° C. The product obtained before reacts with hydroxyl-containing compound, and the general formula of hydroxyl-containing compound is HORS, wherein, R⁵ is C₁-C₂₀ alkyl group which may be saturated or unsaturated straight-chain, branched or cyclic chain, hydroxyl-containing compound is selected from ethanol, n-butanol, n-hexanol, isooctyl alcohol, benzyl alcohol and phenethyl alcohol et al. The molar ratio of the hydroxyl-containing compound and the magnesium loading on carrier A is 0.01˜200, preferably 0.1˜160. The reaction time depends on the properties of reactant and operation conditions, and the time is generally within 5 min to 2 h, preferably, 10 min to 1 h. Finally, C₃-C₂₀ alkane is used as washing solvent, such as n-heptane, hexane et al. at 0˜150° C., preferably, room temperature to 100° C. At last, the product is dried at room temperature to 250° C. for 2˜20 h, preferably, 60˜120° C. and 6˜12 h, and the drying process is also carried out under vacuum. The obtained product is then transferred under nitrogen and stored.

Said step c) relates to a method of supporting support(carrier) B onto support(carrier) A and the preparation method of the catalyst. In one embodiment, the product obtained from step b) is reacted with a solution of titanium-containing compound, a stirring preferably a continuous stirring, may be carried out during the reaction. Generally, such stirring lasts from about 0.5 to 8 h, preferably is 1˜5 h. The titanium-containing compound is shown as Ti(L²)ₕCl₄₋ₕ, Ti(L²)ₛCl₃₋ₛ or Ti(L²)ₜCl₂₋ₜ, wherein, L² is C₁-C₂₀ alkyl group R³ or alkyl oxide group R³O, R³ may be saturated or unsaturated straight-chain, branched or cyclic chain, 0≦h≦4, 0≦s≦3, 0≦t≦2, when h, s and t is 2 or more than 2, the R³ may be same or different. The titanium compound is selected from trimethoxy titanium chloride, triethoxy titanium chloride, tri-n-propoxy titanium chloride, tri-iso-propoxy titanium chloride, dimethoxy titanium dichloride, diethoxy titanium dichloride, di-isopropoxy titanium dichloride, methoxy titanium trichloride, ethoxy titanium trichloride, titanium tetrachloride, titanium trichloride, titanium dichloride, ethyl titanium chloride et al. The molar ratio of the titanium-containing compound and the magnesium loading supported on carrier A is 0.01˜500, preferably, 0.1˜200. Generally, this period is carried out at room temperature to 200° C., preferably, 80˜180° C. If necessary, internal electron donor may be added into the reaction system simultaneously, and the internal electron donor is selected from the donors mentioned before, the molar ratio of the internal electron donor and the magnesium loading on carrier A is 0.01˜500, preferably, 0.1˜50. C₃-C₂₀ alkane is used as washing solvent, such as n-heptane, hexane et al. at 0˜150° C., preferably, room temperature to 100° C. At last, the product is dried at room temperature to 250° C. for 2˜20 h, preferably, 80˜160° C. and 6˜12 h, and the drying process is also carried out under vacuum. The obtained catalyst is transferred under nitrogen and stored.

An example of the method for preparing the catalyst of the present invention includes:

A porous amorphous silica gel is impregnated with a solution of magnesium acetate of a certain concentration, wherein the loading of the magnesium based on the total weight of the catalyst (e.g. 0.1˜40 wt %) satisfied the requirement in the present application. After being continuously stirred for a certain period of time (e.g. 4˜8 h), then heated and dried, the silica gel support supporting the magnesium acetate is high-temperature calcined in a fluidized bed, wherein at the low temperature stage (e.g. 100˜300° C.), the physical water of the support is removed under nitrogen and the magnesium acetate decompose partially. At the high temperature stage (e.g. 300˜900° C.), hydroxyl group on the surface of the silica gel is removed under dry air and the magnesium acetate decompose completely. The high temperature stage lasts a certain period of time (e.g. 3˜8 h). Finally, the product is naturally cooled down, and when the temperature is decreased to 300˜400° C., the atmosphere may be changed to nitrogen. Then, at a certain temperature (e.g. −70˜50° C.), the product obtained before reacts with triethyl aluminum, the molar ratio of the organic aluminum compound and the magnesium loading on carrier A is 0.1˜80. Later then, the product reacts with n-hexanol at a certain temperature (such as room temperature to 100° C.), and the molar ratio of n-hexanol and the magnesium loading on carrier A is 0.1˜160. After continuous stirring (e.g. 10 min˜1 h) the product obtained before is washed with hexane at a certain temperature (e.g. room temperature to 100° C.) and dried at 60˜120° C. for 6˜12 h under inert gas, such as nitrogen, helium, argon et al, preferably is nitrogen, and this drying process is also carried out under vacuum. The product is transferred under the protection of nitrogen and stored. Finally, at a certain temperature (e.g. 80˜180° C.), the product obtained before reacts with TiCl₄, the molar ratio of TiCl₄ and the magnesium loading on carrier A is 0.1˜200. If necessary, an internal electron donor may be added into the reaction system, such as dibutylphthalate. The molar ratio of the internal electron donor and the magnesium loading on carrier A is 0.1˜50. After continuous stirring (e.g. 1˜5 h), the product is washed with hexane at a certain temperature (e.g. room temperature to 100° C.) and dried at 80˜160° C. for 6˜12 h under inert gas, such as nitrogen, helium, argon et al, preferably is nitrogen, and this drying process is also carried out under vacuum. Then the catalyst is transferred under the protection of nitrogen and stored.

One embodiment of the present invention which provides the supported polyolefin catalystcomprises the steps of:

a) Carrier A is impregnated with a solution of soluble magnesium salt and an ammonium salt, then dried and calcined at high temperature of 300˜900° C.;

b) The product obtained from step a) is reacted with the solution of titanium-containing compound, if necessary, an internal electron donor may be added into the reaction system simultaneously, followed by washing and drying, the catalyst is prepared.

A preferred process for preparing a supported polyolefin catalyst of the present invention comprises the steps of:

a) Carrier A is impregnated with the solution of soluble magnesium salt and ammonium salt at 0 to 80° C. for 0.5˜12 h, preferably, room temperature to 70° C. and 4˜8 h, then dried at room temperature to 250° C. for 2˜20 h, preferably, 80° C. to 200° C. and 8˜15 h, the drying process may be also carried out under vacuum. Subsequently, the product is calcined and activated in an inert gas or oxygen or air at high temperature as 300˜900° C. for 1˜10 h, preferably, 400° C. to 800° C. and 3˜8 h, and cooling, wherein air is replaced with an inert gas such as nitrogen or argon et al when it is cooled to 300˜400° C.

b) The product obtained from step a) is reacted with the solution of titanium-containing compound at room temperature to 200° C. for 0.5˜8 h, preferably, 80° C. to 180° C. and 1˜5 h. If necessary, the internal electron donor may be added into the reaction system simultaneously, then the product is washed by C₃-C₂₀ alkane solvent such as n-heptane, hexane et al. at 0˜150° C., preferably, room temperature to 100° C. At last, the product is dried at room temperature to 250° C. for 2˜20 h, preferably, 80˜160° C. and 6˜12 h, and then the catalyst is prepared and stored.

Generally, according to the present invention, carrier A is impregnated with the magnesium salt and ammonium salt, a catalyst matrix supported magnesium compound is prepared after high temperature calcination, then the catalyst matrix is further reacted with the titanium-containing compound subsequently, thereby, carrier B is synthesized in situ on the surface of carrier A and titanium species may also be supported simultaneously. If necessary, an internal electron donor may be added into the reaction system to prepare the supported olefin polymerization catalyst.

Said step a) relates to a method of depositing soluble magnesium salt and ammonium salt onto the carrier A (for example the support mentioned above), and such method may be any method capable of depositing magnesium salt and ammonium salt onto the support, which is known by those skilled in the art. In one embodiment of the present invention, the method of depositing magnesium salt and ammonium salt onto the support comprises impregnating the porous support with solution of magnesium salt and ammonium salt, and the magnesium salt and the ammonium salt may be any soluble magnesium salt and ammonium salt as mentioned before. In one embodiment, a stirring, preferably continuous stirring may be carried out during the impregnation process. Generally, such stirring lasts from about 1 to 12 h at 0˜80° C., preferably is 4˜8 h and room temperature to 70° C. In one embodiment, the loading of magnesium is at most 0.01˜50 wt % based on the total weight of the catalyst, preferably is 0.1˜40 wt %, the molar ratio of the ammonium salt and the magnesium salt is 0.01˜10. Then the resultant magnesium- and ammonium-supporting support is dried, generally at room temperature to 250° C., preferably is 80˜200° C. In one embodiment, the drying is conducted at about 120° C., and the drying process may also be carried out under vacuum. The duration period for such drying is not specially limited, but such drying generally lasts from about 2˜20 h, preferably is 7˜18 h, further preferably is 8˜15 h. After drying, the magnesium- and ammonium-supporting carrier A is calcined. The calcining manner is not specifically limited, but it is preferably conducted within a fluidized bed. In one embodiment, such calcining is carried out by two stages as low temperature stage and high temperature stage. The low temperature stage is generally conducted at about 100 to 300° C., and the high temperature stage is generally conducted at about 300 to 900° C. Without any theoretical limitation, it is believed that the physical water of the support is removed during the low temperature stage, and the soluble magnesium salt and ammonium salt decomposes partially. The hydroxyl radical on the carrier A is removed during the high temperature stage, and the soluble magnesium salt and the ammonium salt decomposes completely. In one embodiment, the low temperature stage lasts from 1 to 10 h, preferably from 2 to 9 h, further preferably from 3 to 8 h. In another embodiment, the high temperature stage lasts from 1 to 10 h, preferably from 2 to 9 h, further preferably from 3 to 8 h. In one embodiment, the low temperature stage is carried out under an inert atmosphere, wherein the inert gas is selected from, e.g. the inert gases as mentioned above, preferably high purity nitrogen. In one embodiment, the calcining is carried out in air or oxygen, preferably dry air. After calcining, the resultant support supporting magnesium-containing compound is cooled from the high temperature stage. In one embodiment, when the temperature is decreased to 300˜400° C., the atmosphere may be changed, e.g. from air to inert gas, such as nitrogen, argon et al. In one embodiment, such cooling is a natural falling of temperature.

Said step b) relates to a method of supporting support(carrier) B onto support(carrier) A and the preparation method of the catalyst. In one embodiment, the product obtained from step a) is reacted with the solution of titanium-containing compound, a stirring may be carried out during the reaction, preferably continuous stirring. Generally, such stirring lasts from about 0.5 to 8 h, preferably is 1˜5 h. The titanium-containing compound is shown as Ti(L²)ₕCl₄₋ₕ, Ti(L²)ₛCl₃₋ₛ or Ti(L²)ₜCl₂₋ₜ, wherein, L² is C₁-C₂₀ alkyl group R³ or alkyl oxide group R³O, R³ may be saturated or unsaturated straight-chain, branched or cyclic chain, 0≦h≦4, 0≦s≦3, 0≦t≦2, when h, s and t is 2 or more than 2, the existed R³ may be same or different. The titanium compound is selected from trimethoxy titanium chloride, triethoxy titanium chloride, tri-n-propoxy titanium chloride, tri-iso-propoxy titanium chloride, dimethoxy titanium dichloride, diethoxy titanium dichloride, di-isopropoxy titanium dichloride, methoxy titanium trichloride, ethoxy titanium trichloride, titanium tetrachloride, titanium trichloride, titanium dichloride, ethyl titanium chloride et al. The molar ratio of the titanium-containing compound and the magnesium loading supported on carrier A is 0.01˜500, preferably, 0.1˜200. Generally, this period is carried out at room temperature to 200° C., preferably, 80˜180° C. If necessary, internal electron donor may be added into the reaction system simultaneously, and the internal electron donor is selected from the donors mentioned before, the molar ratio of the internal electron donor and the magnesium loading on carrier A is 0.01˜500, preferably, 0.1˜50. C₃-C₂₀ alkane is used as washing solvent, such as n-heptane, hexane et al. at 0˜150° C., preferably, room temperature to 100° C. At last, the product is dried at room temperature to 250° C. for 2˜20 h, preferably, 80˜160° C. and 6˜12 h, and the drying process is also carried out under vacuum. Then the obtained catalyst is transferred under nitrogen and stored.

As an example, the specific operations for preparing the catalyst of the present invention include:

A porous amorphous silica gel is impregnated with a solution of magnesium acetate and ammonium acetate of a certain concentration, wherein the loading of magnesium and ammonium based on the total weight of the catalyst (e.g. 0.1˜40 wt % for Mg, the molar ratio of the ammonium salt and the magnesium salt is 0.01˜10) satisfied the requirement in the present application. After being continuously stirred for a certain period of time (e.g. 4˜8 h), heated and dried, the silica gel support supporting the magnesium acetate and ammonium acetate are high-temperature calcined in a fluidized bed, wherein at the low temperature stage (e.g. 100˜300° C.), the physical water of the support is removed under nitrogen and magnesium acetate and the ammonium acetate decomposes partially. At the high temperature stage (e.g. 300˜900° C.), hydroxyl group on the surface of the silica gel is removed under dry air and the magnesium acetate and the ammonium acetate decomposes completely. The high temperature stage lasts a certain period of time (e.g. 3˜8 h). Finally, the product is naturally cooled down, and when the temperature is decreased to 300˜400° C., the atmosphere may be changed to nitrogen. Then, at a certain temperature (e.g. 80˜180° C.), the product obtained before reacts with TiCl₄, the molar ratio of TiCl₄ and the magnesium loading on carrier A is 0.1˜200. If necessary, an internal electron donor may be added into the reaction system, such as dibutylphthalate, the molar ratio of the internal electron donor and the magnesium loading on carrier A is 0.1˜50. After continuous stirring (e.g. 1˜5 h), the product is washed with hexane at a certain temperature (e.g. room temperature to 100° C.) and dried at 80˜160° C. for 6˜12 h under inert gas, such as nitrogen, helium, argon et al, preferably is nitrogen, and this drying process is also carried out under vacuum. Then the catalyst is transferred under the protection of nitrogen and stored.

One embodiment of the present invention comprises the steps of:

a) Carrier A is impregnated with a solution of soluble magnesium salt and ammonium salt, then dried and calcined at high temperature of 300˜900° C.;

b) The product obtained from step a) is reacted with an organic magnesium compound, then drying;

c) The product obtained from step b) is reacted with a solution of titanium-containing compound, if necessary, an internal electron donor may be added into the reaction system simultaneously, and then through washing and drying to prepare the catalyst.

A preferred process for preparing a supported polyolefin catalyst of the present invention comprises the steps of:

a) Carrier A is impregnated with the solution of soluble magnesium salt and ammonium salt at 0 to 80° C. for 0.5˜12 h, preferably, room temperature to 70° C. and 4˜8 h, then dried at room temperature to 250° C. for 2˜20 h, preferably, 80° C. to 200° C. and 8˜15 h. The drying process may be also carried out under vacuum. Subsequently, the product is calcined and activated in an inert gas or oxygen or air at high temperature as 300˜900° C. for 1˜10 h, preferably, 400° C. to 800° C. and 3˜8 h, and cooling, wherein air is replaced with an inert gas such as nitrogen or argon et al when it is cooled to 300˜400° C.

b) The product obtained from step a) is reacted with the organic magnesium compound at 0˜150° C. for 5 min˜2 h, preferably at room temperature to 70° C. and 10 min˜1 h. Then the product is washed by C₃-C₂₀ alkane solvent such as n-heptane, hexane et al. at 0˜150° C., preferably, room temperature to 100° C. At last, the product is dried at room temperature to 250° C. for 2˜20 h, preferably, 60˜120° C. and 6˜12 h, and the drying process may also be carried out under vacuum. Then the product is obtained and stored.

c) The product obtained from step b) is reacted with the solution of titanium-containing compound at room temperature to 200° C. for 0.5˜8 h, preferably, 80° C. to 180° C. and 1˜5 h. If necessary, an internal electron donor may be added into the reaction system simultaneously, then the product is washed by C₃-C₂₀ alkane solvent such as n-heptane, hexane et al. at 0˜150° C., preferably, room temperature to 100° C. At last, the product is dried at room temperature to 250° C. for 2˜20 h, preferably, 80˜160° C. and 6˜12 h, and the drying process may also be carried out under vacuum. Then the catalyst is prepared and stored.

Generally, according to the present invention, carrier A is impregnated with the magnesium salt and ammonium salt, a catalyst matrix supported magnesium compound is prepared after high temperature calcination, then the catalyst matrix is further reacted with the organic magnesium compound and titanium-containing compound subsequently, thereby, carrier B is synthesized in situ on the surface of carrier A and titanium species also supported simultaneously. If necessary, an internal electron donor may be added into the reaction system to prepare the supported olefin polymerization catalyst.

Said step a) relates to a method of depositing the soluble magnesium salt and the ammonium salt onto the carrier A (for example the support mentioned above), and such method may be any method capable of depositing magnesium salt and ammonium salt onto the support, which is known by those skilled in the art. In one embodiment of the present invention, the method of depositing the magnesium salt and the ammonium salt onto the support comprises impregnating porous support with solution of the magnesium salt and the ammonium salt, and the magnesium salt and ammonium salt may be any soluble magnesium salt and ammonium salt as mentioned before. In one embodiment, a stirring, preferably continuous stirring, may be carried out during the impregnation process. Generally, such stirring lasts from about 1 to 12 h at 0˜80° C., preferably is 4˜8 h and room temperature to 70° C. In one embodiment, the loading of the magnesium is at most 0.01˜50 wt % based on the total weight of the catalyst, preferably is 0.1˜40 wt %, the molar ratio of the ammonium salt and the magnesium salt is 0.01˜10. Then the resultant magnesium- and ammonium-supporting support is dried, generally at room temperature to 250° C., preferably is 80˜200° C. In one embodiment, the drying is conducted at about 120° C., and the drying process may also be carried out under vacuum. The duration period for such drying is not specially limited, but such drying generally lasts from about 2˜20 h, preferably is 7˜18 h, further preferably is 8˜15 h. After drying, the magnesium- and ammonium-supporting carrier A is calcined. The calcining manner is not specifically limited, but it is preferably conducted within a fluidized bed. In one embodiment, such calcining is carried out by two stages as low temperature stage and high temperature stage. The low temperature stage is generally conducted at about 100 to 300° C., and the high temperature stage is generally conducted at about 300 to 900° C. Without any theoretical limitation, it is believed that the physical water of the support is removed during the low temperature stage, and the soluble magnesium salt and ammonium salt decompose partially. The hydroxyl radical on the carrier A is removed during the high temperature stage, and the soluble magnesium salt and ammonium salt decompose completely. In one embodiment, the low temperature stage lasts from 1 to 10 h, preferably from 2 to 9 h, further preferably from 3 to 8 h. In another embodiment, the high temperature stage lasts from 1 to 10 h, preferably from 2 to 9 h, further preferably from 3 to 8 h. In one embodiment, the low temperature stage is carried out under an inert atmosphere, wherein the inert gas is selected from, e.g. the inert gases as mentioned above, preferably high purity nitrogen. In one embodiment, the calcining is carried out in air or oxygen, preferably dry air. After calcining, the resultant support supporting magnesium-containing compound is cooled from the high temperature stage. In one embodiment, when the temperature is decreased to 300˜400° C., the atmosphere may be changed, e.g. from air to inert gas, such as nitrogen, argon et al. In one embodiment, such cooling is a natural falling of temperature.

Said step b) relates to a method of further modifying the surface of the product obtained from step a). In one embodiment, the organic magnesium compound is R⁴ₚMgX₂₋ₚ, wherein, R⁴ is C₁-C₂₀ alkyl group which may be saturated or unsaturated straight-chain, branched or cyclic chain, 0<p<2, X is halogen, such as F, Cl, Br, I. The organic magnesium compound is selected from methyl magnesium chloride, ethyl magnesium chloride, butyl magnesium chloride, allyl magnesium chloride, isopropyl magnesium chloride, t-butyl magnesium chloride, 2-methyl butyl magnesium chloride, 1-heptyl magnesium chloride, 1-pentyl magnesium chloride, 1-hexyl magnesium chloride, 1,1-dimethylpropyl magnesium chloride, cyclopentyl magnesium chloride, vinyl magnesium chloride, 2-butyl magnesium chloride, 1-octyl magnesium chloride et al. The molar ratio of the organic magnesium compound and the magnesium loading on carrier A is 0.01˜100, preferably 0.1˜80. Generally, such stirring lasts from about 5 min to 2 h at 0˜150° C., preferably is 10 min to 1 h and 0˜70° C. C₃-C₂₀ alkane is used as washing solvent, such as n-heptane, hexane et al. at 0˜150° C., preferably, room temperature to 100° C. At last, the product is dried at room temperature to 250° C. for 2˜20 h, preferably, 60˜120° C. and 6˜12 h, and the drying process is also carried out under vacuum. Then the obtained product is transferred under nitrogen and stored.

Said step c) relates to a method of supporting support(carrier) B onto support(carrier) A and the preparation method of the catalyst. In one embodiment, the product obtained from step b) is reacted with solution of titanium-containing compound, a stirring, preferably continuous stirring, may be carried out during the reaction. Generally, such stirring lasts from about 0.5 to 8 h, preferably is 1˜5 h. The titanium-containing compound is shown as Ti(L²)ₕCl₄₋ₕ, Ti(L²)ₛCl₃₋ₛ or Ti(L²)ₜCl₂-t, wherein, L² is C₁-C₂₀ alkyl group R³ or alkyl oxide group R³O, R³ may be saturated or unsaturated straight-chain, branched or cyclic chain, 0≦h≦4, 0≦s≦3, 0≦t≦2, when h, s and t is 2 or more than 2, the R³ may be same or different. The titanium compound is selected from trimethoxy titanium chloride, triethoxy titanium chloride, tri-n-propoxy titanium chloride, tri-iso-propoxy titanium chloride, dimethoxy titanium dichloride, diethoxy titanium dichloride, di-isopropoxy titanium dichloride, methoxy titanium trichloride, ethoxy titanium trichloride, titanium tetrachloride, titanium trichloride, titanium dichloride, ethyl titanium chloride et al. The molar ratio of the titanium-containing compound and the magnesium loading supported on carrier A is 0.01˜500, preferably, 0.1˜200. Generally, this period is carried out at room temperature to 200° C., preferably, 80˜180° C. If necessary, an internal electron donor may be added into the reaction system simultaneously, and the internal electron donor is selected from the donors mentioned before, the molar ratio of the internal electron donor and the magnesium loading on carrier A is 0.01˜500, preferably, 0.1˜50. C₃-C₂₀ alkane is used as washing solvent, such as n-heptane, hexane et al. at 0˜150° C., preferably, room temperature to 100° C. At last, the product is dried at room temperature to 250° C. for 2˜20 h, preferably, 80˜160° C. and 6˜12 h, and the drying process is also carried out under vacuum. The obtained catalyst is then transferred under nitrogen and stored.

As an example, the specific operations for preparing the catalyst of the present invention include:

A porous amorphous silica gel is impregnated with solution of magnesium acetate and ammonium acetate of a certain concentration, wherein the loading of the magnesium and the ammonium based on the total weight of the catalyst (e.g. 0.1˜40 wt % for Mg, the molar ratio of the ammonium salt and the magnesium salt is 0.01˜10) satisfied the requirement in the present application. After being continuously stirred for a certain period of time (e.g. 4˜8 h), heated and dried, the silica gel support supporting the magnesium acetate and ammonium acetate are high-temperature calcined in a fluidized bed, wherein at the low temperature stage (e.g. 100˜300° C.), the physical water of the support is removed under nitrogen and magnesium acetate and ammonium acetate decompose partially. At the high temperature stage (e.g. 300˜900° C.), hydroxyl group on the surface of the silica gel is removed under dry air and magnesium acetate and ammonium acetate decompose completely. The high temperature stage lasts a certain period of time (e.g. 3˜8 h). Finally, the product is naturally cooled down, and when the temperature is decreased to 300˜400° C., the atmosphere may be changed to nitrogen. Then, at a certain temperature (e.g. room temperature-70° C.), the product obtained reacts with organic magnesium compound (such as ethyl magnesium chloride), the molar ratio of the organic magnesium compound and the magnesium loading on carrier A is 0.1˜80. After continuous stirring (e.g. 10 min˜1 h), the product is washed with hexane at a certain temperature (e.g. room temperature to 100° C.) and dried at 60˜120° C. for 6˜12 h under an inert gas, such as nitrogen, helium, argon et al, preferably is nitrogen, and this drying process is also carried out under vacuum. The product is then transferred under the protection of nitrogen and stored. Finally, at a certain temperature (e.g. 80˜180° C.), the product obtained before reacts with TiCl₄, the molar ratio of TiCl₄ and the magnesium loading on carrier A is 0.1˜200. If necessary, internal electron donor may be added into the reaction system, such as dibutylphthalate, the molar ratio of the internal electron donor and the magnesium loading on carrier A is 0.1˜50. After continuous stirring (e.g. 1˜5 h), the product is washed with hexane at a certain temperature (e.g. room temperature to 100° C.) and dried at 80˜160° C. for 6˜12 h under inert gas, such as nitrogen, helium, argon et al, preferably is nitrogen, and this drying process is also carried out under vacuum. The catalyst is then transferred under the protection of nitrogen and stored.

One embodiment of the present invention which provides the supported polyolefin catalyst comprises the steps of:

a) support(carrier) A, is impregnated with a solution of soluble magnesium salt and ammonium salt, then dried and calcined at high temperature of 300˜900° C.;

b) The product obtained from step a) is reacted with an organic aluminum compound, then dried;

c) The product obtained from step b) is reacted with a solution of titanium-containing compound, if necessary, an internal electron donor may be added into the reaction system simultaneously, and then through washing and drying, to prepare catalyst.

A preferred process for preparing the supported polyolefin catalyst of the present invention comprises the steps of:

a) Carrier A is impregnated with the solution of soluble magnesium salt and ammonium salt at 0 to 80° C. for 0.5˜12 h, preferably, room temperature to 70° C. and 4˜8 h, then dried at room temperature to 250° C. for 2˜20 h, preferably, 80° C. to 200° C. and 8˜15 h, the drying process may be also carried out under vacuum. Subsequently, the product is calcined and activated in an inert gas or oxygen or air at high temperature as 300˜900° C. for 1˜10 h, preferably, 400° C. to 800° C. and 3˜8 h, and cooled, wherein air is replaced with an inert gas such as nitrogen or argon et al when it is cooled to 300˜400° C.

b) The product obtained from step a) is reacted with the organic aluminum compound at −90˜70° C. for 5 min˜2 h, preferably at −70 to 50° C. and 10 min˜1 h. Then the product is washed by C₃-C₂₀ alkane solvent such as n-heptane, hexane et al. at 0˜150° C., preferably, room temperature to 100° C. At last, the product is dried at room temperature to 250° C. for 2˜20 h, preferably, 60˜120° C. and 6˜12 h, and the drying process may also be carried out under vacuum. Then the product is obtained and stored.

c) The product obtained from step b) is reacted with the solution of titanium-containing compound at room temperature to 200° C. for 0.5˜8 h, preferably, 80° C. to 180° C. and 1˜5 h. If necessary, internal electron donor may be added into the reaction system simultaneously, then the product is washed by C₃-C₂₀ alkane solvent such as n-heptane, hexane et al. at 0˜150° C., preferably, room temperature to 100° C. At last, the product is dried at room temperature to 250° C. for 2˜20 h, preferably, 80˜160° C. and 6˜12 h, and the drying process may also be carried out under vacuum. Then the catalyst is prepared and stored.

Generally, according to the present invention, carrier A is impregnated with the magnesium salt and ammonium salt, a catalyst matrix supported magnesium compound is prepared after high temperature calcination, then the catalyst matrix is further reacted with the organic aluminum compound and titanium-containing compound subsequently, thereby, carrier B is synthesized in situ on the surface of carrier A and titanium species also supported simultaneously. If necessary, an internal electron donor may be added into the reaction system to prepare the supported olefin polymerization catalyst.

Said step a) relates to a method of depositing the soluble magnesium salt and ammonium salt onto the carrier A (for example the support mentioned above), and such method may be any method capable of depositing magnesium salt and ammonium salt onto the support, which is known by those skilled in the art. In one embodiment of the present invention, the method of depositing the magnesium salt and ammonium salt onto the support comprises impregnating porous support with the solution of magnesium salt and the ammonium salt, and magnesium salt and ammonium salt may be any soluble magnesium salt and ammonium salt as mentioned before. In one embodiment, a stirring, preferably continuous stirring, may be carried out during the impregnation process. Generally, such stirring lasts from about 1 to 12 h at 0˜80° C., preferably is 4˜8 h and room temperature to 70° C. In one embodiment, the loading of the magnesium is at most 0.01˜50 wt % based on the total weight of the catalyst, preferably is 0.1˜40 wt %, the molar ratio of the ammonium salt and the magnesium salt is 0.01˜10. Then the resultant magnesium- and ammonium-supporting support is dried, generally at room temperature to 250° C., preferably is 80˜200° C. In one embodiment, the drying is conducted at about 120° C., and the drying process may also be carried out under vacuum. The duration period for such drying is not specially limited, but such drying generally lasts from about 2˜20 h, preferably is 7˜18 h, further preferably is 8˜15 h. After drying, the magnesium- and ammonium-supporting carrier A is calcined. The calcining manner is not specifically limited, but it is preferably conducted within a fluidized bed. In one embodiment, such calcining is carried out by two stages as low temperature stage and high temperature stage. The low temperature stage is generally conducted at about 100 to 300° C., and the high temperature stage is generally conducted at about 300 to 900° C. Without any theoretical limitation, it is believed that the physical water of the support is removed during the low temperature stage, and the soluble magnesium salt and ammonium salt decompose partially. The hydroxyl radical on the carrier A is removed during the high temperature stage, and the soluble magnesium salt and ammonium salt decompose completely. In one embodiment, the low temperature stage lasts from 1 to 10 h, preferably from 2 to 9 h, further preferably from 3 to 8 h. In another embodiment, the high temperature stage lasts from 1 to 10 h, preferably from 2 to 9 h, further preferably from 3 to 8 h. In one embodiment, the low temperature stage is carried out under an inert atmosphere, wherein the inert gas is selected from, e.g. the inert gases as mentioned above, preferably high purity nitrogen. In one embodiment, the calcining is carried out in air or oxygen, preferably dry air. After calcining, the resultant support supporting magnesium-containing compound is cooled downfrom the high temperature stage. In one embodiment, when the temperature is decreased to 300˜400° C., the atmosphere may be changed, e.g. from air to inert gas, such as nitrogen, argon et al. In one embodiment, such cooling down is a natural falling of temperature.

Said step b) relates to a method of further modifying the surface of the product obtained from step a). In one embodiment, the product obtained from step a) is reacted with an organic aluminum compound, and the organic aluminum compound is selected from trialkylaluminum AlR₃, dialkyl alkoxide aluminum AlR₂OR, dialkyl aluminum halides AlR₂X, aluminoxane, triethyldialuminium trichloride et al, wherein, R is C₁-C₁₂ alkyl group, X is halogen, such as F, Cl, Br, I. The molar ratio of the organic aluminum compound and the magnesium loading on carrier A is 0.01˜100, preferably 0.1˜80. Generally, such stirring lasts from about 5 min to 2 h at −90˜70° C., preferably is 10 min to 1 h and −70˜50° C. C₃-C₂₀ alkane is used as washing solvent, such as n-heptane, hexane et al. at 0˜150° C., preferably, room temperature to 100° C. At last, the product is dried at room temperature to 250° C. for 2˜20 h, preferably, 60˜120° C. and 6˜12 h, and the drying process is also carried out under vacuum. The obtained product is then transferred under nitrogen and stored.

Said step c) relates to a method of supporting support(carrier) B onto support(carrier) A and the preparation method of the catalyst. In one embodiment, the product obtained from step b) is reacted with the solution of titanium-containing compound, a stirring, preferably continuous stirring, may be carried out during the reaction. Generally, such stirring lasts from about 0.5 to 8 h, preferably is 1˜5 h. The titanium-containing compound is shown as Ti(L²)ₕCl₄₋ₕ, Ti(L²)ₛCl₃₋ₛ or Ti(L²)ₜCl₂-t, wherein, L² is C₁-C₂₀ alkyl group R³ or alkyl oxide group R³O, R³ may be saturated or unsaturated straight-chain, branched or cyclic chain, 0≦h≦4, 0≦s≦3, 0≦t≦2, when h, s and t is 2 or more than 2, the existed R³ may be same or different. The titanium compound is selected from trimethoxy titanium chloride, triethoxy titanium chloride, tri-n-propoxy titanium chloride, tri-iso-propoxy titanium chloride, dimethoxy titanium dichloride, diethoxy titanium dichloride, di-isopropoxy titanium dichloride, methoxy titanium trichloride, ethoxy titanium trichloride, titanium tetrachloride, titanium trichloride, titanium dichloride, ethyl titanium chloride et al. The molar ratio of the titanium-containing compound and the magnesium loading supported on carrier A is 0.01˜500, preferably, 0.1˜200. Generally, this period is carried out at room temperature to 200° C., preferably, 80˜180° C. If necessary, internal electron donor may be added into the reaction system simultaneously, and the internal electron donor is selected from the donors mentioned before, the molar ratio of the internal electron donor and the magnesium loading on carrier A is 0.01˜500, preferably, 0.1˜50. C₃-C₂₀ alkane is used as washing solvent, such as n-heptane, hexane et al. at 0˜150° C., preferably, room temperature to 100° C. At last, the product is dried at room temperature to 250° C. for 2˜20 h, preferably, 80˜160° C. and 6˜12 h, and the drying process is also carried out under vacuum. The obtained catalyst is then transferred under nitrogen and stored.

As an example, a specific operation for preparing the catalyst of the present invention includes:

A porous amorphous silica gel is impregnated with the solution of magnesium acetate and the ammonium acetate of a certain concentration, wherein the loading of the magnesium and ammonium based on the total weight of the catalyst (e.g. 0.1˜40 wt % for Mg, the molar ratio of the ammonium salt and the magnesium salt is 0.01˜10) satisfied the requirement in the present application. After being continuously stirred for a certain period of time (e.g. 4˜8 h), heated and dried, the silica gel support supporting the magnesium acetate and ammonium acetate are high-temperature calcined in a fluidized bed, wherein at the low temperature stage (e.g. 100˜300° C.), the physical water of the support is removed under nitrogen and magnesium acetate and ammonium acetate decompose partially. At the high temperature stage (e.g. 300˜900° C.), hydroxyl group on the surface of the silica gel is removed under dry air and magnesium acetate and ammonium acetate decompose completely. The high temperature stage lasts a certain period of time (e.g. 3˜8 h). Finally, the product is naturally cooled down, and when the temperature is decreased to 300˜400° C., the atmosphere may be changed to nitrogen. Then, at a certain temperature (e.g. −70˜50° C.), the product obtained reacts with triethyl aluminum, the molar ratio of the organic aluminum compound and the magnesium loading on carrier A is 0.1˜80. After continuous stirring (e.g. 10 min˜1 h), the product is washed with hexane at a certain temperature (e.g. room temperature to 100° C.) and dried at 60˜120° C. for 6˜12 h under inert gas, such as nitrogen, helium, argon et al, preferably is nitrogen, and this drying process is also carried out under vacuum. The product is transferred under the protection of nitrogen and stored. Finally, at a certain temperature (e.g. 80˜180° C.), the product obtained before reacts with TiCl₄, the molar ratio of TiCl₄ and the magnesium loading on carrier A is 0.1˜200. If necessary, internal electron donor may be added into the reaction system, such as dibutylphthalate, the molar ratio of the internal electron donor and the magnesium loading on carrier A is 0.1˜50. After continuous stirring (e.g. 1˜5 h), the product is washed with hexane at a certain temperature (e.g. room temperature to 100° C.) and dried at 80˜160° C. for 6˜12 h under inert gas, such as nitrogen, helium, argon et al, preferably is nitrogen, and this drying process is also carried out under vacuum. The catalyst is transferred under the protection of nitrogen and stored.

One embodiment of the present invention comprises the steps of:

a) support(carrier) A is impregnated with the solution of soluble magnesium salt and the ammonium salt, then dried and calcined at high temperature of 300˜900° C.;

b) The product obtained from step a) is reacted with an organic aluminum compound and hydroxyl-containing compound successively before drying;

c) The product obtained from step b) is reacted with the solution of titanium-containing compound, if necessary, an internal electron donor may be added into the reaction system simultaneously, and then through washing and drying, to prepare the catalyst.

A preferred process for preparing a supported polyolefin catalyst of the present invention comprises the steps of:

a) Carrier A is impregnated with of the soluble magnesium salt and ammonium salt carrier A at 0 to 80° C. for 0.5˜12 h, preferably, room temperature to 70° C. and 4˜8 h, then dried at room temperature to 250° C. for 2˜20 h, preferably, 80° C. to 200° C. and 8˜15 h, the drying process may be also carried out under vacuum. Subsequently, the product is calcined and activated in an inert gas or oxygen or air at high temperature as 300˜900° C. for 1˜10 h, preferably, 400° C. to 800° C. and 3˜8 h, and cooling, wherein air is replaced with an inert gas such as nitrogen or argon et al when it is cooled to 300˜400° C.

b) The product obtained from step a) is reacted with an organic aluminum compound at −90˜70° C. for 5 min˜2 h, preferably at −70 to 50° C. and 10 min˜1 h. Then the product is reacted with a hydroxyl-containing compound at 0 to 150° C., preferably, room temperature to 100° C. The reaction time depends on the properties of reactant and operation conditions, and the time is generally within 5 min to 2 h, preferably, 10 min to 1 h. Finally the product is washed by C₃-C₂₀ alkane solvent such as n-heptane, hexane et al. at 0˜150° C., preferably, room temperature to 100° C. At last, the product is dried at room temperature to 250° C. for 2˜20 h, preferably, 60˜120° C. and 6˜12 h, and the drying process may also be carried out under vacuum. Then the product is obtained and stored.

c) The product obtained from step b) is reacted with the solution of titanium-containing compound at room temperature to 200° C. for 0.5˜8 h, preferably, 80° C. to 180° C. and 1˜5 h. If necessary, internal electron donor may be added into the reaction system simultaneously, then the product is washed by C₃-C₂₀ alkane solvent such as n-heptane, hexane et al. at 0˜150° C., preferably, room temperature to 100° C. At last, the product is dried at room temperature to 250° C. for 2˜20 h, preferably, 80˜160° C. and 6˜12 h, and the drying process may also be carried out under vacuum. Then the catalyst is prepared and stored.

Generally, according to the present invention, carrier A is impregnated with the magnesium salt and ammonium salt, a catalyst matrix supported magnesium compound is prepared after high temperature calcination. Then the catalyst matrix is further reacted with an organic aluminum compound, hydroxyl-containing compound and titanium-containing compound subsequently, thereby, support(carrier) B is synthesized in situ on the surface of carrier A and titanium species is also supported simultaneously. If necessary, an internal electron donor may be added into the reaction system to prepare the supported olefin polymerization catalyst.

Said step a) relates to a method of depositing soluble magnesium salt and ammonium salt onto the carrier A (for example the support mentioned above), and such method may be any method, known by those skilled in the art, capable of depositing magnesium salt and ammonium salt onto the support. In one embodiment of the present invention, the method of depositing magnesium salt and ammonium salt onto the support comprises impregnating porous support with solution of magnesium salt and ammonium salt, and magnesium salt and ammonium salt may be any soluble magnesium salt and ammonium salt as mentioned before. In one embodiment, stirring may be carried out during the impregnation process, preferably continuous stirring. Generally, such stirring lasts from about 1 to 12 h at 0˜80° C., preferably is 4˜8 h and room temperature to 70° C. In one embodiment, the loading of magnesium is at most 0.01˜50 wt % based on the total weight of the catalyst, preferably is 0.1˜40 wt %, the molar ratio of the ammonium salt and the magnesium salt is 0.01˜10. Then the resultant magnesium- and ammonium-supporting support is dried, generally at room temperature to 250° C., preferably is 80˜200° C. In one embodiment, the drying is conducted at about 120° C., and the drying process may also be carried out under vacuum. The duration period for such drying is not specially limited, but such drying generally lasts from about 2˜20 h, preferably is 7˜18 h, further preferably is 8˜15 h. After drying, the magnesium- and ammonium-supporting carrier A is calcined. The calcining manner is not specifically limited, but it is preferably conducted within a fluidized bed. In one embodiment, such calcining is carried out by two stages as low temperature stage and high temperature stage. The low temperature stage is generally conducted at about 100 to 300° C., and the high temperature stage is generally conducted at about 300 to 900° C. Without any theoretical limitation, it is believed that the physical water of the support is removed during the low temperature stage, and the soluble magnesium salt and ammonium salt decompose partially. The hydroxyl radical on the carrier A is removed during the high temperature stage, and the soluble magnesium salt and ammonium salt decompose completely. In one embodiment, the low temperature stage lasts from 1 to 10 h, preferably from 2 to 9 h, further preferably from 3 to 8 h. In another embodiment, the high temperature stage lasts from 1 to 10 h, preferably from 2 to 9 h, further preferably from 3 to 8 h. In one embodiment, the low temperature stage is carried out under an inert atmosphere, wherein the inert gas is selected from, e.g. the inert gases as mentioned above, preferably high purity nitrogen. In one embodiment, the calcining is carried out in air or oxygen, preferably dry air. After calcining, the resultant support supporting magnesium-containing compound is cooled from the high temperature stage. In one embodiment, when the temperature is decreased to 300˜400° C., the atmosphere may be changed, e.g. from air to inert gas, such as nitrogen, argon et al. In one embodiment, such cooling is a natural falling of temperature.

Said step b) relates to a method of further modifying the surface of the product obtained from step a). In one embodiment, the product obtained from step a) is reacted with organic aluminum compound, and the organic aluminum compound is selected from trialkylaluminum AlR₃, dialkyl alkoxide aluminum AlR₂OR, dialkyl aluminum halides AlR₂X, aluminoxane, triethyldialuminium trichloride et al, wherein, R is C₁-C₁₂ alkyl group, X is halogen, such as F, Cl, Br, I. The molar ratio of the organic aluminum compound and the magnesium loading on carrier A is 0.01˜100, preferably 0.1˜80. Generally, such stirring lasts from about 5 min to 2 h at −90˜70° C., preferably is 10 min to 1 h and −70˜50° C. The product obtained before reacts with hydroxyl-containing compound, and the general formula of hydroxyl-containing compound is HORS, wherein, R⁵ is C₁-C₂₀ alkyl group which may be saturated or unsaturated straight-chain, branched or cyclic chain, hydroxyl-containing compound is selected from ethanol, n-butanol, n-hexanol, isooctyl alcohol, benzyl alcohol and phenethyl alcohol et al. The molar ratio of the hydroxyl-containing compound and the magnesium loading on carrier A is 0.01˜200, preferably 0.1˜160. The reaction time depends on the properties of reactant and operation conditions, and the time is generally within 5 min to 2 h, preferably, 10 min to 1 h. Finally, C₃-C₂₀ alkane is used as washing solvent, such as n-heptane, hexane et al. at 0˜150° C., preferably, room temperature to 100° C. At last, the product is dried at room temperature to 250° C. for 2˜20 h, preferably, 60˜120° C. and 6˜12 h, and the drying process is also carried out under vacuum. The obtained product is transferred under nitrogen and stored.

Said step c) relates to a method of supporting carrier B onto carrier A and the preparation method of the catalyst. In one embodiment, the product obtained from step b) is reacted with solution of titanium-containing compound, stirring may be carried out during the reaction, preferably continuous stirring. Generally, such stirring lasts from about 0.5 to 8 h, preferably is 1˜5 h. The titanium-containing compound is shown as Ti(L²)ₕCl₄₋ₕ, Ti(L²)ₛCl₃₋ₛ or Ti(L²)ₜCl₂₋ₜ, wherein, L² is C₁-C₂₀ alkyl group R³ or alkyl oxide group R³O, R³ may be saturated or unsaturated straight-chain, branched or cyclic chain, 0≦h≦4, 0≦s≦3, 0≦t≦2, when h, s and t is 2 or more than 2, the existed R³ may be same or different. The titanium compound is selected from trimethoxy titanium chloride, triethoxy titanium chloride, tri-n-propoxy titanium chloride, tri-iso-propoxy titanium chloride, dimethoxy titanium dichloride, diethoxy titanium dichloride, di-isopropoxy titanium dichloride, methoxy titanium trichloride, ethoxy titanium trichloride, titanium tetrachloride, titanium trichloride, titanium dichloride, ethyl titanium chloride et al. The molar ratio of the titanium-containing compound and the magnesium loading supported on carrier A is 0.01˜500, preferably, 0.1˜200. Generally, this period is carried out at room temperature to 200° C., preferably, 80˜180° C. If necessary, internal electron donor may be added into the reaction system simultaneously, and the internal electron donor is selected from the donors mentioned before, the molar ratio of the internal electron donor and the magnesium loading on carrier A is 0.01˜500, preferably, 0.1˜50. C₃-C₂₀ alkane is used as washing solvent, such as n-heptane, hexane et al. at 0˜150° C., preferably, room temperature to 100° C. At last, the product is dried at room temperature to 250° C. for 2˜20 h, preferably, 80˜160° C. and 6˜12 h, and the drying process is also carried out under vacuum. The obtained catalyst is transferred under nitrogen and stored.

As an example, the specific operation for preparing the catalyst of the present invention includes:

A porous amorphous silica gel is impregnated with solution of magnesium acetate and ammonium acetate of a certain concentration, wherein the loading of magnesium and ammonium based on the total weight of the catalyst (e.g. 0.1˜40 wt % for Mg, the molar ratio of the ammonium salt and the magnesium salt is 0.01˜10) satisfied the requirement in the present application. After being continuously stirred for a certain period of time (e.g. 4˜8 h), heated and dried, the silica gel support supporting the magnesium acetate and ammonium acetate are high-temperature calcined in a fluidized bed, wherein at the low temperature stage (e.g. 100˜300° C.), the physical water of the support is removed under nitrogen and magnesium acetate and ammonium acetate decompose partially. At the high temperature stage (e.g. 300˜900° C.), hydroxyl group on the surface of the silica gel is removed under dry air and magnesium acetate and ammonium acetate decompose completely. The high temperature stage lasts a certain period of time (e.g. 3˜8 h). Finally, the product is naturally cooled down, and when the temperature is decreased to 300˜400° C., the atmosphere may be changed to nitrogen. Then, at a certain temperature (e.g. −70˜50° C.), the product obtained reacts with triethyl aluminum, the molar ratio of the organic aluminum compound and the magnesium loading on carrier A is 0.1˜80. Later then, the product is reacted with n-hexanol at a certain temperature (such as room temperature to 100° C.), and the molar ratio of n-hexanol and the magnesium loading on carrier A is 0.1˜160. After continuous stirring (e.g. 10 min˜1 h) the product obtained before is washed with hexane at a certain temperature (e.g. room temperature to 100° C.) and dried at 60˜120° C. for 6˜12 h under inert gas, such as nitrogen, helium, argon et al, preferably is nitrogen, and this drying process is also carried out under vacuum. The product is transferred under the protection of nitrogen and stored. Finally, at a certain temperature (e.g. 80˜180° C.), the product obtained before reacts with TiCl₄, the molar ratio of TiCl₄ and the magnesium loading on carrier A is 0.1˜200. If necessary, an internal electron donor may be added into the reaction system, such as dibutylphthalate, the molar ratio of the internal electron donor and the magnesium loading on carrier A is 0.1˜50. After continuous stirring (e.g. 1˜5 h), the product is washed with hexane at a certain temperature (e.g. room temperature to 100° C.) and dried at 80˜160° C. for 6˜12 h under inert gas, such as nitrogen, helium, argon et al, preferably is nitrogen, and this drying process is also carried out under vacuum. The catalyst then is transferred under the protection of nitrogen and stored.

One embodiment of the present invention comprises the steps of:

a) Any catalyst is prepared according to one of the eight catalyst preparation methods mentioned above;

b) The pre-catalyst is pre-reduced by adding organometallic cocatalyst, such as organic aluminum compound, organic lithium compound, organic boron compound et al. The molar ratio of the organometallic cocatalyst and the titanium species is 0.01˜1000, the catalyst is prepared and stored.

A preferred process for preparing the supported polyolefin catalyst of the present invention comprises the steps of:

a) Any catalyst is prepared according to one of the eight catalyst preparation methods mentioned above;

b) The pre-catalyst is pre-reduced by adding an organometallic cocatalyst, such as organic aluminum compound, organic lithium compound, organic boron compound et al. The reaction time and temperature are 0.1˜5 h and 0˜200° C., respectively, preferably 0.5˜2 h and room temperature to 160° C., respectively. Then the product is dried at room temperature to 250° C. for 2˜20 h, preferably 80˜160° C. and 6˜12 h, and the drying process may also be carried out under vacuum. Then the catalyst is prepared and stored.

Generally, according to the present invention, the prepared catalyst is reacted with organic aluminum compound, organic lithium compound, or organic boron compound et al. to be pre-reduced and thereby prepare the supported olefin polymerization catalyst.

Said step a) relates to a method of catalyst preparation according to one of the eight catalyst preparation methods mentioned above;

Said step b) relates to a method of catalyst pre-reduction. In one embodiment, a stirring, preferably continuous stirring, may be carried out during the impregnation process. Generally, such stirring lasts from about 0.1 to 5 h, preferably is 0.5˜2 h. In one embodiment, the product obtained from step a) is reacted with organic aluminum compound, organic lithium compound, organic boron compound et al. which may be added to pre-reduced the catalyst, wherein, organic aluminum compound include trialkylaluminum AlR₃, dialkyl alkoxide aluminum AlR₂OR, dialkyl aluminum halides AlR₂X, aluminoxane, triethyldialuminium trichloride et al, wherein, R is C₁-C₂₀ alkyl group, X is halogen, such as F, Cl, Br, I. The general formula of organic lithium compound is LiR⁶, wherein, R⁶ is C₁-C₂₀ alkyl group which may be saturated or unsaturated straight-chain, branched or cyclic chain, organic lithium compound is selected from methyl lithium, ethyl lithium, butyl lithium, t-butyl lithium, pentyl lithium, phenyl lithium et al. The general formula of organic boron compound is BR⁷_{q}Cl₃-_{q}, wherein, R⁷ is C₁-C₂₀ alkyl group or alkoxy group, 0<q<3, the organic boron compound is selected from trimethyl boron, triethyl boron, dichloro-methyl boron, dichloro-ethyl boron, dichloro-butyl boron, dichloro-methoxy boron, dichloro-ethoxy boron, boron trichloride and dichloro-butoxy group. The molar ratio of the organometallic cocatalyst and the titanium species is 0.01˜1000, preferably 0.05˜500, further preferably 0.1˜300. The reaction time and temperature are 0.1˜5 h and 0˜200° C., respectively, preferably 0.5˜2 h and room temperature to 160° C., respectively. Then the product is dried at room temperature to 250° C. for 2˜20 h, preferably 80˜160° C. and 6˜12 h, and the drying process may also be carried out under vacuum. The catalyst is prepared and stored.

As an example, a specific operation for preparing the catalyst of the present invention includes:

Any catalyst is prepared according to one of the eight catalyst preparation method mentioned above at a certain temperature (e.g. room temperature-160° C.), the product obtained is reacted with trihexylaluminium by dropping rihexylaluminium slowly, the molar ratio of trihexylaluminium and the titanium species is 0.1˜300. After continuous stirring (e.g. 0.5˜2 h), the product is dried at 80˜160° C. for 6˜12 h under inert gas, such as nitrogen, helium, argon et al, preferably is nitrogen, and this drying process is also carried out under vacuum. Then the catalyst is transferred under the protection of nitrogen and stored.

The present invention relates to a supported olefin polymerization catalyst and the olefin homopolymerization or copolymerization applications, preferably the homopolymerization or copolymerization of ethylene, propylene, butene, hexene and octene. An organometallic cocatalyst, an external donor or hydrogen may be added into the reaction system if necessary.

Thus, according to another aspect of the invention, it provides a method to produce olefin homopolymers and copolymers by using the catalyst praparation mentioned above.

As for the process above, the olefin(s) used for polymerization generally comprises ethylene or propylene as the polymerization monomer. The comonomer may be C₃-C₂₀ α-olefin, e.g. propylene, 1-butene, 1-pentene, 1-hexene, 1-heptene, 1-octene, 1-nonene, 1-decene, 1-dodecylene, 4-methyl-l-pentene, 4-methyl-l-hexene et al., which may be used alone or in combinations of two or more. The comonomer is preferably selected from the group consisting of 1-butene, 1-hexene, 1-octene and 1-decene. Ethylene may also be used as comonomer when copolymerized with α-olefin. When the comonomer exits, the amount thereof generally ranges from 0 to 30 vol %, preferably 0 to 10 vol % based on the solvent used during the polymerization.

An organometallic cocatalyst may be added into the polymerizaion system if necessary (such as the organometallic cocatalyst mentioned above). In one embodiment, the organometallic cocatalyst may use an organic aluminum compound, such as triethylaluminum, triisobutylaluminum, diethylaluminum ethoxide, diethylaluminum chloride and methyl alumoxane, etc. The amount of the organic aluminum compound is measured by Al/Ti molar ratio as 0˜1000, preferably 0˜500, further preferably 0˜300.

An external electron donor may be added into the polymerization system and the external electron donor is selected from the following compound as shown in figure (V), such as alkoxy silane compound or other monocarboxylic acids, polycarboxylic acids, carboxylic acid anhydrides, carboxylic acid esters, aromatic esters, ketones, ethers, alcohols, amines, lactones, organophosphorus compounds and alkoxysilane compounds, which may be any one or their combination, generally well known in the art for the polymerization of olefins external electron donor.

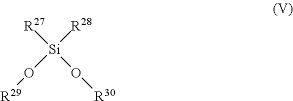

Wherein, R²⁷-R³⁰ may be same or different hydrogen or C₁-C₂₀ alkyl, which may be saturated or unsaturated straight-chain, branched or cyclic chain. The external electron donor selects from methyl formate, ethyl acetate, butyl acetate, ethyl ether, diethyl ether, tetrahydrofuran (THF), acetone, methyl isobutyl ketone, methyl benzoate, ethyl benzoate, diethyl phthalate, acid n-butyl phthalic, N-propyl trimethoxy silane, methyl trimethoxy silane, N-octyl trimethoxy silane, n-butyl methyl dimethoxy silane, phenyl triethoxy silane, cyclohexyl dimethoxysilane, bis cyclopentyl dimethoxysilane, bis isopropyl dimethoxysilane, bis-isobutyl dimethoxysilane et al, and combinations thereof. The molar ratio of the external electron donor and the titanium species is 0.01˜500, preferably, 0.1˜300.

The polymerization may use a molecular weight regulator, such as hydrogen as an example.

As for the aforesaid process for preparing polymers , there is no special limitation to the polymerization process. The processes for preparing olefin polymers by using the supported catalyst of the present invention may include gas phase polymerization, slurry polymerization, suspension polymerization, bulk polymerization, solution polymerization et al. As understood by those skilled in the art, there is no special limitation to the process for preparing olefin polymers by using the supported catalyst of the present invention, and the process may be carried out by using the conventional implementation solutions and polymerization conditions of gas phase polymerization, slurry polymerization, suspension polymerization, bulk polymerization and solution polymerization known in the art.

In one embodiment, a slurry polymerization is used, in which an ethylene or propylene is added into the reactor, and then a solvent and cocatalyst (such as organic aluminum compound), and optionally, hydrogen, an external electron donor and comonomer(s), and finally the supported catalyst of the present invention is added to start the polymerization.

The solvent used in the slurry polymerization is any solvent for olefin polymerization generally known in the art. The solvent may be C₃-C₂₀ alkanes, such as propane, n-butane, isobutane, n-pentane, isopentane, neopentane, n-hexane, cyclohexane, n-heptane, n-octane et al. These solvents may be used alone or may be used in combination of two or more. The solvent is preferably isobutane, pentane, hexane, cyclohexane, n-heptane et al.

More specifically, one embodiment carried out by the conventional slurry polymerization compriese following specific operations:

The polymerization reactor is firstly heated under vacuum, and then replaced with highly pure nitrogen, which is repeated for three times. A small amount of monomeric ethylene is further used to replace once. Finally, the reactor is filled with ethylene or propylene to a slightly positive pressure (0.12 MPa). Then a refined solvent treated by dehydration and deoxidation and a certain amount of alkylaluminium as the cocatalyst are added into the reactor. In the hydrogen regulation and copolymerization experiments,a certain amount of hydrogen and comonomer(s) is/are needed to add into the system respectively, and an external electron donor may be added in propylene polymerizatio, finally, when the pressure of ethylene or propylene is adjusted to 0.15MPa, the catalyst of present invention is added to start the polymerization. The instantaneous consumption of monomeric ethylene is on-line collected (by a high-precision ethylene or propylene mass flow meter connecting with a computer) during the reaction and recorded by the computer. After the reaction is conducted at a certain temperature (e.g. 35˜100° C.) for a certain period of time (e.g. 1 h), a mixed solution of hydrochloric acid/ethanol is added to terminate the reaction, and the polymer is washed, vacuum dried, weighed and analyzed.

### Adventages of the Technical Effect

The present invention relates to a supported olefin polymerization catalyst, preparation method and its application in the production of olefin homopolymers and olefin copolymers. According to the invention, any porous inorganic carrier with any inexpensive soluble magnesium salts are used as raw materials, and the catalyst is prepared by impregnation of solution of soluble Mg-compounds on inorganic carrier, and forming a supported thin layer of magnesium compound on the surface of the inorganic carrier after high temperature calcination, followed by further reacting with chlorinated titanium compound to synthesize the support containing magnesium compound in situ and to support the titanium species simultaneously. According to the invention, the method for preparing catalyst is simple, easy to control catalyst morphology, cost thereof is low, and the resulting composite supported Ziegler-Natta catalyst shows excellent performance in olefin polymerization.

### BRIEF DESCRIPTION OF THE DRAWINGS

FIG. 1 represents the calcination process of the catalyst.

### DESCRIPTION OF THE PREFERRED EMBODIMENTS OF THE INVENTION

The present invention is more detailedly illustrated by reference to the following examples, but is not limited by these examples. The silica gel used in the examples is Davison 955.

The properties of polymers are measured as follows:

High temperature gel permeation chromatography (HT-GPC)

The molecular weight and molecular weight distribution of polymers were measured by HT-GPC (PL-220) using 1,2,4-trichlorobenzene as solvent. The data obtained is processed by the universal method of correction based on the narrow-distributed polystyrene standard products.

### Example 1

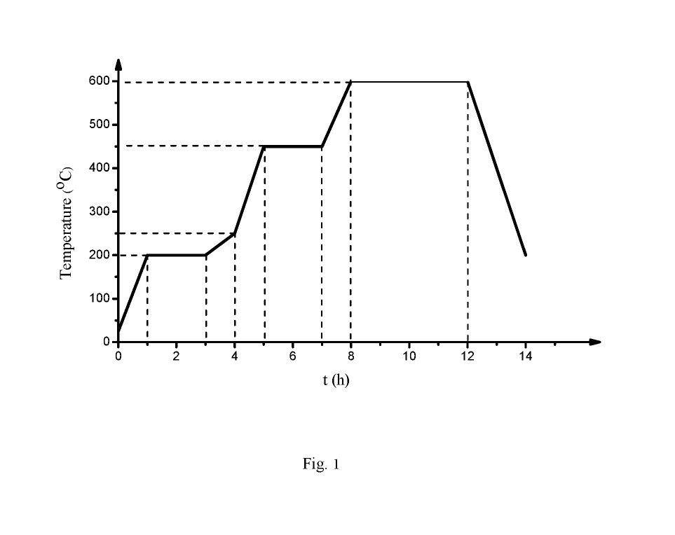

10 g of silica gel (pore volume of 1.5˜1.7 cm³/g and surface area of 250˜300 m²/g) was impregnated with solution of magnesium nitrate (Mg loading is 15 wt %). After being continuously stirred for 5 h at room temperature, then heated to 120° C. for drying 5 h and dried at 120° C. for 6 h in drying oven. The silica gel support supporting the magnesium nitrate was calcined in a fluidized bed. Nitrogen was used before the temperature reaches to 300° C., and then atmosphere changed to high purity air and kept 600° C. for 4 h. Finally, the product was naturally cooled down to 400° C. under the protection of nitrogen gas. The high temperature calcining and then cooling processes above are shown in FIG. 1. 2 g product (catalyst matrix) obtained reacted with 30 ml TiCl₄ at 140° C. for 2 h, and washed with n-hexane several times at room temperature. Finally the product was dried under vaccum and the catalyst was obtained.

### Example 2

10 g of silica gel (pore volume of 1.5˜1.7 cm³/g and surface area of 250˜300 m²/g) was impregnated with solution of magnesium acetate (Mg loading is 15 wt %). After being continuously stirred for 5 h at room temperature, then heated to 120° C. for drying 5 h and dried at 120° C. for 6 h in drying oven. The silica gel support supporting the magnesium acetate was calcined in a fluidized bed. Nitrogen was used before the temperature reaches to 300° C., and then atmosphere changed to high purity air and kept 600° C. for 4 h. Finally, the product was naturally cooled down to 400° C. under the protection of nitrogen gas. The high temperature calcining and then cooling processes above are shown in FIG. 1. 2 g product (catalyst matrix) obtained before reacted with 30 ml TiCl₄ at 140° C. for 2 h, and washed with n-hexane several times at room temperature. Finally the product was dried under vaccum and the catalyst was obtained.

### Example 3

10 g of silica gel (pore volume of 1.5˜1.7 cm³/g and surface area of 250˜300 m²/g) was impregnated with solution of magnesium acetate (Mg loading is 15 wt %). After being continuously stirred for 5 h at room temperature, then heated to 120° C. for drying 5 h and dried at 120° C. for 6 h in drying oven. The silica gel support supporting the magnesium acetate was calcined in a fluidized bed. Nitrogen was used before the temperature reaches to 300° C., and then atmosphere changed to high purity air and kept 600° C. for 4 h. Finally, the product was naturally cooled down to 400° C. under the protection of nitrogen gas. The high temperature calcining and then cooling processes above are shown in FIG. 1. 2 g product (catalyst matrix) obtained before reacted with 30 ml TiCl₄ at 140° C. for 2 h, and washed with n-hexane three times at 70° C. and washed at room temperature several times. Finally the product was dried under vaccum and the catalyst was obtained.

### Example 4

10 g of silica gel (pore volume of 1.5˜1.7 cm³/g and surface area of 250˜300 m²/g) was impregnated with solution of magnesium acetate (Mg loading is 1 wt %). After being continuously stirred for 5 h at room temperature, then heated to 120° C. for drying 5 h and dried at 120° C. for 6 h in drying oven. The silica gel support supporting the magnesium acetate was calcined in a fluidized bed. Nitrogen was used before the temperature reaches to 300° C., and then atmosphere changed to high purity air and kept 600° C. for 4 h. Finally, the product was naturally cooled down to 400° C. under the protection of nitrogen gas. The high temperature calcining and then cooling processes above are shown in FIG. 1. 2 g product (catalyst matrix) obtained before reacted with 30 ml TiCl₄ at 140° C. for 2 h, and washed with n-hexane three times at 70° C. and washed at room temperature several times. Finally the product was dried under vaccum and the catalyst was obtained.

### Example 5

10 g of silica gel (pore volume of 1.5˜1.7 cm³/g and surface area of 250˜300 m²/g) was impregnated with solution of magnesium acetate (Mg loading is 15 wt %). After being continuously stirred for 5 h at room temperature, then heated to 120° C. for drying 5 h and dried at 120° C. for 6 h in drying oven. The silica gel support supporting the magnesium acetate was calcined in a fluidized bed. Nitrogen was used before the temperature reaches to 300° C., and then atmosphere changed to high purity air and kept 600° C. for 4 h. Finally, the product was naturally cooled down to 400° C. under the protection of nitrogen gas. The high temperature calcining and then cooling processes above are shown in FIG. 1. The product reacted with ethyle magnesium chloride (organic Mg/supported Mg=0.1) at 25° C. for 30 min, and washed with n-hexane several times, dried under vaccum. 2 g product (catalyst matrix) obtained before reacted with 30 ml TiCl₄ at 140° C. for 2 h, and washed with n-hexane several times at room temperature. Finally the product was dried under vaccum and the catalyst was obtained.

### Example 6

10 g of silica gel (pore volume of 1.5˜1.7 cm³/g and surface area of 250˜300 m²/g) was impregnated with solution of magnesium acetate (Mg loading is 15 wt %). After being continuously stirred for 5 h at room temperature, then heated to 120° C. for drying 5 h and dried at 120° C. for 6 h in drying oven. The silica gel support supporting the magnesium acetate was calcined in a fluidized bed. Nitrogen was used before the temperature reaches to 300° C., and then atmosphere changed to high purity air and kept 600° C. for 4 h. Finally, the product was naturally cooled down to 400° C. under the protection of nitrogen gas. The high temperature calcining and then cooling processes above are shown in FIG. 1. The product reacted with triethyl aluminum (Al/supported Mg=0.1) at 25° C. for 30 min, and washed with n-hexane several times, dried under vaccum. 2 g product (catalyst matrix) obtained before reacted with 30 ml TiCl₄ at 140° C. for 2 h, and washed with n-hexane several times at room temperature. Finally the product was dried under vaccum and the catalyst was obtained.

### Example 7

10 g of silica gel (pore volume of 1.5˜1.7 cm³/g and surface area of 250˜300 m²/g) was impregnated with solution of magnesium acetate (Mg loading is 15 wt %). After being continuously stirred for 5 h at room temperature, then heated to 120° C. for drying 5 h and dried at 120° C. for 6 h in drying oven. The silica gel support supporting the magnesium acetate was calcined in a fluidized bed. Nitrogen was used before the temperature reaches to 300° C., and then atmosphere changed to high purity air and kept 600° C. for 4 h. Finally, the product was naturally cooled down to 400° C. under the protection of nitrogen gas. The high temperature calcining and then cooling processes above are shown in FIG. 1. The product reacted with triethyl aluminum (Al/supported Mg=0.1) at 25° C. for 30 min, then reacted with n-hexanol (alcohol/supported Mg=2) at 90° C. for 3 min, and washed with n-hexane several times, dried under vaccum. 2 g product (catalyst matrix) obtained before reacted with 30 ml TiCl₄ at 140° C. for 2 h, and washed with n-hexane several times at room temperature. Finally the product was dried under vaccum and the catalyst was obtained.

### Example 8

10 g of silica gel (pore volume of 1.5˜1.7 cm³/g and surface area of 250˜300 m²/g) was impregnated with solution of magnesium acetate (Mg loading is 5 wt %). After being continuously stirred for 5 h at room temperature, then heated to 120° C. for drying 5 h and dried at 120° C. for 6 h in drying oven. The silica gel support supporting the magnesium acetate was calcined in a fluidized bed. Nitrogen was used before the temperature reaches to 300° C., and then atmosphere changed to high purity air and kept 600° C. for 4 h. Finally, the product was naturally cooled down to 400° C. under the protection of nitrogen gas. The high temperature calcining and then cooling processes above are shown in FIG. 1. 2 g product (catalyst matrix) obtained before reacted with 30 ml TiCl₄ at 140° C. for 2 h, and washed with n-hexane several times at room temperature. Finally the product was dried under vaccum and the catalyst was obtained.

### Example 9

10 g of silica gel (pore volume of 1.5˜1.7 cm³/g and surface area of 250˜300 m²/g) was impregnated with solution of magnesium acetate (Mg loading is 10 wt %). After being continuously stirred for 5 h at room temperature, then heated to 120° C. for drying 5 h and dried at 120° C. for 6 h in drying oven. The silica gel support supporting the magnesium acetate was calcined in a fluidized bed. Nitrogen was used before the temperature reaches to 300° C., and then atmosphere changed to high purity air and kept 600° C. for 4 h. Finally, the product was naturally cooled down to 400° C. under the protection of nitrogen gas. The high temperature calcining and then cooling processes above are shown in FIG. 1. 2 g product (catalyst matrix) obtained before reacted with 30 ml TiCl₄ at 140° C. for 2 h, and washed with n-hexane several times at room temperature. Finally the product was dried under vaccum and the catalyst was obtained.

### Example 10

10 g of silica gel (pore volume of 1.5˜1.7 cm³/g and surface area of 250˜300 m²/g) was impregnated with solution of magnesium acetate and ammonium acetate (Mg loading is 15 wt %, the molar ratio of ammonium acetate and magnesium acetate is 1:1). After being continuously stirred for 5 h at room temperature, then heated to 120° C. for drying 5 h and dried at 120° C. for 6 h in drying oven. The silica gel support supporting the magnesium acetate and ammonium acetate were calcined in a fluidized bed. Nitrogen was used before the temperature reaches to 300° C., and then atmosphere changed to high purity air and kept 600° C. for 4 h. Finally, the product was naturally cooled down to 400° C. under the protection of nitrogen gas. The high temperature calcining and then cooling processes above are shown in FIG. 1. 2 g product (catalyst matrix) obtained before reacted with 30 ml TiCl₄ at 140° C. for 2 h, and washed with n-hexane several times at room temperature. Finally the product was dried under vaccum and the catalyst was obtained.

### Example 11

10 g of silica gel (pore volume of 1.5˜1.7 cm³/g and surface area of 250˜300 m²/g) was impregnated with solution of magnesium acetate and ammonium acetate (Mg loading is 15 wt %, the molar ratio of ammonium acetate and magnesium acetate is 1:1). After being continuously stirred for 5 h at room temperature, then heated to 120° C. for drying 5 h and dried at 120° C. for 6 h in drying oven. The silica gel support supporting the magnesium acetate and ammonium acetate were calcined in a fluidized bed. Nitrogen was used before the temperature reaches to 300° C., and then atmosphere changed to high purity air and kept 600° C. for 4 h. Finally, the product was naturally cooled down to 400° C. under the protection of nitrogen gas. The high temperature calcining and then cooling processes above are shown in FIG. 1. The product reacted with ethyle magnesium chloride (organic Mg/supported Mg=0.1) at 25° C. for 30 min, and washed with n-hexane several times, dried under vaccum. 2 g product (catalyst matrix) obtained before reacted with 30 ml TiCl₄ at 140° C. for 2 h, and washed with n-hexane several times at room temperature. Finally the product was dried under vaccum and the catalyst was obtained.

### Example 12

10 g of silica gel (pore volume of 1.5˜1.7 cm³/g and surface area of 250˜300 m²/g) was impregnated with solution of magnesium acetate and ammonium acetate (Mg loading is 15 wt %, the molar ratio of ammonium acetate and magnesium acetate is 1:1). After being continuously stirred for 5 h at room temperature, then heated to 120° C. for drying 5 h and dried at 120° C. for 6 h in drying oven. The silica gel support supporting the magnesium acetate and ammonium acetate were calcined in a fluidized bed. Nitrogen was used before the temperature reaches to 300° C., and then atmosphere changed to high purity air and kept 600° C. for 4 h. Finally, the product was naturally cooled down to 400° C. under the protection of nitrogen gas. The high temperature calcining and then cooling processes above are shown in FIG. 1. The product reacted with triethyl aluminum (Al/supported Mg=0.1) at 25° C. for 30 min, and washed with n-hexane several times, dried under vaccum. 2 g product (catalyst matrix) obtained before reacted with 30 ml TiCl₄ at 140° C. for 2 h, and washed with n-hexane several times at room temperature. Finally the product was dried under vaccum and the catalyst was obtained.

### Example 13

10 g of silica gel (pore volume of 1.5˜1.7 cm³/g and surface area of 250˜300 m²/g) was impregnated with solution of magnesium acetate and ammonium acetate (Mg loading is 15 wt %, the molar ratio of ammonium acetate and magnesium acetate is 1:1). After being continuously stirred for 5 h at room temperature, then heated to 120° C. for drying 5 h and dried at 120° C. for 6 h in drying oven. The silica gel support supporting the magnesium acetate and ammonium acetate were calcined in a fluidized bed. Nitrogen was used before the temperature reaches to 300° C., and then atmosphere changed to high purity air and kept 600° C. for 4 h. Finally, the product was naturally cooled down to 400° C. under the protection of nitrogen gas. The high temperature calcining and then cooling processes above are shown in FIG. 1. The product reacted with triethyl aluminum (Al/supported Mg=0.1) at 25° C. for 30 min, then reacted with n-hexanol (alcohol/supported Mg=2) at 90° C. for 3 min, and washed with n-hexane several times, dried under vaccum. 2 g product (catalyst matrix) obtained above reacted with 30 ml TiCl₄ at 140° C. for 2 h, and washed with n-hexane several times at room temperature. Finally the product was dried under vaccum and the catalyst was obtained.

### Example 14

10 g of silica gel (pore volume of 1.5˜1.7 cm³/g and surface area of 250˜300 m²/g) was impregnated with solution of magnesium acetate (Mg loading is 15 wt %). After being continuously stirred for 5 h at room temperature, then heated to 120° C. for drying 5 h and dried at 120° C. for 6 h in drying oven. The silica gel support supporting the magnesium acetate was calcined in a fluidized bed. Nitrogen was used before the temperature reaches to 300° C., and then atmosphere changed to high purity air and kept 600° C. for 4 h. Finally, the product was naturally cooled down to 400° C. under the protection of nitrogen gas. The high temperature calcining and then cooling processes above are shown in FIG. 1. 2 g product (catalyst matrix) obtained before reacted with 30 ml TiCl₄ and a certain amount of ethyl benzoate at 140° C. for 2 h, the volume of titanium species and internal electron donor is 15, and washed with n-hexane several times at room temperature. Finally the product was dried under vaccum and the catalyst was obtained.

### Example 15

10 g of silica gel (pore volume of 1.5˜1.7 cm³/g and surface area of 250˜300 m²/g) was impregnated with solution of magnesium acetate (Mg loading is 15 wt %). After being continuously stirred for 5 h at room temperature, then heated to 120° C. for drying 5 h and dried at 120° C. for 6 h in drying oven. The silica gel support supporting the magnesium acetate was calcined in a fluidized bed. Nitrogen was used before the temperature reaches to 300° C., and then atmosphere changed to high purity air and kept 600° C. for 4 h. Finally, the product was naturally cooled down to 400° C. under the protection of nitrogen gas. The high temperature calcining and then cooling processes above are shown in FIG. 1. 2 g product (catalyst matrix) obtained before reacted with 30 ml TiCl₄ and a certain amount of dibutylphthalate at 140° C. for 2 h, the volume of titanium species and internal electron donor is 15, and washed with n-hexane several times at room temperature. Finally the product was dried under vaccum and the catalyst was obtained.

### Example 16

10 g of silica gel (pore volume of 1.5˜1.7 cm³/g and surface area of 250˜300 m²/g) was impregnated with solution of magnesium acetate (Mg loading is 15 wt %). After being continuously stirred for 5 h at room temperature, then heated to 120° C. for drying 5 h and dried at 120° C. for 6 h in drying oven. The silica gel support supporting the magnesium acetate was calcined in a fluidized bed. Nitrogen was used before the temperature reaches to 300° C., and then atmosphere changed to high purity air and kept 600° C. for 4 h. Finally, the product was naturally cooled down to 400° C. under the protection of nitrogen gas. The high temperature calcining and then cooling processes above are shown in FIG. 1. 2 g product (catalyst matrix) obtained before reacted with 30 ml TiCl₄ at 140° C. for 2 h, and washed with n-hexane several times at room temperature. The product was dried under vaccum to prepared the catalyst precursor. This precursor reacted with trihexylaluminium at 110° C. for 1 h, and the Al/Ti molar ratio was 10. Finally the product was dried under vaccum and the catalyst was obtained.

### Example 17

10 g of Al₂O₃ was impregnated with solution of magnesium bicarbonate (Mg loading is 15 wt %). After being continuously stirred for 5 h at room temperature, then heated to 120° C. for drying 5 h and dried at 120° C. for 6 h in drying oven. The Al₂O₃ support supporting the magnesium bicarbonate was calcined in a fluidized bed. Nitrogen was used before the temperature reaches to 300° C., and then atmosphere changed to high purity air and kept 600° C. for 4 h. Finally, the product was naturally cooled down to 400° C. under the protection of nitrogen gas. The high temperature calcining and then cooling processes above are shown in FIG. 1. 2 g product (catalyst matrix) obtained before reacted with 30 ml triethoxy titanium chloride at 140° C. for 2 h, and washed with n-hexane several times at room temperature. Finally the product was dried under vaccum and the catalyst was obtained.

### Example 18

10 g of aluminosilicate was impregnated with solution of magnesium chromate (Mg loading is 15 wt %). After being continuously stirred for 5 h at room temperature, then heated to 120° C. for drying 5 h and dried at 120° C. for 6 h in drying oven. The aluminosilicate support supporting the magnesium chromate was calcined in a fluidized bed. Nitrogen was used before the temperature reaches to 300° C., and then atmosphere changed to high purity air and kept 600° C. for 4 h. Finally, the product was naturally cooled down to 400° C. under the protection of nitrogen gas. The high temperature calcining and then cooling processes above are shown in FIG. 1. 2 g product (catalyst matrix) obtained before reacted with 30 ml triethoxy titanium chloride at 140° C. for 2 h, and washed with n-hexane several times at room temperature. Finally the product was dried under vaccum and the catalyst was obtained.

### Example 19

10 g of titanium dioxide was impregnated with solution of magnesium fluoride (Mg loading is 15 wt %). After being continuously stirred for 5 h at room temperature, then heated to 120° C. for drying 5 h and dried at 120° C. for 6 h in drying oven. The titanium dioxide support supporting the magnesium fluoride was calcined in a fluidized bed. Nitrogen was used before the temperature reaches to 300° C., and then atmosphere changed to high purity air and kept 600° C. for 4 h. Finally, the product was naturally cooled down to 400° C. under the protection of nitrogen gas. The high temperature calcining and then cooling processes above are shown in FIG. 1. 2 g product (catalyst matrix) obtained before reacted with 30 ml triethoxy titanium chloride at 140° C. for 2 h, and washed with n-hexane several times at room temperature. Finally the product was dried under vaccum and the catalyst was obtained.

### Example 20

10 g of zirconia was impregnated with solution of magnesium sulfate (Mg loading is 15 wt %). After being continuously stirred for 5 h at room temperature, then heated to 120° C. for drying 5 h and dried at 120° C. for 6 h in drying oven. The zirconia support supporting the magnesium sulfate was calcined in a fluidized bed. Nitrogen was used before the temperature reaches to 300° C., and then atmosphere changed to high purity air and kept 600° C. for 4 h. Finally, the product was naturally cooled down to 400° C. under the protection of nitrogen gas. The high temperature calcining and then cooling processes above are shown in FIG. 1. 2 g product (catalyst matrix) obtained before reacted with 30 ml triethoxy titanium chloride at 140° C. for 2 h, and washed with n-hexane several times at room temperature. Finally the product was dried under vaccum and the catalyst was obtained.

### Example 21

10 g of Al₂O₃ was impregnated with solution of magnesium gluconate (Mg loading is 15 wt %). After being continuously stirred for 5 h at room temperature, then heated to 120° C. for drying 5 h and dried at 120° C. for 6 h in drying oven. The Al₂O₃ support supporting the magnesium gluconate was calcined in a fluidized bed. Nitrogen was used before the temperature reaches to 300° C., and then atmosphere changed to high purity air and kept 600° C. for 4 h. Finally, the product was naturally cooled down to 400° C. under the protection of nitrogen gas. The high temperature calcining and then cooling processes above are shown in FIG. 1. The product reacted with diethylethoxy aluminum (Al/supported Mg=0.1) at 25° C. for 30 min, and washed with n-hexane several times, dried under vaccum. 2 g product (catalyst matrix) obtained before reacted with 30 ml triethoxy titanium chloride at 140° C. for 2 h, and washed with n-hexane several times at room temperature. Finally the product was dried under vaccum and the catalyst was obtained.

### Example 22

10 g of zirconia was impregnated with solution of magnesium chlorate and ammonium nitrate (Mg loading is 15 wt %, the molar ratio of ammonium nitrate and magnesium chlorate is 1:1). After being continuously stirred for 5 h at room temperature, then heated to 120° C. for drying 5 h and dried at 120° C. for 6 h in drying oven. The zirconia support supporting the magnesium chlorate and ammonium nitrate were calcined in a fluidized bed. Nitrogen was used before the temperature reaches to 300° C., and then atmosphere changed to high purity air and kept 600° C. for 4 h. Finally, the product was naturally cooled down to 400° C. under the protection of nitrogen gas. The high temperature calcining and then cooling processes above are shown in FIG. 1. 2 g product (catalyst matrix) obtained before reacted with 30 ml diethoxytitanium dichloride and a certain amount of 2-ethyl butyl acetate at 140° C. for 2 h, the volume of titanium species and internal electron donor is 15, and washed with n-hexane several times at room temperature. Finally the product was dried under vaccum and the catalyst was obtained.

### Example 23

10 g of titanium dioxide was impregnated with solution of magnesium phosphate and ammonium carbonate (Mg loading is 15 wt %, the molar ratio of ammonium carbonate and magnesium phosphate is 1:1). After being continuously stirred for 5 h at room temperature, then heated to 120° C. for drying 5 h and dried at 120° C. for 6 h in drying oven. The titanium dioxide support supporting the magnesium phosphate and ammonium carbonate were calcined in a fluidized bed. Nitrogen was used before the temperature reaches to 300° C., and then atmosphere changed to high purity air and kept 600° C. for 4 h. Finally, the product was naturally cooled down to 400° C. under the protection of nitrogen gas. The high temperature calcining and then cooling processes above are shown in FIG. 1. 2 g product (catalyst matrix) obtained before reacted with 30 ml titanium trichloride and a certain amount of diethyl ether at 140° C. for 2 h, the volume of titanium species and internal electron donor is 15, and washed with n-hexane several times at room temperature. Finally the product was dried under vaccum and the catalyst was obtained.

### Example 24

10 g of Al₂O₃ was impregnated with solution of magnesium sulfide (Mg loading is 15 wt %). After being continuously stirred for 5 h at room temperature, then heated to 120° C. for drying 5 h and dried at 120° C. for 6 h in drying oven. The Al₂O₃ support supporting the magnesium sulfide was calcined in a fluidized bed. Nitrogen was used before the temperature reaches to 300° C., and then atmosphere changed to high purity air and kept 600° C. for 4 h. Finally, the product was naturally cooled down to 400° C. under the protection of nitrogen gas. The high temperature calcining and then cooling processes above are shown in FIG. 1. 2 g product (catalyst matrix) obtained before reacted with 30 ml triethoxy titanium chloride and a certain amount of tetrahydrofuran at 140° C. for 2 h, the volume of titanium species and internal electron donor is 15, and washed with n-hexane several times at room temperature. Finally the product was dried under vaccum and the catalyst was obtained.

### Example 25

10 g of Al₂O₃ was impregnated with solution of magnesium bicarbonate (Mg loading is 15 wt %). After being continuously stirred for 5 h at room temperature, then heated to 120° C. for drying 5 h and dried at 120° C. for 6 h in drying oven. The Al₂O₃ support supporting the magnesium bicarbonate was calcined in a fluidized bed. Nitrogen was used before the temperature reaches to 300° C., and then atmosphere changed to high purity air and kept 600° C. for 4 h. Finally, the product was naturally cooled down to 400° C. under the protection of nitrogen gas. The high temperature calcining and then cooling processes above are shown in FIG. 1. 2 g product (catalyst matrix) obtained before reacted with 30 ml methoxy titanium trichloride and a certain amount of methyl isobutyl ketone at 140° C. for 2 h, the volume of titanium species and internal electron donor is 15, and washed with n-hexane several times at room temperature. Finally the product was dried under vaccum and the catalyst was obtained.

### Example 26

100 mg catalyst which prepared according to example 1 was weighed for the polymerization. The polymerization reactor was firstly heated under vacuum, and then replaced with highly pure nitrogen, which was repeated for three times. A small amount of monomeric ethylene was used to replace once. Finally, the reactor was filled with ethylene to a slight positive pressure (0.12 MPa). The polymerization temperature was maintained at 70° C. 40 ml of refined n-heptane as solvent and a certain amount of triisobutyl aluminium (TiBA) as cocatalyst were added into the reactor successively. Finally another 40 ml n-heptane were added into the reactor and the pressure of ethylene was raised to 0.15 MPa and the catalysts were added. The instantaneous consumption of monomeric ethylene was on-line collected (by the high-precision ethylene mass flow meter connecting with a computer) during the reaction and recorded by the computer. After the reaction was conducted at 70° C. for 1 h, 50 ml mixed solution of hydrochloric acid/ethanol was added to terminate the reaction, and the polymer was vacuum dried at 60° C. for 4 h, weighed and analyzed.

### Example 27

100 mg catalyst which prepared according to example 2 was weighed for the polymerization. The polymerization reactor was firstly heated under vacuum, and then replaced with highly pure nitrogen, which was repeated for three times. A small amount of monomeric ethylene was used to replace once. Finally, the reactor was filled with ethylene to a slight positive pressure (0.12 MPa). The polymerization temperature was maintained at 70° C. 40 ml of refined n-heptane as solvent and a certain amount of triisobutyl aluminium (TiBA) as cocatalyst were added into the reactor successively. The amount of cocatalyst was AlTi=25, 50, 100, 150, 200 and corresponded to example 27-1, 27-2, 27-3, 27-4, 27-5, respectively. Finally another 40 ml n-heptane were added into the reactor and the pressure of ethylene was raised to 0.15 MPa and the catalysts were added. The instantaneous consumption of monomeric ethylene was on-line collected (by the high-precision ethylene mass flow meter connecting with a computer) during the reaction and recorded by the computer. After the reaction was conducted at 70° C. for 1 h, 50 ml mixed solution of hydrochloric acid/ethanol was added to terminate the reaction, and the polymer was vacuum dried at 60° C. for 4 h, weighed and analyzed.

### Example 28

100 mg catalyst which prepared according to example 2 was weighed for the polymerization. The polymerization reactor was firstly heated under vacuum, and then replaced with highly pure nitrogen, which was repeated for three times. A small amount of monomeric ethylene was used to replace once. Finally, the reactor was filled with ethylene to a slight positive pressure (0.12 MPa). The polymerization temperature was maintained at 70° C. 40 ml of refined n-heptane as solvent and a certain amount of triethyl aluminum (TEA) as cocatalyst were added into the reactor successively. The amount of cocatalyst was AlTi=15, 25, 50 and corresponded to example 28-1, 28-2, 28-3, respectively. Finally another 40 ml n-heptane were added into the reactor and the pressure of ethylene was raised to 0.15 MPa and the catalysts were added. The instantaneous consumption of monomeric ethylene was on-line collected (by the high-precision ethylene mass flow meter connecting with a computer) during the reaction and recorded by the computer. After the reaction was conducted at 70° C. for 1 h, 50 ml mixed solution of hydrochloric acid/ethanol was added to terminate the reaction, and the polymer was vacuum dried at 60° C. for 4 h, weighed and analyzed.

### Example 29

100 mg catalyst which prepared according to example 3 was weighed for the polymerization. The polymerization reactor was firstly heated under vacuum, and then replaced with highly pure nitrogen, which was repeated for three times. A small amount of monomeric ethylene was used to replace once. Finally, the reactor was filled with ethylene to a slight positive pressure (0.12 MPa). The polymerization temperature was maintained at 70° C. 40 ml of refined n-heptane as solvent and a certain amount of triisobutyl aluminium (TiBA) as cocatalyst were added into the reactor successively. The amount of cocatalyst was AlTi=10, 15, 25, 50, 100 and corresponded to example 29-1, 29-2, 29-3, 29-4, 29-5, respectively. Finally another 40 ml n-heptane were added into the reactor and the pressure of ethylene was raised to 0.15 MPa and the catalysts were added. The instantaneous consumption of monomeric ethylene was on-line collected (by the high-precision ethylene mass flow meter connecting with a computer) during the reaction and recorded by the computer. After the reaction was conducted at 70° C. for 1 h, 50 ml mixed solution of hydrochloric acid/ethanol was added to terminate the reaction, and the polymer was vacuum dried at 60° C. for 4 h, weighed and analyzed.

### Example 30

100 mg catalyst which prepared according to example 3 was weighed for the polymerization. The polymerization reactor was firstly heated under vacuum, and then replaced with highly pure nitrogen, which was repeated for three times. A small amount of monomeric ethylene was used to replace once. Finally, the reactor was filled with ethylene to a slight positive pressure (0.12 MPa). The polymerization temperature was maintained at 70° C. 40 ml of refined n-heptane as solvent and a certain amount of triethyl aluminum (TEA) as cocatalyst were added into the reactor successively. The amount of cocatalyst was AlTi=10, 15, 25 and corresponded to example 30-1, 30-2, 30-3, respectively. Finally another 40 ml n-heptane were added into the reactor and the pressure of ethylene was raised to 0.15 MPa and the catalysts were added. The instantaneous consumption of monomeric ethylene was on-line collected (by the high-precision ethylene mass flow meter connecting with a computer) during the reaction and recorded by the computer. After the reaction was conducted at 70° C. for 1 h, 50 ml mixed solution of hydrochloric acid/ethanol was added to terminate the reaction, and the polymer was vacuum dried at 60° C. for 4 h, weighed and analyzed.

### Example 31

100 mg catalyst which prepared according to example 4 was weighed for the polymerization. The polymerization reactor was firstly heated under vacuum, and then replaced with highly pure nitrogen, which was repeated for three times. A small amount of monomeric ethylene was used to replace once. Finally, the reactor was filled with ethylene to a slight positive pressure (0.12 MPa). The polymerization temperature was maintained at 70° C. 40 ml of refined n-heptane as solvent and a certain amount of triisobutyl aluminium (TiBA) as cocatalyst were added into the reactor successively. The amount of cocatalyst was AlTi=5, 10, 15, 25 and corresponded to example 31-1, 31-2, 31-3, 31-4, respectively. Finally another 40 ml n-heptane were added into the reactor and the pressure of ethylene was raised to 0.15 MPa and the catalysts were added. The instantaneous consumption of monomeric ethylene was on-line collected (by the high-precision ethylene mass flow meter connecting with a computer) during the reaction and recorded by the computer. After the reaction was conducted at 70° C. for 1 h, 50 ml mixed solution of hydrochloric acid/ethanol was added to terminate the reaction, and the polymer was vacuum dried at 60° C. for 4 h, weighed and analyzed.

### Example 32

100 mg catalyst which prepared according to example 5 was weighed for the polymerization. The polymerization reactor was firstly heated under vacuum, and then replaced with highly pure nitrogen, which was repeated for three times. A small amount of monomeric ethylene was used to replace once. Finally, the reactor was filled with ethylene to a slight positive pressure (0.12 MPa). The polymerization temperature was maintained at 70° C. 40 ml of refined n-heptane as solvent and a certain amount of diethylaluminium chloride (DEAC, Al/Ti=50) as cocatalyst were added into the reactor successively. Finally another 40 ml n-heptane were added into the reactor and the pressure of ethylene was raised to 0.15 MPa and the catalysts were added. The instantaneous consumption of monomeric ethylene was on-line collected (by the high-precision ethylene mass flow meter connecting with a computer) during the reaction and recorded by the computer. After the reaction was conducted at 70° C. for 1 h, 50 ml mixed solution of hydrochloric acid/ethanol was added to terminate the reaction, and the polymer was vacuum dried at 60° C. for 4 h, weighed and analyzed.

### Example 33

100 mg catalyst which prepared according to example 6 was weighed for the polymerization. The polymerization reactor was firstly heated under vacuum, and then replaced with highly pure nitrogen, which was repeated for three times. A small amount of monomeric ethylene was used to replace once. Finally, the reactor was filled with ethylene to a slight positive pressure (0.12 MPa). The polymerization temperature was maintained at 70° C. 40 ml of refined n-heptane as solvent and a certain amount of triethyl aluminum (TEA, Al/Ti=50) as cocatalyst were added into the reactor successively. Finally another 40 ml n-heptane were added into the reactor and the pressure of ethylene was raised to 0.15 MPa and the catalysts were added. The instantaneous consumption of monomeric ethylene was on-line collected (by the high-precision ethylene mass flow meter connecting with a computer) during the reaction and recorded by the computer. After the reaction was conducted at 70° C. for 1 h, 50 ml mixed solution of hydrochloric acid/ethanol was added to terminate the reaction, and the polymer was vacuum dried at 60° C. for 4 h, weighed and analyzed.

### Example 34

100 mg catalyst which prepared according to example 7 was weighed for the polymerization. The polymerization reactor was firstly heated under vacuum, and then replaced with highly pure nitrogen, which was repeated for three times. A small amount of monomeric ethylene was used to replace once. Finally, the reactor was filled with ethylene to a slight positive pressure (0.12 MPa). The polymerization temperature was maintained at 70° C. 40 ml of refined n-heptane as solvent and a certain amount of triisobutyl aluminium (TiBA, Al/Ti=50) as cocatalyst were added into the reactor successively. Finally another 40 ml n-heptane were added into the reactor and the pressure of ethylene was raised to 0.15 MPa and the catalysts were added. The instantaneous consumption of monomeric ethylene was on-line collected (by the high-precision ethylene mass flow meter connecting with a computer) during the reaction and recorded by the computer. After the reaction was conducted at 70° C. for 1 h, 50 ml mixed solution of hydrochloric acid/ethanol was added to terminate the reaction, and the polymer was vacuum dried at 60° C. for 4 h, weighed and analyzed.

### Example 35

100 mg catalyst which prepared according to example 8 was weighed for the polymerization. The polymerization reactor was firstly heated under vacuum, and then replaced with highly pure nitrogen, which was repeated for three times. A small amount of monomeric ethylene was used to replace once. Finally, the reactor was filled with ethylene to a slight positive pressure (0.12 MPa). The polymerization temperature was maintained at 70° C. 40 ml of refined n-heptane as solvent and a certain amount of triisobutyl aluminium (TiBA) as cocatalyst were added into the reactor successively. The amount of cocatalyst was AlTi=10, 15, 25 and corresponded to example 35˜1, 35˜2, 35˜3, respectively. Finally another 40 ml n-heptane were added into the reactor and the pressure of ethylene was raised to 0.15 MPa and the catalysts were added. The instantaneous consumption of monomeric ethylene was on-line collected (by the high-precision ethylene mass flow meter connecting with a computer) during the reaction and recorded by the computer. After the reaction was conducted at 70° C. for 1 h, 50 ml mixed solution of hydrochloric acid/ethanol was added to terminate the reaction, and the polymer was vacuum dried at 60° C. for 4 h, weighed and analyzed.

### Example 36

100 mg catalyst which prepared according to example 9 was weighed for the polymerization. The polymerization reactor was firstly heated under vacuum, and then replaced with highly pure nitrogen, which was repeated for three times. A small amount of monomeric ethylene was used to replace once. Finally, the reactor was filled with ethylene to a slight positive pressure (0.12 MPa). The polymerization temperature was maintained at 70° C. 40 ml of refined n-heptane as solvent and a certain amount of triisobutyl aluminium (TiBA) as cocatalyst were added into the reactor successively. The amount of cocatalyst was AlTi=10, 15, 25 and corresponded to example 36˜1, 36˜2, 36˜3, respectively. Finally another 40 ml n-heptane were added into the reactor and the pressure of ethylene was raised to 0.15 MPa and the catalysts were added. The instantaneous consumption of monomeric ethylene was on-line collected (by the high-precision ethylene mass flow meter connecting with a computer) during the reaction and recorded by the computer. After the reaction was conducted at 70° C. for 1 h, 50 ml mixed solution of hydrochloric acid/ethanol was added to terminate the reaction, and the polymer was vacuum dried at 60° C. for 4 h, weighed and analyzed.

### Example 37

100 mg catalyst which prepared according to example 10 was weighed for the polymerization. The polymerization reactor was firstly heated under vacuum, and then replaced with highly pure nitrogen, which was repeated for three times. A small amount of monomeric ethylene was used to replace once. Finally, the reactor was filled with ethylene to a slight positive pressure (0.12 MPa). The polymerization temperature was maintained at 70° C. 40 ml of refined n-heptane as solvent and a certain amount of triisobutyl aluminium (TiBA) as cocatalyst were added into the reactor successively. The amount of cocatalyst was AlTi=15, 25, 50 and corresponded to example 37˜1, 37˜2, 37˜3, respectively. Finally another 40 ml n-heptane were added into the reactor and the pressure of ethylene was raised to 0.15 MPa and the catalysts were added. The instantaneous consumption of monomeric ethylene was on-line collected (by the high-precision ethylene mass flow meter connecting with a computer) during the reaction and recorded by the computer. After the reaction was conducted at 70° C. for 1 h, 50 ml mixed solution of hydrochloric acid/ethanol was added to terminate the reaction, and the polymer was vacuum dried at 60° C. for 4 h, weighed and analyzed.

### Example 38

100 mg catalyst which prepared according to example 11 was weighed for the polymerization. The polymerization reactor was firstly heated under vacuum, and then replaced with highly pure nitrogen, which was repeated for three times. A small amount of monomeric ethylene was used to replace once. Finally, the reactor was filled with ethylene to a slight positive pressure (0.12 MPa). The polymerization temperature was maintained at 70° C. 40 ml of refined n-heptane as solvent and a certain amount of diethylaluminium chloride (DEAC, Al/Ti=25) as cocatalyst were added into the reactor successively. Finally another 40 ml n-heptane were added into the reactor and the pressure of ethylene was raised to 0.15 MPa and the catalysts were added. The instantaneous consumption of monomeric ethylene was on-line collected (by the high-precision ethylene mass flow meter connecting with a computer) during the reaction and recorded by the computer. After the reaction was conducted at 70° C. for 1 h, 50 ml mixed solution of hydrochloric acid/ethanol was added to terminate the reaction, and the polymer was vacuum dried at 60° C. for 4 h, weighed and analyzed.

### Example 39

100 mg catalyst which prepared according to example 12 was weighed for the polymerization. The polymerization reactor was firstly heated under vacuum, and then replaced with highly pure nitrogen, which was repeated for three times. A small amount of monomeric ethylene was used to replace once. Finally, the reactor was filled with ethylene to a slight positive pressure (0.12 MPa). The polymerization temperature was maintained at 70° C. 40 ml of refined n-heptane as solvent and a certain amount of triethyl aluminum (TEA, Al/Ti=25) as cocatalyst were added into the reactor successively. Finally another 40 ml n-heptane were added into the reactor and the pressure of ethylene was raised to 0.15 MPa and the catalysts were added. The instantaneous consumption of monomeric ethylene was on-line collected (by the high-precision ethylene mass flow meter connecting with a computer) during the reaction and recorded by the computer. After the reaction was conducted at 70° C. for 1 h, 50 ml mixed solution of hydrochloric acid/ethanol was added to terminate the reaction, and the polymer was vacuum dried at 60° C. for 4 h, weighed and analyzed.

### Example 40

100 mg catalyst which prepared according to example 13 was weighed for the polymerization. The polymerization reactor was firstly heated under vacuum, and then replaced with highly pure nitrogen, which was repeated for three times. A small amount of monomeric ethylene was used to replace once. Finally, the reactor was filled with ethylene to a slight positive pressure (0.12 MPa). The polymerization temperature was maintained at 70° C. 40 ml of refined n-heptane as solvent and a certain amount of triisobutyl aluminium (TiBA, Al/Ti=25) as cocatalyst were added into the reactor successively. Finally another 40 ml n-heptane were added into the reactor and the pressure of ethylene was raised to 0.15 MPa and the catalysts were added. The instantaneous consumption of monomeric ethylene was on-line collected (by the high-precision ethylene mass flow meter connecting with a computer) during the reaction and recorded by the computer. After the reaction was conducted at 70° C. for 1 h, 50 ml mixed solution of hydrochloric acid/ethanol was added to terminate the reaction, and the polymer was vacuum dried at 60° C. for 4 h, weighed and analyzed.

### Example 41

100 mg catalyst which prepared according to example 14 was weighed for the polymerization. The polymerization reactor was firstly heated under vacuum, and then replaced with highly pure nitrogen, which was repeated for three times. A small amount of monomeric propylene was used to replace once. Finally, the reactor was filled with propylene to a slight positive pressure (0.12 MPa). The polymerization temperature was maintained at 70° C. 40 ml of refined n-heptane as solvent, a certain amount of triisobutyl aluminium (TiBA, Al/Ti=50) as cocatalyst and bis-cyclopentyl dimethoxysilane (DCPMS/Ti=10) were added into the reactor successively. Finally another 40 ml n-heptane were added into the reactor and the pressure of propylene was raised to 0.15 MPa and the catalysts were added. The instantaneous consumption of monomeric propylene was on-line collected (by the high-precision propylene mass flow meter connecting with a computer) during the reaction and recorded by the computer. After the reaction was conducted at 70° C. for 1 h, 50 ml mixed solution of hydrochloric acid/ethanol was added to terminate the reaction, and the polymer was vacuum dried at 60° C. for 4 h, weighed and analyzed.

### Example 42

100 mg catalyst which prepared according to example 15 was weighed for the polymerization. The polymerization reactor was firstly heated under vacuum, and then replaced with highly pure nitrogen, which was repeated for three times. A small amount of monomeric propylene was used to replace once. Finally, the reactor was filled with propylene to a slight positive pressure (0.12 MPa). The polymerization temperature was maintained at 70° C. 40 ml of refined n-heptane as solvent, a certain amount of triisobutyl aluminium (TiBA, Al/Ti=50) as cocatalyst and bis-cyclopentyl dimethoxysilane (DCPMS/Ti=10) were added into the reactor successively. Finally another 40 ml n-heptane were added into the reactor and the pressure of propylene was raised to 0.15 MPa and the catalysts were added. The instantaneous consumption of monomeric propylene was on-line collected (by the high-precision propylene mass flow meter connecting with a computer) during the reaction and recorded by the computer. After the reaction was conducted at 70° C. for 1 h, 50 ml mixed solution of hydrochloric acid/ethanol was added to terminate the reaction, and the polymer was vacuum dried at 60° C. for 4 h, weighed and analyzed.

### Example 43

100 mg catalyst which prepared according to example 16 was weighed for the polymerization. The polymerization reactor was firstly heated under vacuum, and then replaced with highly pure nitrogen, which was repeated for three times. A small amount of monomeric ethylene was used to replace once. Finally, the reactor was filled with ethylene to a slight positive pressure (0.12 MPa). The polymerization temperature was maintained at 70° C. 40 ml of refined n-heptane as solvent and a certain amount of triisobutyl aluminium (TiBA, Al/Ti=50) as cocatalyst were added into the reactor successively. Finally another 40 ml n-heptane were added into the reactor and the pressure of ethylene was raised to 0.15 MPa and the catalysts were added. The instantaneous consumption of monomeric ethylene was on-line collected (by the high-precision ethylene mass flow meter connecting with a computer) during the reaction and recorded by the computer. After the reaction was conducted at 70° C. for 1 h, 50 ml mixed solution of hydrochloric acid/ethanol was added to terminate the reaction, and the polymer was vacuum dried at 60° C. for 4 h, weighed and analyzed.

### Example 44

100 mg catalyst which prepared according to example 17 was weighed for the polymerization. The polymerization reactor was firstly heated under vacuum, and then replaced with highly pure nitrogen, which was repeated for three times. A small amount of monomeric ethylene was used to replace once. Finally, the reactor was filled with ethylene to a slight positive pressure (0.12 MPa). The polymerization temperature was maintained at 70° C. 40 ml of refined n-heptane as solvent and a certain amount of triisobutyl aluminium (TiBA, Al/Ti=50) as cocatalyst were added into the reactor successively. Finally another 40 ml n-heptane were added into the reactor and the pressure of ethylene was raised to 0.15 MPa and the catalysts were added. The instantaneous consumption of monomeric ethylene was on-line collected (by the high-precision ethylene mass flow meter connecting with a computer) during the reaction and recorded by the computer. After the reaction was conducted at 70° C. for 1 h, 50 ml mixed solution of hydrochloric acid/ethanol was added to terminate the reaction, and the polymer was vacuum dried at 60° C. for 4 h, weighed and analyzed.

### Example 45

100 mg catalyst which prepared according to example 18 was weighed for the polymerization. The polymerization reactor was firstly heated under vacuum, and then replaced with highly pure nitrogen, which was repeated for three times. A small amount of monomeric ethylene was used to replace once. Finally, the reactor was filled with ethylene to a slight positive pressure (0.12 MPa). The polymerization temperature was maintained at 70° C. 40 ml of refined n-heptane as solvent and a certain amount of triethyl aluminum (TEA, Al/Ti=50) as cocatalyst were added into the reactor successively. Finally another 40 ml n-heptane were added into the reactor and the pressure of ethylene was raised to 0.15 MPa and the catalysts were added. The instantaneous consumption of monomeric ethylene was on-line collected (by the high-precision ethylene mass flow meter connecting with a computer) during the reaction and recorded by the computer. After the reaction was conducted at 70° C. for 1 h, 50 ml mixed solution of hydrochloric acid/ethanol was added to terminate the reaction, and the polymer was vacuum dried at 60° C. for 4 h, weighed and analyzed.

### Example 46

100 mg catalyst which prepared according to example 19 was weighed for the polymerization. The polymerization reactor was firstly heated under vacuum, and then replaced with highly pure nitrogen, which was repeated for three times. A small amount of monomeric ethylene was used to replace once. Finally, the reactor was filled with ethylene to a slight positive pressure (0.12 MPa). The polymerization temperature was maintained at 70° C. 40 ml of refined n-heptane as solvent and a certain amount of triisobutyl aluminium (TiBA, Al/Ti=50) as cocatalyst were added into the reactor successively. Finally another 40 ml n-heptane were added into the reactor and the pressure of ethylene was raised to 0.15 MPa and the catalysts were added. The instantaneous consumption of monomeric ethylene was on-line collected (by the high-precision ethylene mass flow meter connecting with a computer) during the reaction and recorded by the computer. After the reaction was conducted at 70° C. for 1 h, 50 ml mixed solution of hydrochloric acid/ethanol was added to terminate the reaction, and the polymer was vacuum dried at 60° C. for 4 h, weighed and analyzed.

### Example 47

100 mg catalyst which prepared according to example 20 was weighed for the polymerization. The polymerization reactor was firstly heated under vacuum, and then replaced with highly pure nitrogen, which was repeated for three times. A small amount of monomeric ethylene was used to replace once. Finally, the reactor was filled with ethylene to a slight positive pressure (0.12 MPa). The polymerization temperature was maintained at 70° C. 40 ml of refined n-heptane as solvent and a certain amount of triisobutyl aluminium (TiBA, Al/Ti=50) as cocatalyst were added into the reactor successively. Finally another 40 ml n-heptane were added into the reactor and the pressure of ethylene was raised to 0.15 MPa and the catalysts were added. The instantaneous consumption of monomeric ethylene was on-line collected (by the high-precision ethylene mass flow meter connecting with a computer) during the reaction and recorded by the computer. After the reaction was conducted at 70° C. for 1 h, 50 ml mixed solution of hydrochloric acid/ethanol was added to terminate the reaction, and the polymer was vacuum dried at 60° C. for 4 h, weighed and analyzed.

### Example 48

100 mg catalyst which prepared according to example 21 was weighed for the polymerization. The polymerization reactor was firstly heated under vacuum, and then replaced with highly pure nitrogen, which was repeated for three times. A small amount of monomeric ethylene was used to replace once. Finally, the reactor was filled with ethylene to a slight positive pressure (0.12 MPa). The polymerization temperature was maintained at 70° C. 40 ml of refined n-heptane as solvent and a certain amount of methylaluminoxane (MAO, Al/Ti=50) as cocatalyst were added into the reactor successively. Finally another 40 ml n-heptane were added into the reactor and the pressure of ethylene was raised to 0.15 MPa and the catalysts were added. The instantaneous consumption of monomeric ethylene was on-line collected (by the high-precision ethylene mass flow meter connecting with a computer) during the reaction and recorded by the computer. After the reaction was conducted at 70° C. for 1 h, 50 ml mixed solution of hydrochloric acid/ethanol was added to terminate the reaction, and the polymer was vacuum dried at 60° C. for 4 h, weighed and analyzed.

### Example 49

100 mg catalyst which prepared according to example 22 was weighed for the polymerization. The polymerization reactor was firstly heated under vacuum, and then replaced with highly pure nitrogen, which was repeated for three times. A small amount of monomeric propylene was used to replace once. Finally, the reactor was filled with propylene to a slight positive pressure (0.12 MPa). The polymerization temperature was maintained at 70° C. 40 ml of refined n-heptane as solvent, a certain amount of triisobutyl aluminium (TiBA, Al/Ti=50) as cocatalyst and bis-cyclopentyl dimethoxysilane (DCPMS/Ti=10) were added into the reactor successively. Finally another 40 ml n-heptane were added into the reactor and the pressure of propylene was raised to 0.15 MPa and the catalysts were added. The instantaneous consumption of monomeric propylene was on-line collected (by the high-precision propylene mass flow meter connecting with a computer) during the reaction and recorded by the computer. After the reaction was conducted at 70° C. for 1 h, 50 ml mixed solution of hydrochloric acid/ethanol was added to terminate the reaction, and the polymer was vacuum dried at 60° C. for 4 h, weighed and analyzed.

### Example 50

100 mg catalyst which prepared according to example 23 was weighed for the polymerization. The polymerization reactor was firstly heated under vacuum, and then replaced with highly pure nitrogen, which was repeated for three times. A small amount of monomeric propylene was used to replace once. Finally, the reactor was filled with propylene to a slight positive pressure (0.12 MPa). The polymerization temperature was maintained at 70° C. 40 ml of refined n-heptane as solvent, a certain amount of triisobutyl aluminium (TiBA, Al/Ti=50) as cocatalyst and bis-cyclopentyl dimethoxysilane (DCPMS/Ti=10) were added into the reactor successively. Finally another 40 ml n-heptane were added into the reactor and the pressure of propylene was raised to 0.15 MPa and the catalysts were added. The instantaneous consumption of monomeric propylene was on-line collected (by the high-precision propylene mass flow meter connecting with a computer) during the reaction and recorded by the computer. After the reaction was conducted at 70° C. for 1 h, 50 ml mixed solution of hydrochloric acid/ethanol was added to terminate the reaction, and the polymer was vacuum dried at 60° C. for 4 h, weighed and analyzed.

### Example 51

100 mg catalyst which prepared according to example 24 was weighed for the polymerization. The polymerization reactor was firstly heated under vacuum, and then replaced with highly pure nitrogen, which was repeated for three times. A small amount of monomeric propylene was used to replace once. Finally, the reactor was filled with propylene to a slight positive pressure (0.12 MPa). The polymerization temperature was maintained at 70° C. 40 ml of refined n-heptane as solvent, a certain amount of triisobutyl aluminium (TiBA, Al/Ti=50) as cocatalyst and bis-cyclopentyl dimethoxysilane (DCPMS/Ti=10) were added into the reactor successively. Finally another 40 ml n-heptane were added into the reactor and the pressure of propylene was raised to 0.15 MPa and the catalysts were added. The instantaneous consumption of monomeric propylene was on-line collected (by the high-precision propylene mass flow meter connecting with a computer) during the reaction and recorded by the computer. After the reaction was conducted at 70° C. for 1 h, 50 ml mixed solution of hydrochloric acid/ethanol was added to terminate the reaction, and the polymer was vacuum dried at 60° C. for 4 h, weighed and analyzed.

### Example 52

100 mg catalyst which prepared according to example 25 was weighed for the polymerization. The polymerization reactor was firstly heated under vacuum, and then replaced with highly pure nitrogen, which was repeated for three times. A small amount of monomeric propylene was used to replace once. Finally, the reactor was filled with propylene to a slight positive pressure (0.12 MPa). The polymerization temperature was maintained at 70° C. 40 ml of refined n-heptane as solvent, a certain amount of triisobutyl aluminium (TiBA, Al/Ti=50) as cocatalyst and bis-cyclopentyl dimethoxysilane (DCPMS/Ti=10) were added into the reactor successively. Finally another 40 ml n-heptane were added into the reactor and the pressure of propylene was raised to 0.15 MPa and the catalysts were added. The instantaneous consumption of monomeric propylene was on-line collected (by the high-precision propylene mass flow meter connecting with a computer) during the reaction and recorded by the computer. After the reaction was conducted at 70° C. for 1 h, 50 ml mixed solution of hydrochloric acid/ethanol was added to terminate the reaction, and the polymer was vacuum dried at 60° C. for 4 h, weighed and analyzed.

### Example 53

100 mg catalyst which prepared according to example 2 was weighed for the polymerization. The polymerization reactor was firstly heated under vacuum, and then replaced with highly pure nitrogen, which was repeated for three times. A small amount of monomeric ethylene was used to replace once. Finally, the reactor was filled with ethylene to a slight positive pressure (0.12 MPa). The polymerization temperature was maintained at 70° C. 40 ml of refined n-heptane as solvent and a certain amount of triisobutyl aluminium (TiBA, Al/Ti=50) as cocatalyst were added into the reactor successively. Finally another 40 ml n-heptane, 10 ml H2 were added into the reactor and the pressure of ethylene was raised to 0.15 MPa and the catalysts were added. The instantaneous consumption of monomeric ethylene was on-line collected (by the high-precision ethylene mass flow meter connecting with a computer) during the reaction and recorded by the computer. After the reaction was conducted at 70° C. for 1 h, 50 ml mixed solution of hydrochloric acid/ethanol was added to terminate the reaction, and the polymer was vacuum dried at 60° C. for 4 h, weighed and analyzed.

### Example 54

100 mg catalyst which prepared according to example 3 was weighed for the polymerization. The polymerization reactor was firstly heated under vacuum, and then replaced with highly pure nitrogen, which was repeated for three times. A small amount of monomeric ethylene was used to replace once. Finally, the reactor was filled with ethylene to a slight positive pressure (0.12 MPa). The polymerization temperature was maintained at 70° C. 40 ml of refined n-heptane as solvent and a certain amount of triisobutyl aluminium (TiBA, Al/Ti=15) as cocatalyst were added into the reactor successively. Finally another 40 ml n-heptane, 10 ml H2 were added into the reactor and the pressure of ethylene was raised to 0.15 MPa and the catalysts were added. The instantaneous consumption of monomeric ethylene was on-line collected (by the high-precision ethylene mass flow meter connecting with a computer) during the reaction and recorded by the computer. After the reaction was conducted at 70° C. for 1 h, 50 ml mixed solution of hydrochloric acid/ethanol was added to terminate the reaction, and the polymer was vacuum dried at 60° C. for 4 h, weighed and analyzed.

### Example 55

100 mg catalyst which prepared according to example 8 was weighed for the polymerization. The polymerization reactor was firstly heated under vacuum, and then replaced with highly pure nitrogen, which was repeated for three times. A small amount of monomeric ethylene was used to replace once. Finally, the reactor was filled with ethylene to a slight positive pressure (0.12 MPa). The polymerization temperature was maintained at 70° C. 40 ml of refined n-heptane as solvent and a certain amount of triisobutyl aluminium (TiBA, Al/Ti=15) as cocatalyst were added into the reactor successively. Finally another 40 ml n-heptane, 10 ml H2 were added into the reactor and the pressure of ethylene was raised to 0.15 MPa and the catalysts were added. The instantaneous consumption of monomeric ethylene was on-line collected (by the high-precision ethylene mass flow meter connecting with a computer) during the reaction and recorded by the computer. After the reaction was conducted at 70° C. for 1 h, 50 ml mixed solution of hydrochloric acid/ethanol was added to terminate the reaction, and the polymer was vacuum dried at 60° C. for 4 h, weighed and analyzed.

### Example 56

100 mg catalyst which prepared according to example 9 was weighed for the polymerization. The polymerization reactor was firstly heated under vacuum, and then replaced with highly pure nitrogen, which was repeated for three times. A small amount of monomeric ethylene was used to replace once. Finally, the reactor was filled with ethylene to a slight positive pressure (0.12 MPa). The polymerization temperature was maintained at 70° C. 40 ml of refined n-heptane as solvent and a certain amount of triisobutyl aluminium (TiBA, Al/Ti=15) as cocatalyst were added into the reactor successively. Finally another 40 ml n-heptane, 10 ml H2 were added into the reactor and the pressure of ethylene was raised to 0.15 MPa and the catalysts were added. The instantaneous consumption of monomeric ethylene was on-line collected (by the high-precision ethylene mass flow meter connecting with a computer) during the reaction and recorded by the computer. After the reaction was conducted at 70° C. for 1 h, 50 ml mixed solution of hydrochloric acid/ethanol was added to terminate the reaction, and the polymer was vacuum dried at 60° C. for 4 h, weighed and analyzed.

### Example 57

100 mg catalyst which prepared according to example 10 was weighed for the polymerization. The polymerization reactor was firstly heated under vacuum, and then replaced with highly pure nitrogen, which was repeated for three times. A small amount of monomeric ethylene was used to replace once. Finally, the reactor was filled with ethylene to a slight positive pressure (0.12 MPa). The polymerization temperature was maintained at 70° C. 40 ml of refined n-heptane as solvent and a certain amount of triisobutyl aluminium (TiBA, Al/Ti=25) as cocatalyst were added into the reactor successively. Finally another 40 ml n-heptane, 10 ml H2 were added into the reactor and the pressure of ethylene was raised to 0.15 MPa and the catalysts were added. The instantaneous consumption of monomeric ethylene was on-line collected (by the high-precision ethylene mass flow meter connecting with a computer) during the reaction and recorded by the computer. After the reaction was conducted at 70° C. for 1 h, 50 ml mixed solution of hydrochloric acid/ethanol was added to terminate the reaction, and the polymer was vacuum dried at 60° C. for 4 h, weighed and analyzed.

### Example 58

100 mg catalyst which prepared according to example 2 was weighed for the polymerization. The polymerization reactor was firstly heated under vacuum, and then replaced with highly pure nitrogen, which was repeated for three times. A small amount of monomeric ethylene was used to replace once. Finally, the reactor was filled with ethylene to a slight positive pressure (0.12 MPa). The polymerization temperature was maintained at 70° C. 40 ml of refined n-heptane as solvent and a certain amount of triisobutyl aluminium (TiBA, Al/Ti=50) as cocatalyst were added into the reactor successively. Then a certain amount of 1-hexene (such as 0.8 mL, 2.4 mL, 4.0 mL, namely 1 vol %, 3 vol %, 5 vol %) were added into the reactor and corresponded to example 58˜1, 58˜2, 58˜3, respectively.Finally another 40 ml n-heptane, 10 ml H2 were added into the reactor and the pressure of ethylene was raised to 0.15 MPa and the catalysts were added. The instantaneous consumption of monomeric ethylene was on-line collected (by the high-precision ethylene mass flow meter connecting with a computer) during the reaction and recorded by the computer. After the reaction was conducted at 70° C. for 1 h, 50 ml mixed solution of hydrochloric acid/ethanol was added to terminate the reaction, and the polymer was vacuum dried at 60° C. for 4 h, weighed and analyzed.

### Example 59

100 mg catalyst which prepared according to example 8 was weighed for the polymerization. The polymerization reactor was firstly heated under vacuum, and then replaced with highly pure nitrogen, which was repeated for three times. A small amount of monomeric ethylene was used to replace once. Finally, the reactor was filled with ethylene to a slight positive pressure (0.12 MPa). The polymerization temperature was maintained at 70° C. 40 ml of refined n-heptane as solvent and a certain amount of triisobutyl aluminium (TiBA, Al/Ti=15) as cocatalyst were added into the reactor successively. Then a certain amount of 1-hexene (such as 0.8 mL, 2.4 mL, 4.0 mL, namely 1 vol %, 3 vol %, 5 vol %) were added into the reactor and corresponded to example 59˜1, 59˜2, 59˜3, respectively.Finally another 40 ml n-heptane, 10 ml H2 were added into the reactor and the pressure of ethylene was raised to 0.15 MPa and the catalysts were added. The instantaneous consumption of monomeric ethylene was on-line collected (by the high-precision ethylene mass flow meter connecting with a computer) during the reaction and recorded by the computer. After the reaction was conducted at 70° C. for 1 h, 50 ml mixed solution of hydrochloric acid/ethanol was added to terminate the reaction, and the polymer was vacuum dried at 60° C. for 4 h, weighed and analyzed.

### Example 60

100 mg catalyst which prepared according to example 9 was weighed for the polymerization. The polymerization reactor was firstly heated under vacuum, and then replaced with highly pure nitrogen, which was repeated for three times. A small amount of monomeric ethylene was used to replace once. Finally, the reactor was filled with ethylene to a slight positive pressure (0.12 MPa). The polymerization temperature was maintained at 70° C. 40 ml of refined n-heptane as solvent and a certain amount of triisobutyl aluminium (TiBA, Al/Ti=15) as cocatalyst were added into the reactor successively. Then a certain amount of 1-hexene (such as 0.8 mL, 2.4 mL, 4.0 mL, namely 1 vol %, 3 vol %, 5 vol %) were added into the reactor and corresponded to example 60˜1, 60˜2, 60˜3, respectively.Finally another 40 ml n-heptane, 10 ml H2 were added into the reactor and the pressure of ethylene was raised to 0.15 MPa and the catalysts were added. The instantaneous consumption of monomeric ethylene was on-line collected (by the high-precision ethylene mass flow meter connecting with a computer) during the reaction and recorded by the computer. After the reaction was conducted at 70° C. for 1 h, 50 ml mixed solution of hydrochloric acid/ethanol was added to terminate the reaction, and the polymer was vacuum dried at 60° C. for 4 h, weighed and analyzed.

### Example 61

100 mg catalyst which prepared according to example 10 was weighed for the polymerization. The polymerization reactor was firstly heated under vacuum, and then replaced with highly pure nitrogen, which was repeated for three times. A small amount of monomeric ethylene was used to replace once. Finally, the reactor was filled with ethylene to a slight positive pressure (0.12 MPa). The polymerization temperature was maintained at 70° C. 40 ml of refined n-heptane as solvent and a certain amount of triisobutyl aluminium (TiBA, Al/Ti=25) as cocatalyst were added into the reactor successively. Then a certain amount of 1-hexene (such as 0.8 mL, 2.4 mL, 4.0 mL, namely 1 vol %, 3 vol %, 5 vol %) were added into the reactor and corresponded to example 61˜1, 61˜2, 61˜3, respectively.Finally another 40 ml n-heptane, 10 ml H2 were added into the reactor and the pressure of ethylene was raised to 0.15 MPa and the catalysts were added. The instantaneous consumption of monomeric ethylene was on-line collected (by the high-precision ethylene mass flow meter connecting with a computer) during the reaction and recorded by the computer. After the reaction was conducted at 70° C. for 1 h, 50 ml mixed solution of hydrochloric acid/ethanol was added to terminate the reaction, and the polymer was vacuum dried at 60° C. for 4 h, weighed and analyzed.

### Comparison Example 1

A certain amount of anhydrous MgCl₂ and refined n-heptane were added into the reactor with magnetic stirring under nitrogen protection. Then a certain amount of anhydrous ethanol (n[EtOH]:n[MgCl₂]=4:1) was added after fully stirring. Until the temperature was raised up to 120° C. and MgCl₂ was fully dissolved for 1 h, the temperature was cooled to room temperature, and n-heptane was removed. MgCl₂.nEtOH complex was dried under vaccum and transferred to a bottle under the protecton of nitrogen. About 5 g the synthesized MgCl₂.nEtOH were added into a three-necked bottle with ice bath cooling, then TiCl₄ (n[Ti]:n[Mg]=20:1 molar ratio) was added into the reactor with stirring and heating to 120° C. for 2 h under nitrogen. The product was washed with 50 mL n-heptane after cooled to 60° C., then a certain amount of TiCl₄ (n[Ti]:n[Mg]=20:1 molar ratio) was added and heated to 120° C. for 2 h. The product obtainedwas washed with 50 mL n-heptane after cooled to 60° C., and then dried under vaccum. Then the catalyst obtained was prepared and stored.

### Comparison Example 2

2 g pre-activated SiO₂ (pore volume 1.5˜1.7 cm³/g, surface area 250˜300 m²/g), 50 mL n-heptane and 20 mL TiBA were added int the reactor under nitrogen with stirring at 60° C. for 2 h. Then small amount of ethanol was added and washed with n-heptane for several times. The pre-treated SiO₂ obtained after drying under vaccum. A certain amount of anhydrous MgCl₂ and refined n-heptane were added into the reactor with magnetic stirring under nitrogen protection. Then a certain amount of anhydrous ethanol (n[EtOH]:n[MgCl₂]=4:1) was added after fully stirring. Until the temperature was raised up to 120° C. and MgCl₂ was fully dissolved for 1 h, the temperature was cooled down to room temperature, and n-heptane was removed. MgCl₂.nEtOH complex was dried under vaccum and transferred to a bottle under the protecton of nitrogen. TiCl₃ and MgCl₂.nEtOH were added into THF solution at 60° C. with stirring until fully dissolved, then a certain amount of pre-treated SiO₂ was added and dried under vaccum with nitrogen. Then the catalyst obtained was prepared and stored.

### Comparison Example 3

10 g Mg(OEt)₂ and 100 ml refined n-octane were added into the reactor with stirring. When the temperature was raised up to 85° C., 20 mL TiCl₄ was added by dropping and heated to 120° C. for a while. The temperature was cooled (no less than 60° C.) for 10 h. The supernatant liquid was romoved and 100 mL refined n-hexane was added into the reactor, and transferred into the centrifuge bottle under nitrogen with stirring for 10 min and centrifuging for 10 min. Then the supernatant liquid was romoved and 100 mL refined n-hexane was added into the reactor for several times. The catalyst obtained was prepared and stored.

### Comparison Example 4

100 mg catalyst which prepared according to Comparison Example 1 was weighed for the polymerization. The polymerization reactor was firstly heated under vacuum, and then replaced with highly pure nitrogen, which was repeated for three times. A small amount of monomeric ethylene was used to replace once. Finally, the reactor was filled with ethylene to a slight positive pressure (0.12 MPa). The polymerization temperature was maintained at 70° C. 40 ml of refined n-heptane as solvent and a certain amount of triisobutylaluminium (TiBA, Al/Ti=50) as cocatalyst were added into the reactor successively. Finally another 40 ml n-heptane were added into the reactor and the pressure of ethylene was raised to 0.15 MPa and the catalysts were added. The instantaneous consumption of monomeric ethylene was on-line collected (by the high-precision ethylene mass flow meter connecting with a computer) during the reaction and recorded by the computer. After the reaction was conducted at 70° C. for 1 h, 50 ml mixed solution of hydrochloric acid/ethanol was added to terminate the reaction, and the polymer was vacuum dried at 60° C. for 4 h, weighed and analyzed.

### Comparison Example 5

100 mg catalyst which prepared according to Comparison Example 2 was weighed for the polymerization. The polymerization reactor was firstly heated under vacuum, and then replaced with highly pure nitrogen, which was repeated for three times. A small amount of monomeric ethylene was used to replace once. Finally, the reactor was filled with ethylene to a slight positive pressure (0.12 MPa). 40 ml of refined n-heptane as solvent and a certain amount of triisobutylaluminium (TiBA, Al/Ti=50) as cocatalyst were added into the reactor successively. Finally another 40 ml n-heptane were added into the reactor and the pressure of ethylene was raised to 0.15 MPa and the catalysts were added. While the polymerization temperature was maintained at 70° C., the catalyst was added to react. The instantaneous consumption of monomeric ethylene was on-line collected (by the high-precision ethylene mass flow meter connecting with a computer) during the reaction and recorded by the computer. After the reaction was conducted at 70° C. for 1 h, 50 ml mixed solution of hydrochloric acid/ethanol was added to terminate the reaction, and the polymer was vacuum dried at 60° C. for 4 h, then weighed and analyzed.

### Comparison Example 6

100 mg catalyst which prepared according to Comparison Example 3 was weighed for the polymerization. The polymerization reactor was firstly heated under vacuum, and then replaced with highly pure nitrogen, which was repeated for three times. A small amount of monomeric ethylene was used to replace once. Finally, the reactor was filled with ethylene to a slight positive pressure (0.12 MPa). The polymerization temperature was maintained at 70° C. 40 ml of refined n-heptane as solvent and a certain amount of triisobutylaluminium (TiBA, Al/Ti=50) as cocatalyst were added into the reactor successively. Finally another 40 ml n-heptane were added into the reactor and the pressure of ethylene was raised to 0.15 MPa and the polymerization temperature was maintained at 70° C., the catalysts were added. The instantaneous consumption of monomeric ethylene was on-line collected (by the high-precision ethylene mass flow meter connecting with a computer) during the reaction and recorded by the computer. After the reaction was conducted at 70° C. for 1 h, 50 ml mixed solution of hydrochloric acid/ethanol was added to terminate the reaction, and the polymer was vacuum dried at 60° C. for 4 h, weighed and analyzed.

TABLE 1
Ethylene polymerization activities of the examples

| | Activity |
|---|---|
| Examples | (kg Polymer/mol Ti · h) |
| Example 26 | 46.93 |
| Example 27-1 | 59.78 |
| Example 27-2 | 66.86 |
| Example 27-3 | 65.55 |
| Example 27-4 | 57.65 |
| Example 27-5 | 41.58 |
| Example 28-1 | 44.32 |
| Example 28-2 | 43.54 |
| Example 28-3 | 42.11 |
| Example 29-1 | 54.53 |
| Example 29-2 | 60.06 |
| Example 29-3 | 59.63 |
| Example 29-4 | 59.25 |
| Example 29-5 | 56.78 |
| Example 30-1 | 34.54 |
| Example 30-2 | 38.58 |
| Example 30-3 | 36.47 |
| Example 31-1 | 47.96 |
| Example 31-2 | 44.20 |
| Example 31-3 | 40.53 |
| Example 31-4 | 36.83 |
| Example 32 | 45.37 |
| Example 33 | 50.95 |
| Example 34 | 57.88 |
| Example 35-1 | 68.02 |
| Example 35-2 | 72.00 |
| Example 35-3 | 66.00 |
| Example 36-1 | 57.93 |
| Example 36-2 | 67.47 |
| Example 36-3 | 60.46 |
| Example 37-1 | 44.91 |
| Example 37-2 | 52.74 |
| Example 37-3 | 43.05 |
| Example 38 | 39.02 |
| Example 39 | 45.42 |
| Example 40 | 49.39 |
| Example 41 | 50.74 |
| Example 42 | 54.21 |
| Example 43 | 65.41 |
| Example 44 | 51.45 |
| Example 45 | 50.88 |
| Example 46 | 53.43 |
| Example 47 | 52.64 |
| Example 48 | 49.35 |
| Example 49 | 51.23 |
| Example 50 | 49.78 |
| Example 51 | 52.13 |
| Example 52 | 50.76 |
| Example 53 | 52.66 |
| Example 54 | 51.60 |
| Example 55 | 53.62 |
| Example 56 | 50.45 |
| Example 57 | 48.44 |
| Example 58-1 | 82.54 |
| Example 58-2 | 79.33 |
| Example 58-3 | 78.11 |
| Example 59-1 | 77.26 |
| Example 59-2 | 84.37 |
| Example 59-3 | 73.49 |
| Example 60-1 | 88.42 |
| Example 60-2 | 78.56 |
| Example 60-3 | 77.81 |
| Example 61-1 | 81.35 |
| Example 61-2 | 78.32 |
| Example 61-3 | 76.98 |
| Comparison Example 4 | 64.43 |
| Comparison Example 5 | 61.77 |
| Comparison Example 6 | 63.99 |

### (1) The Effects of Cocatalyst

TABLE 2
Cocatalyst concentration effects on the polymerization with supported
polyolefin catalysts

| | | | Activity | | |
|---|---|---|---|---|---|
| | | | (kg Polymer/mol | Mw | |
| Examples | Cocatalyst | Al/Ti | Ti · h) | (×10⁶) | MWD |
| Example | TiBA | 25 | 59.78 | 1.36 | 6.2 |
| 27-1 | | | | | |
| Example | TiBA | 50 | 66.86 | 1.38 | 5.8 |
| 27-2 | | | | | |
| Example | TiBA | 100 | 65.55 | 1.33 | 6.2 |
| 27-3 | | | | | |
| Example | TiBA | 150 | 57.65 | 1.27 | 6.6 |
| 27-4 | | | | | |
| Example | TiBA | 200 | 41.58 | 1.25 | 5.1 |
| 27-5 | | | | | |
| Example | TiBA | 10 | 54.53 | 1.15 | 4.8 |
| 29-1 | | | | | |
| Example | TiBA | 15 | 60.06 | 1.32 | 5.3 |
| 29-2 | | | | | |
| Example | TiBA | 25 | 59.63 | 1.30 | 6.4 |
| 29-3 | | | | | |
| Example | TiBA | 50 | 59.25 | 1.26 | 5.4 |
| 29-4 | | | | | |
| Example | TiBA | 100 | 56.78 | 1.24 | 6.0 |
| 29-5 | | | | | |
| Example | TiBA | 5 | 47.96 | 1.97 | 3.4 |
| 31-1 | | | | | |
| Example | TiBA | 10 | 44.20 | 1.91 | 5.3 |
| 31-2 | | | | | |
| Example | TiBA | 15 | 40.53 | 1.81 | 4.7 |
| 31-3 | | | | | |
| Example | TiBA | 25 | 36.83 | 1.79 | 6.6 |
| 31-4 | | | | | |
| Example | TiBA | 10 | 68.02 | 1.59 | 7.8 |
| 35-1 | | | | | |
| Example | TiBA | 15 | 72.00 | 1.45 | 4.6 |
| 35-2 | | | | | |
| Example | TiBA | 25 | 66.00 | 1.44 | 6.2 |
| 35-3 | | | | | |
| Example | TiBA | 10 | 57.93 | 1.43 | 7.2 |
| 36-1 | | | | | |
| Example | TiBA | 15 | 67.47 | 1.41 | 6.8 |
| 36-2 | | | | | |
| Example | TiBA | 25 | 60.46 | 1.40 | 7.0 |
| 36-3 | | | | | |
| Example | TiBA | 15 | 44.91 | 1.44 | 7.4 |
| 37-1 | | | | | |
| Example | TiBA | 25 | 52.74 | 1.41 | 7.0 |
| 37-2 | | | | | |
| Example | TiBA | 50 | 43.05 | 1.42 | 7.0 |
| 37-3 | | | | | |

Polymerization conditions: P = 0.15 Mpa, h = 1 h, T = 70° C., n-heptane = 80 mL, cocatalyst TiBA, Examples 27, 29, 31, 35, 36, 37.

Cocatalyst concentration effects on the polymerization with supported polyolefin catalysts were shown in Table 2. From the results, when TiBA was used as cocatalyst, as for the catalyst prepred by Example 2, with the increasing of cocatalyst concentration from 25 to 200, the catalyst activity increased to a maximum value then decreased, which means proper amount of cocatalyst may enhance the actvity. The catalyst activity of Example 2 reached the maximum value with Al/Ti molar ratio at 50. The similar tendency were found for the other catalysts, for Example 3 at 15, Example 4 at 5, Example 8 at 15, Example 9 at 15, Example 10 at 25.

TABLE 3
Cocatalyst type effects on the polymerization with supported
polyolefin catalysts

| | | | Activity | | |
|---|---|---|---|---|---|
| | | Al/ | (kg Polymer/mol | Mw | |
| Examples | Cocatalyst | Ti | Ti · h) | (×10⁶) | MWD |
| Example 27-2 | TiBA | 50 | 66.86 | 1.38 | 5.8 |
| Example 28-3 | TEA | 50 | 42.11 | 0.91 | 8.4 |
| Example 29-2 | TiBA | 15 | 60.06 | 1.32 | 5.3 |
| Example 30-2 | TEA | 15 | 38.58 | 1.09 | 14.3 |

Polymerization conditions: P = 0.15 Mpa, h = 1 h, T = 70° C., n-heptane = 80 mL, Mg = 15 wt %, Examples 27-2, 28-3 and 29-2, 30-2.

Cocatalyst type effects on the polymerization with supported polyolefin catalysts were shown in Table 3. From the results, the activity when using TEA as cocatalyst was lower than that of TiBA. And through the further characterization of the polymers, the molecular weight and molecular weight distribution of the polymers were different, the Mw was lower with broad MWD using TEA as cocatalyst than TiBA, which means cocatalyst may influence the active sites of catalyst.

### (2) Magnesium Contents Effects on Polymerization

TABLE 4
Magnesium contents effects on the polymerization with supported
polyolefin catalysts

| | | | Activity | | |
|---|---|---|---|---|---|
| | Mg | | (kg Polymer/mol | Mw | |
| Examples | contents | Al/Ti | Ti · h) | (×10⁶) | MWD |
| Example 29-3 | 15% | 25 | 59.63 | 1.30 | 6.4 |
| Example 31-4 | 1% | 25 | 36.83 | 1.79 | 6.6 |
| Example 27-1 | 15% | 25 | 59.78 | 1.36 | 6.2 |
| Example 36-3 | 10% | 25 | 60.46 | 1.40 | 7.0 |
| Example 35-3 | 5% | 25 | 66.00 | 1.42 | 7.0 |

Polymerization conditions: P = 0.15 Mpa, h = 1 h, T = 70° C., n-heptane = 80 mL, cocatalyst TiBA, Examples 29-3, 31-4 and 27-1, 36-3, 35-3.

Mg contents effects on the polymerization with supported polyolefin catalysts (Example 29-3, 31-3, 27-1, 36-3 and 35-3) were shown in Table 4. From the results, at high washing temperature, the activity of catalyst with 15 wt % Mg content was higher than that with 1 wt % Mg content, while at room temperatue, the Mg content increased from 5 wt %, 10 wt % to 15 wt %, the activity decreased, which means the increased Mg content with a proper value is beneficial for the activity. Under the same preparation conditions, the Mw of polymer decreased with the increased Mg content.

### (3) Washing Temperature Effects on the Ethylene Polymerization

TABLE 5
The polymerization results of catalysts obtained from different washing
temperature

| | | Activity | | |
|---|---|---|---|---|
| | | (kg Polymer/mol | Mw | |
| Examples | Al/Ti | Ti · h) | (×10⁶) | MWD |
| Example 27-1 | 25 | 59.78 | 1.36 | 6.2 |
| Example 29-3 | 25 | 59.63 | 1.30 | 6.4 |
| Example 27-2 | 50 | 66.86 | 1.38 | 5.8 |
| Example 29-4 | 50 | 59.25 | 1.26 | 5.4 |
| Example 27-3 | 100 | 65.55 | 1.33 | 6.2 |
| Example 29-5 | 100 | 56.78 | 1.24 | 6.0 |

Polymerization conditions: P = 0.15 Mpa, h = 1 h, T = 70° C., n-heptane = 80 mL, Mg = 15 wt %, cocatalyst TiBA, Examples 27-1, 29-3, 27-2, 29-4, 27-3, 29-5.

The catalysts obtained from Example 2 and Example 3 at Al/Ti molar ratio at 25, 50, 100 were used in ethylene polymerization. The catalyst of Example 2 was prepared from room temperature and Example 3 was prepared from high temperature (70° C.). The catalyst activity of room temperature washing was higher than that of high temperature at the same conditions.

### (4) Ammonium Acetate Effects on Polymerization

TABLE 6
Ammonium acetate effects the polymerization with supported polyolefin
catalysts

| | | Activity | | |
|---|---|---|---|---|
| | | (kg Polymer/mol | Mw | |
| Examples | Al/Ti | Ti · h) | (×10⁶) | MWD |
| Example 27-1 | 25 | 59.78 | 1.36 | 6.2 |
| Example 37-2 | 25 | 52.74 | 1.41 | 7.0 |
| Example 27-2 | 50 | 66.86 | 1.38 | 5.8 |
| Example 37-3 | 50 | 43.05 | 1.42 | 7.0 |

Polymerization conditions: P = 0.15 Mpa, h = 1 h, T = 70° C., n-heptane = 80 mL, cocatalyst TiBA, Examples 27-1, 37-2, 27-2, 37-3.

Ammonium acetate effects on the polymerization with supported polyolefin catalysts were shown in Table 6. Example 27-1 and 27-2 were the ethylene polymerization of the catalyst without ammonium acetate. At the same Al/Ti molar ratio, the ethylene homopolymerization were not improved by adding ammonium acetate.

(5) 1-Hexene amount effects on ethylene/1-hexene copolymerization

TABLE 7
1-Hexene effects on ethylene/1-hexene copolymerization with supported
polyolefin catalysts

| | 1- | | Activity | | |
|---|---|---|---|---|---|
| | Hexene | | (kg Polymer/mol | Mw | |
| Examples | (mL) | Al/Ti | Ti · h) | (×10⁶) | MWD |
| Example 27-2 | 0 | 50 | 66.86 | 1.38 | 5.8 |
| Example 58-1 | 0.8 | 50 | 82.54 | 0.72 | 7.2 |
| Example 58-2 | 2.4 | 50 | 79.33 | 0.48 | 6.1 |
| Example 58-3 | 4.0 | 50 | 78.11 | 0.32 | 6.9 |
| Example 35-2 | 0 | 15 | 72.00 | 1.45 | 4.6 |
| Example 59-1 | 0.8 | 15 | 77.26 | 0.83 | 6.8 |
| Example 59-2 | 2.4 | 15 | 84.37 | 0.54 | 7.1 |
| Example 59-3 | 4.0 | 15 | 73.49 | 0.46 | 6.5 |
| Example 36-2 | 0 | 15 | 67.47 | 1.41 | 6.8 |
| Example 60-1 | 0.8 | 15 | 88.42 | 0.80 | 7.2 |
| Example 60-2 | 2.4 | 15 | 78.56 | 0.52 | 6.7 |
| Example 60-3 | 4.0 | 15 | 77.81 | 0.41 | 6.5 |
| Example 37-2 | 0 | 25 | 52.74 | 1.41 | 7.0 |
| Example 61-1 | 0.8 | 25 | 81.35 | 0.75 | 6.3 |
| Example 61-2 | 2.4 | 25 | 78.32 | 0.71 | 9.1 |
| Example 61-3 | 4.0 | 25 | 76.98 | 0.46 | 6.8 |

Polymerization conditions: P = 0.15 Mpa, h = 1 h, T = 70° C., n-heptane = 80 mL, cocatalyst TiBA, Examples 27-2, 58-1, 58-2, 58-3, 35-2, 59-1, 59-2, 59-3, 36-2, 60-1, 60-2, 60-3, 37-2, 61-1, 61-2, 61-3.

Ethylene/1-hexene copolymerization results with different supported polyolefin catalysts were shown in Table 7. Compared with the homopolymerization results, the activities of copolymerization with the catalysts of Example 2, Example 8, Example 9 and Example 10 increased. With the increasing of 1-hexene concentration, the activity increased to a maximum value then decreased, and the Mw of copolymers decreased with the increased 1-hexene.

### (6) Hydrogen Effects on the Polymerization

TABLE 8
Hydrogen effects on the polymerization

| | | | Activity | | |
|---|---|---|---|---|---|
| | | | (kg Polymer/mol | Mw | |
| Examples | H₂ (mL) | Al/Ti | Ti · h) | (×10⁶) | MWD |
| Example 27-2 | 0 | 50 | 66.86 | 1.38 | 5.8 |
| Example 53 | 10 | 50 | 52.66 | 0.68 | 8.5 |
| Example 29-2 | 0 | 15 | 60.06 | 1.32 | 5.3 |
| Example 54 | 10 | 15 | 51.60 | 0.74 | 6.1 |
| Example 35-2 | 0 | 15 | 72.00 | 1.45 | 4.6 |
| Example 55 | 10 | 15 | 53.62 | 1.10 | 8.8 |
| Example 36-2 | 0 | 15 | 67.47 | 1.41 | 6.8 |
| Example 56 | 10 | 15 | 50.45 | 0.65 | 7.7 |
| Example 37-2 | 0 | 25 | 52.74 | 1.41 | 7.0 |
| Example 57 | 10 | 25 | 48.44 | 0.80 | 5.9 |

Polymerization conditions: P = 0.15 Mpa, h = 1 h, T = 70° C., n-heptane = 80 mL, cocatalyst TiBA, Examples 27-2, 53, 29-2, 54, 35-2, 55, 36-2, 56, 37-2, 57.

From the results as shown in Table 8, the activity and Mw decreased with the addition of hydrogen, which means hydrogen is a good chain transfer agent leading to lower Mw.

### (7) The Comparision of Different Catalyst Preparation Method

TABLE 9
The comparision of different catalyst preparation method

| | | Activity | | |
|---|---|---|---|---|
| | | (kg Polymer/mol | Mw | |
| Examples | Al/Ti | Ti · h) | (×10⁶) | MWD |
| Example 7-2 | 50 | 66.86 | 1.38 | 5.8 |
| Comparision Example 4 | 50 | 64.43 | 1.21 | 6.2 |
| Comparision Example 5 | 50 | 61.77 | 1.09 | 5.9 |
| Comparision Example 6 | 50 | 63.99 | 1.08 | 6.5 |

Polymerization conditions: P = 0.15 Mpa, h = 1 h, T = 70° C., n-heptane = 80 mL, cocatalyst TiBA, Examples 27-2, Comparision Example 4, Comparision Example 5, Comparision Example 6.

From the results as shown in Table 9, at the same catalyst preparation conditions, the activity of the catalyst prepared according to the present invention was higher than the other three method (Comparision Example 4, Comparision Example 5, Comparision Example 6). Meanwhile, the present invention with relatively simple method was superior to the other method.

The present invention relates to a supported olefin polymerization catalyst, preparation method and its application in the production of olefin homopolymers and olefin copolymers. This invention uses any porous inorganic carrier with any inexpensive soluble magnesium salts as raw materials, the catalyst is prepared through impregnation of solution of soluble Mg-compounds on inorganic carrier, and forming a supported thin layer of magnesium compound on the surface of inorganic carrier after high temperature calcination, followed by further reacting with chlorinated titanium compound to synthesize the support containing magnesium compound in situ and to support the titanium species simultaneously. The catalyst preparation method is simple, low cost, easy to control catalyst morphology, and the resulting composite supported Ziegler-Natta catalyst shows excellent performance in olefin polymerization. Using the present invention of supported olefin polymerization catalyst, by changing the type and amount of cocatalyst, molecular weight regulator and other factors, it may be easily and readily adjusted the average molecular weight, molecular weight distribution of the olefin homopolymers and copolymers, and the comonomer content and distribution, thereby obtaining the polymer with desired properties.

1. A supported olefin polymerization catalyst, wherein said catalyst mainly comprises: porous support as carrier A, magnesium-containing compound support as carrier B and supported transition metal active component containing titanium.

2. The catalyst according to claim 1, wherein said support A is one or more selected from silica, alumina, aluminosilicate (xAl₂O₃.ySiO₂), titania, zirconia, magnesium oxide, calcium oxide, inorganic clays and combinations thereof.

3. The catalyst according to claim 1, wherein said support B is a kind of magnesium compound of general formula R¹ₘMgCl₂₋ₘ, wherein, R¹ is C₁-C₂₀ alkyl group which selected from saturated or unsaturated straight-chain, branched or cyclic chain, 0≦m<2.

4. The catalyst according to claim 1, wherein said titanium transition metal is titanium compound, such as Ti(L¹)ₙCl₄₋ₙ, Ti(L¹)_{g}Cl_{3-g} or Ti(L¹)ₖCl₂₋ₖ, wherein, L¹ is C₁-C₂₀ alkyl group R² or alkyl oxide group R²O, R² is selected from saturated or unsaturated straight-chain, branched or cyclic chain, 0≦n≦4, 0≦g≦3, 0≦k≦2, when n, g and k is 2 or more than 2, the R² could be same or different;The titanium compound is selected from trimethoxy titanium chloride, triethoxy titanium chloride, tri-n-propoxy titanium chloride, tri-iso-propoxy titanium chloride, dimethoxy titanium dichloride, diethoxy titanium dichloride, di-iso-propoxy titanium dichloride, methoxy titanium trichloride, ethoxy titanium trichloride, titanium tetrachloride, tetraethoxy titanium, tetraethyl titanate, tetrabutyl titanate, titanium trichloride, titanium ethoxide, titanium dichloride, di-n-butyl titanium, ethyl titanium chloride.

5. The catalyst according to claim 1, wherein said support B is supported on support A, and the loading of the support B is 0.01˜50wt % (weight of Mg based on the total weight of the catalyst).

6. A method for preparing the catalyst of claim 1, wherein: support A is impregnated with solution of the soluble magnesium salt, or impregnated with a mixed solution mixed with the soluble magnesium salt and the soluble ammonium salt, followed by calcination at high temperature of 300˜900° C. and further reacting with titanium-containing compound, to obtain the catalyst.

7. The method for preparing the catalyst according to claim 6, wherein the soluble magnesium salt is one or more selected from magnesium carbonate, magnesium bicarbonate, magnesium chromate, magnesium silicon fluoride, magnesium acetate, magnesium nitrate, magnesium fluoride, magnesium chloride, magnesium bromide, magnesium iodide, magnesium sulfate, magnesium gluconate, magnesium chlorate, magnesium perchlorate, magnesium phosphate, magnesium sulfate, magnesium citrate, magnesium amino acid and combinations thereof; the magnesium loading on support A is 0.01˜50wt % (weight of Mg based on the total weight of the catalyst);
The soluble ammonium salt is one or more selected from ammonium acetate, ammonium nitrate, ammonium carbonate, ammonium bicarbonate et al and combinations thereof; the molar ratio of the soluble ammonium salt and the magnesium salt is 0.01˜10.

8. The method for preparing the catalyst according to claim 6, wherein the titanium compound which react with the calcination product is Ti(L²)ₕCl₄₋ₕ, Ti(L²)ₛCl₃₋ₛ or Ti(L²)ₜCl₂₋ₜ, wherein, L² is C₁-C₂₀ alkyl group, R³ or alkyl oxide group R³O, R³ is selected from saturated or unsaturated straight-chain, branched or cyclic chain, 0≦h≦4, 0≦s≦3, 0≦t≦2, when h, s and t is 2 or more than 2, the R³ could be same or different. The titanium compound is one or more selected from trimethoxy titanium chloride, triethoxy titanium chloride, tri-n-propoxy titanium chloride, tri-iso-propoxy titanium chloride, dimethoxy titanium dichloride, diethoxy titanium dichloride, di-isopropoxy titanium dichloride, methoxy titanium trichloride, ethoxy titanium trichloride, titanium tetrachloride, titanium trichloride, titanium dichloride, ethyl titanium chloride et al; The molar ratio of the titanium compound and the magnesium supported on support A is 0.01˜500.

9. The method for preparing the catalyst according to claim 6, wherein when support A is reacting with titanium-containing compound, an internal electron donor is added into the solution simultaneously; The internal electron donor is one or more selected from alkyl ester of saturated aliphatic carboxylic acid, alkyl esters of aromatic carboxylic acid, aliphatic ethers, cyclic ethers, saturated aliphatic ketones, glycol esters, and combinations thereof; The molar ratio of the internal electron donor and the magnesium loading on the support A is 0.01˜500.

10. The method for preparing the catalyst according to claim 6, wherein after the high temperature calcination and before the reaction with the titanium-containing compound, one or two selected from organic magnesium compound, organic aluminum compound or hydroxy-containing compound is/are added to react with the product obtained from the high temperature calcination to modify the surface of the carrier;
The general formula of organic magnesium compound is R⁴ₚMgX₂₋ₚ, wherein, R⁴ is C₁-C₂₀ alkyl group which may be saturated or unsaturated straight-chain, branched or cyclic chain, 0<p<2, X is halogen, such as F, Cl, Br, I. The organic magnesium compound is one or more selected from methyl magnesium chloride, ethyl magnesium chloride, butyl magnesium chloride, allyl magnesium chloride, isopropyl magnesium chloride, t-butyl magnesium chloride, 2-methyl butyl magnesium chloride, 1-heptyl magnesium chloride, 1-pentyl magnesium chloride, 1-hexyl magnesium chloride, 1,1-dimethylpropyl magnesium chloride, cyclopentyl magnesium chloride, vinyl magnesium chloride, 2-butyl magnesium chloride, 1-octyl magnesium chloride et al; The molar ratio of the organic magnesium compound and the magnesium loading on support A is 0.01˜100;
The organic aluminum compound is chosen from trialkylaluminum AlR₃, dialkyl alkoxide aluminum AlR₂OR, dialkyl aluminum halides AlR₂X, aluminoxane, triethyldialuminium trichloride et al, wherein, R is C₁-C₁₂ alkyl group, X is halogen, such as F, Cl, Br, I; the molar ratio of the organic aluminum compound and the magnesium loading on support A is 0.01˜100;
The general formula of hydroxyl-containing compound is HORS, wherein, R⁵ is C₁-C₂₀ alkyl group which may be saturated or unsaturated straight-chain, branched or cyclic chain, hydroxyl-containing compound is chosen from ethanol, n-butanol, n-hexanol, isooctyl alcohol, benzyl alcohol and phenethyl alcohol et al;The molar ratio of the hydroxyl-containing compound and the magnesium loading on support A is 0.01˜200.

11. The method for preparing the catalyst according to claim 6, wherein the catalyst was pre-activated by using organometallic cocatalyst. The organometallic cocatalyst include organic aluminum compound, organic lithium compound, organic boron compound et al;The organic aluminum compound is chosen from trialkylaluminum AlR₃, dialkyl alkoxide aluminum AlR₂OR, dialkyl aluminum halides AlR₂X, aluminoxane, triethyldialuminium trichloride et al, wherein, R is C₁-Cao alkyl group, X is halogen, such as F, Cl, Br, I; The general formula of organic lithium compound is LiR⁶, wherein, R⁶ is C₁-C₂₀ alkyl group which may be saturated or unsaturated straight-chain, branched or cyclic chain, organic lithium compound is selected from methyl lithium, ethyl lithium, butyl lithium, t-butyl lithium, pentyl lithium, phenyl lithium et al; The general formula of organic boron compound is BR⁷_{q}Cl_{3-q}, wherein, R⁷ is C₁-C₂₀ alkyl group or alkoxy group, 0<q<3, the organic boron compound is selected from trimethyl boron, triethyl boron, dichloro-methyl boron, dichloro-ethyl boron, dichloro-butyl boron, dichloro-methoxy boron, dichloro-ethoxy boron, boron trichloride and dichloro-butoxy group; The molar ratio of the organometallic cocatalyst and the titanium species (transitin metal active component containing titanium) is 0.01˜1000.

12. A method for preparing the catalyst of claims 1, which comprises following steps:
a) The support A is impregnated with a solution of soluble magnesium salt or impregnated with a solution mixed with a soluble magnesium salt and a soluble ammonium salt, followed by a, drying and calcining at high temperature of 300˜900° C.;
b) The product obtained from step a) is reacted with the solution of titanium-containing compound, if necessary, an internal electron donor could be added into the reaction system simultaneously, followed by washing and drying to obtain the catalyst.

13. A method for preparing the catalyst of claims 1, which comprises following steps:
a) The support A is impregnated with a solution of soluble magnesium salt or impregnated with a solution mixed with a soluble magnesium salt and a soluble ammonium salt, followed by drying and calcining at high temperature of 300˜900° C.;
b) The product obtained from step a) is reacted with an organic magnesium compound or an organic aluminum compound, then drying;
c) The product obtained from step b) is reacted with the solution of titanium-containing compound, if necessary, an internal electron donor could be added into the reaction system simultaneously, and then followed by washing and drying, to obtain the catalyst.

14. A method (process) for preparing the catalyst of claims 1, which comprises following steps:
a) The support A is impregnated with a solution of soluble magnesium salt, or impregnated with a solution mixed with a soluble magnesium salt and a soluble ammonium salt, followed by drying and calcining at high temperature of 300˜900° C.;
b) The product obtained from step a) is reacted with an organic aluminum compound, then added a hydroxyl-containing compound before drying;
c) The product obtained from step b) is reacted with the solution of titanium-containing compound, if necessary, an internal electron donor could be added into the reaction system simultaneously, and then followed by washing and drying, to obtain the catalyst.

15. A method (process) for preparing the catalyst of claims 1, which comprises following steps:
a) A catalyst is prepared according to any one of claims 12-14 as mentioned above;
b) The catalyst obtained from step a) is reacted with an organometallic cocatalyst to pre-activate. The organometallic cocatalyst involve organic aluminum compound, organic lithium compound, organic boron compound et al. The catalyst is prepared and stored.

16. Use of the supported olefin polymerization catalysts of claims 1 in olefin homopolymerization or copolymerization, The olefin homopolymerization and copolymerization is a homopolymerization or copolymerization of olefin which is selected from ethylene, propylene, butene, hexene and octene, and an organometallic cocatalyst, an external donor or hydrogen could be added therein if necessary; The molar ratio of organometallic cocatalyst and the titanium species (tansition metal active component containing titanium) is 0˜1000, and the molar ratio of the external electron donor and the titanim species (tansition metal active component containing titanium) is 0.1˜500;
The external electron donor is one or more selected from monocarboxylic acids, polycarboxylic acids, carboxylic acid anhydrides, carboxylic acid esters, aromatic esters, ketones, ethers, alcohols, amines, lactones, organophosphorus compounds and alkoxysilane compounds, and combinations thereof.
